(19) United States
(12) Patent Application Publication
(10) Pub. No.: US 2025/0312807 A1
(43) Pub. Date: Oct. 9, 2025

(54) Mobile and Submersible Performance System and Associated Displays

(71) Applicants: Mark W. Fuller, Sun Valley, CA (US); David Kuklish, Sun Valley, CA (US); Andrew Stangeland, Sun Valley, CA (US); Kevin Izard, Sun Valley, CA (US); Mark Erensteyn, Sun Valley, CA (US)

(72) Inventors: Mark W. Fuller, Sun Valley, CA (US); David Kuklish, Sun Valley, CA (US); Andrew Stangeland, Sun Valley, CA (US); Kevin Izard, Sun Valley, CA (US); Mark Erensteyn, Sun Valley, CA (US)

(21) Appl. No.: 19/048,831

(22) Filed: Feb. 7, 2025

Related U.S. Application Data
(60) Provisional application No. 63/551,519, filed on Feb. 8, 2024.

(51) Int. Cl. B05B 1/20; B05B 1/34; B05B 15/68; B05B 17/08

(52) U.S. Cl. CPC B05B 1/20; B05B 1/34; B05B 15/68; B05B 17/08

(57) ABSTRACT

A performance system for a water display, that moves in water a reservoir of water, that submerges below the water surface and rises above the water surface, that includes a performance platform and an arm system that may be raised and lowered and that include water delivery devices the emit streams of water, including water fan expressions that may be emitted outward and in an up and down fashion, thereby emulating the flapping of a bird's wings. The performance system may include lighting, fog and other visual effects and the water display may include a plurality of performance systems that are controlled according to a performance choreography.

### CROSS REFERENCE TO RELATED APPLICATION

This application claims the benefit of U.S. Provisional Application No. 63/551,519, filed Feb. 8, 2024, the contents of which are incorporated herein by reference.

### FIELD OF THE INVENTION

The current invention generally relates to performance devices that provide visual effects, including mobile and submersible devices that may operate in a body of water, that may emit streams of water, as well as lighting and other visual and/or audio effects, and that may move about the body of water and provide visual effects in choreographed fashion for performances by a display.

### BACKGROUND OF THE INVENTION

Various types of displays involving water, lighting and other visual and audio effects have existed for some time. For example, displays exist whereby one or more water delivery devices are located in a reservoir of water. The water delivery devices emit streams of water that may vary in height and direction and may be choreographed with one another or with other visual and/or audio effects. Examples of such displays or features are the Bellagio Fountains in Las Vegas and the Dubai Fountain at the Burj Khalifa in Dubai.

However, the water delivery devices in many existing displays are stationary, so the emitted water streams may originate from only fixed locations. The nozzles from which the water streams are actually emitted are also typically located at or a relatively small distance above the water's surface. These limitations of existing water delivery devices may consequently limit the visual effects and/or choreography that the display provides.

Furthermore, water delivery devices in existing displays are typically always positioned above the water surface and are not submersible. Indeed, water delivery devices may involve complex mechanical and electrical systems that may be damaged if subjected to an underwater environment. However, the inability to submerge may also limit the visual effects and/or choreography that the display provides.

As such, there is a need for water delivery devices that may move about a reservoir or other body of water and that may vary the height at which nozzles emit streams of water.

There is also a need for a water delivery devices that are submersible.

### SUMMARY OF THE INVENTION

The current invention is specified in the claims as well as in the following written description, including the figures.

In an aspect of the invention, a water display is described which includes multiple performance systems that move about a reservoir or other body of water and that emits streams of water. The water delivery devices may also include water sources that are elevated above the reservoir surface so that the streams of water appear as if they originate at an elevation. The manner in which the streams of water are emitted from the multiple water delivery devices may be choreographed so that water is emitted according to an overall display choreography. The choreography may be supplemented by laser or other lighting effects and/or music or other audio effects.

In another aspect of the invention, a performance system for use in a water display is described. The performance system includes a moving system that propels and steers the performance system, a performance platform that includes water delivery devices, lighting and other visual effects; a lifting system that moveably attached the performance platform to the movement system and that raises the performance platform above the movement platform; and an arm system that is moveably attached to the lifting system and/or the performance platform, that may be raised or lowered and that may include water delivery devices, lighting and/or other visual effects. The performance platform and arm system may be raised according to a performance choreography while providing emitting water streams, lighting and other visual effects.

In another aspect of the invention, the arm system may include a dual fan water delivery device at its distal end that may emit fan water expressions in an up and down articulating fashion while the arm system is deployed to an upper position. In this manner, the performance system emulates a bird flapping its wings and taking flight.

In another aspect of the invention, aspect of the invention, multiple performance systems may emit fan water expressions in articulating up and down fashion as their arm systems are raised, thereby emulating a flock of birds flapping their wings to gain flight.

In another aspect of the invention, the performance system may be submerged underwater while at the same time protecting its interior components from water damage, and may raise above the water surface to provide visual effects.

In another aspect of the invention, the manner in which the performance platform and arm system may be configured at their lowered facilitates and positioned in relation to the movement system, allows the performance system to efficiently move through a body of water while accounting for hydrodynamic forces. Also, the raising and lowering of the performance platform and arm system may occur while the performance system is moving in a stable and controlled manner. Also, performance system includes modules that provide propulsion and steering, actuation for raising and lowering the performance platform and arm system, the control of water delivery devices, lighting and other visual effects, and other modules to provide additional functionality that are arranged and protected to withstand a water environment.

Other aspects of the invention are described herein.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 is a perspective view of a mobile aquatic expressive platform system, or performance system, with its arm in a deployed position.

FIG. 1A shows a display with a reservoir adjacent to a building, and with a number of performance systems in its reservoir.

FIG. 1B shows a display with water features around a periphery of its reservoir.

FIG. 1C shows a performance system with its arm in a non-deployed or nested position.

FIG. 2 is a side view of a performance system, with its performance platform in an elevated position above its base, and with its arm in a deployed position.

FIG. 3 is a front view of a performance system, with its base in an elevated position and its arm in a deployed position.

FIG. 4 is a top view of a performance system, with its arm retracted in a non-deployed position and residing within the performance platform.

FIG. 5 shows a display and a manner in which multiple mobile aquatic performance systems or movable water delivery devices may move about a reservoir of a display.

FIG. 6 shows a display and a manner in which multiple water delivery devices may vary the directions and locations at which they emit streams of water. FIG. 6 also shows the emission of water streams to reflect the flapping of a bird's wings.

FIGS. 7-9 show a water display and the position of water delivery devices at different times during a performance, and also show the emission of water streams to reflect the flapping of a bird's wings.

FIGS. 10-14 show a water delivery device at different times as the arm deploys and water is emitted.

FIG. 15 shows a plurality of water delivery systems with a desired choreography during a performance by a water display.

FIG. 16 is a perspective view of a chassis with a shell cover.

FIG. 17 is a perspective view of a chassis.

FIG. 18 is an exploded view of several components of a chassis.

FIG. 19 shows an x-brace.

FIG. 20 is a perspective view of a movement system with several of its components referenced.

FIG. 21 is a perspective view of a structural weldment for a motor box.

FIG. 22 is a perspective view of a box weldment for a motor box.

FIG. 23 is a perspective view of a structural weldment, showing several of its drive components.

FIG. 24 shows a drive assembly and several of its components.

FIG. 25 shows an assembled omni wheel system.

FIG. 26 is an exploded view of the omni wheel system.

FIG. 27 is a front view of a movement system and a front omni wheel system.

FIG. 28 is a front perspective view of an omni wheel system.

FIG. 29 is a rear perspective view of an omni wheel system.

FIG. 30 is a semi-transparent view of an omni wheel system.

FIG. 31 is a top view of a performance platform.

FIG. 32 is a front view of a performance platform.

FIG. 33 is a side perspective view of a performance platform.

FIG. 34 is a perspective view of a performance system with its arm in a deployed position.

FIG. 35 is a front view of a performance system in a submerged position P1 and in a performance position P2, where its lifting system has raised its performance platform above the water surface.

FIG. 36 is a partial side view of a performance system showing its lifting system in a retracted or lowered position.

FIG. 37 is a partial side view of a performance system showing its lifting system in a raised or deployed position.

FIG. 38 is an exploded view of a chassis and lifting system.

FIG. 39 is a top view showing a lifting system.

FIG. 40 is a side view showing components of a lifting system.

FIG. 41 is a side view showing components of a lifting system.

FIG. 42 is a partial perspective view of a performance system showing its lifting system and arm in a raised or deployed position.

FIG. 43 is a partial perspective view of a performance system showing its lifting system and its arm in a partially raised or deployed position.

FIG. 44 is a top perspective view of an arm system in a non-deployed or lowered position.

FIG. 45 is a partial side view showing a lifting system and arm in a lowered or non-deployed position.

FIG. 46 is a section view showing a cylinder rod in an extended position and an arm in a lowered position.

FIG. 47 is a section view showing a cylinder rod in a retracted position and an arm in a raised position.

FIG. 48 shows an arm in a raised or deployed position with water being emitted in fan expressions.

FIG. 49 is a perspective view of a mechanism to control the direction of water delivery devices.

FIGS. 50A, 50B and 50C show a movement system and performance platform in connection with hydrodynamic analysis.

FIG. 51 shows a movement system and performance platform with thrusters to address hydrodynamic characteristics.

FIG. 52 is a perspective view of a movement system exposed to show a chassis and fuselages.

FIG. 53 is a block diagram showing functional modules.

FIG. 54 is a perspective view showing an arrangement of modules in a chassis.

FIG. 55 is a bottom perspective view of a movement system, showing drive modules, along with conceptual representations of drive module movement.

FIG. 56 shows alternative drive systems.

FIG. 57 is a perspective view of a drive module showing components contained therein.

FIG. 58 is a top view of a drive module showing components contained therein.

FIG. 59 is a block diagram regarding a drive module.

FIG. 60 is a front, semi-transparent perspective view of the front of a movement system, showing aspects of a front drive system.

FIG. 61 is an exploded view of a rotator bearing.

FIG. 62 is a section view showing a rotator bearing and front axle mount.

FIG. 63 is a system diagram of an air pressure and purge system.

FIG. 64 is a perspective view of a rechargeable power system.

FIG. 65 is a perspective view of a rechargeable power system residing in a chassis of a movement system.

FIG. 66 is a block diagram of a rechargeable power system.

FIG. 67 is a schematic of an electrical hub/server.

FIG. 68 is a schematic of a server module.

FIG. 69 shows an underwater charging station with a performance system parked over it.

FIG. 70 is a bottom perspective view of a performance system, showing induction pickup pads.

FIGS. 71A and 71B show locations patterns of induction chargers.

FIG. 72 is a schematic of a NavCom system.

FIG. 73 is a perspective view of an isolation portion of a water delivery device.

FIG. 74 is a bottom perspective view of a spinner base for a water delivery device.

FIG. 75 is a top perspective view of a spinner base for a water delivery device.

FIG. 76 is a top perspective view of a performance platform, showing lighting elements.

FIG. 77 depicts cones of light emitted by lighting elements. FIG. 78 depicts narrow cones or stripes of light emitted by lighting elements.

FIG. 79 shows a telescoping arm system.

FIG. 80 shows different views of a dry dock servicing station.

### DETAILED DESCRIPTION OF THE PREFERRED EMBODIMENTS

Preferred or exemplary embodiments of the invention are now described with reference to the figures. These preferred embodiments and examples are provided to provide further understanding of the invention, without limiting its scope. Alternate embodiments and variations of the subject matter described herein will be apparent to those of ordinary skill in the art.

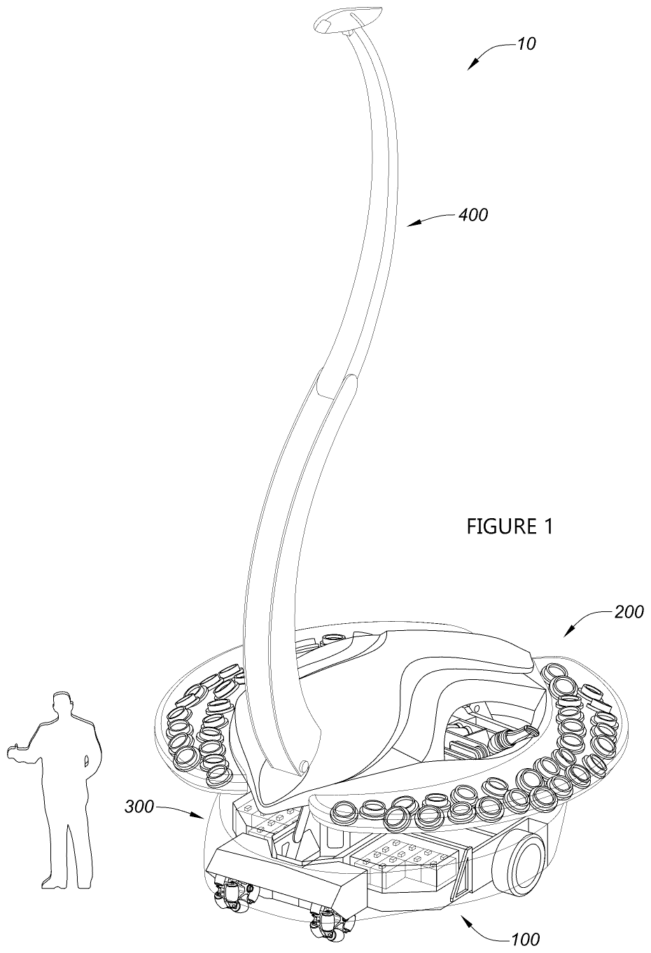

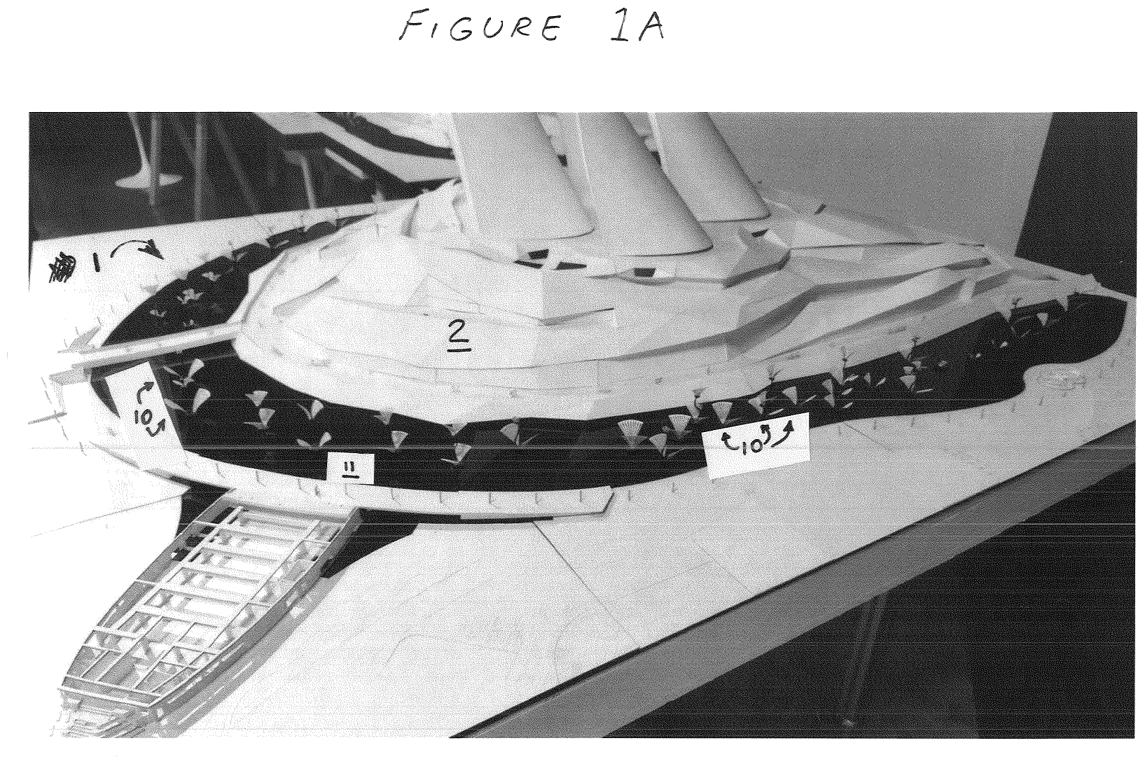

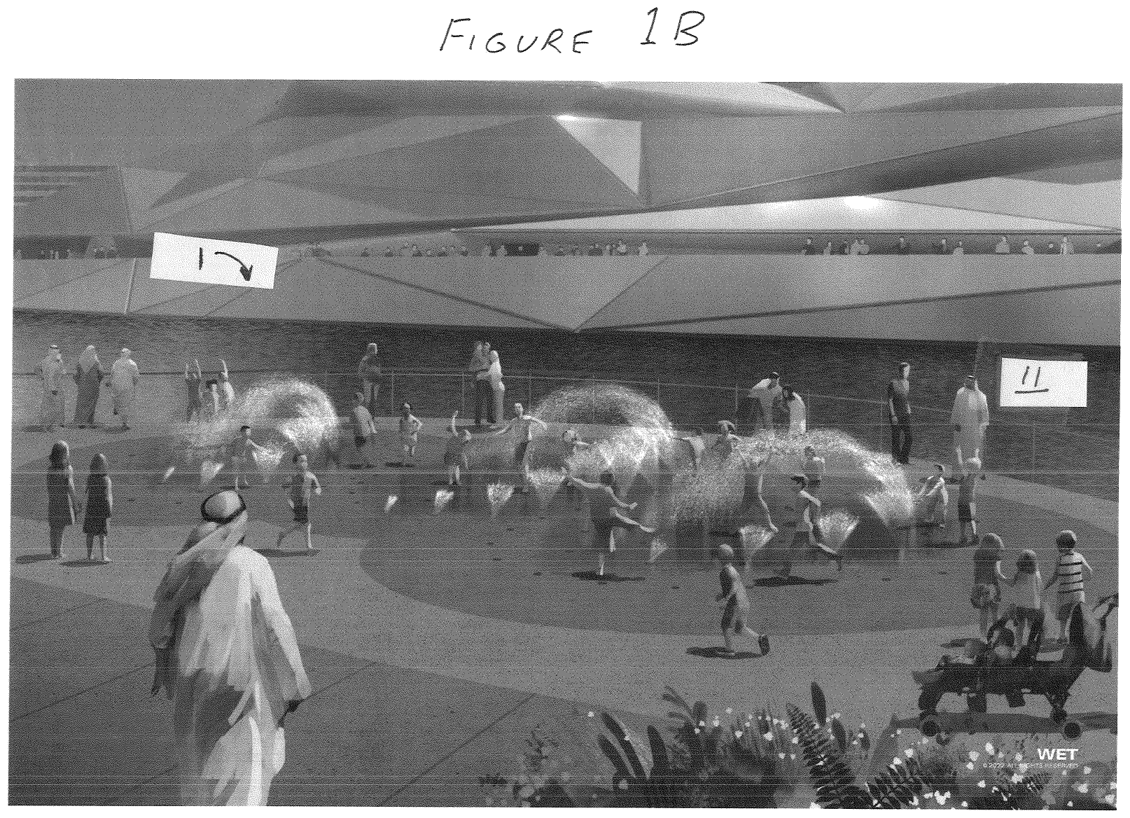

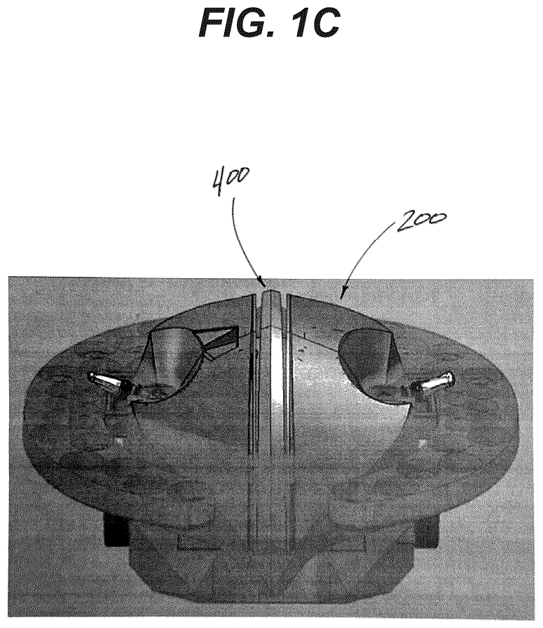

FIG. 1 shows a mobile aquatic expressive platform or mobile performance system 10. System 10 preferably includes a number of water delivery devices that emit streams of water in different expressions and at different heights. System 10 also preferably provides lighting effects, as well as other visual and/or sensory effects such as fog. One or more systems 10 may form part of an overall display or feature 1 as shown in FIG. 1A. The systems 10 may move about the reservoir 11 and provide visual and sensory effects in choreographed fashion for performances provided by display 1. For example, systems 10 may move about reservoir 11 while completely submerged, and then, while still moving, surface and perform a complex choreography of visual effects with the other systems 10.

The ability of systems 10 to move about reservoir 11, submerge and then surface, and emit water streams at varying heights above the reservoir and in different expressions, provides a wide variety of visual effects when compared to stationary water delivery devices. This in turn enhances the overall performances that may be provided by display 1. However, it should be noted that display 1 may include both mobile systems 10 as well as stationary water delivery devices which may also be controlled to provide a choreographed performance. For example, display 1 also may include one or more submersible, spinning performance platforms that may emits water streams and provide lighting effects. Additional water features may be located around the periphery of reservoir 11 as shown in FIG. 1B.

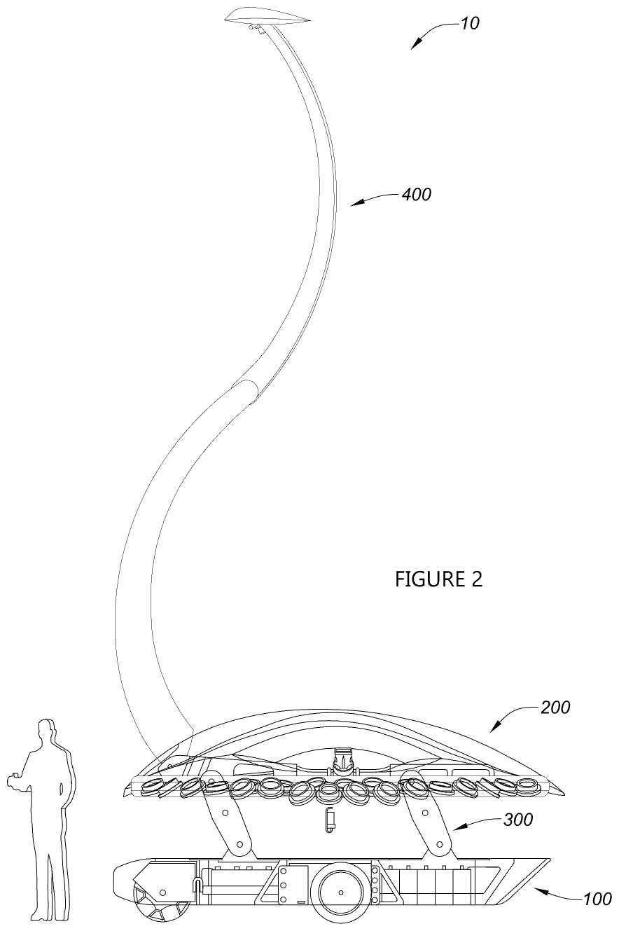

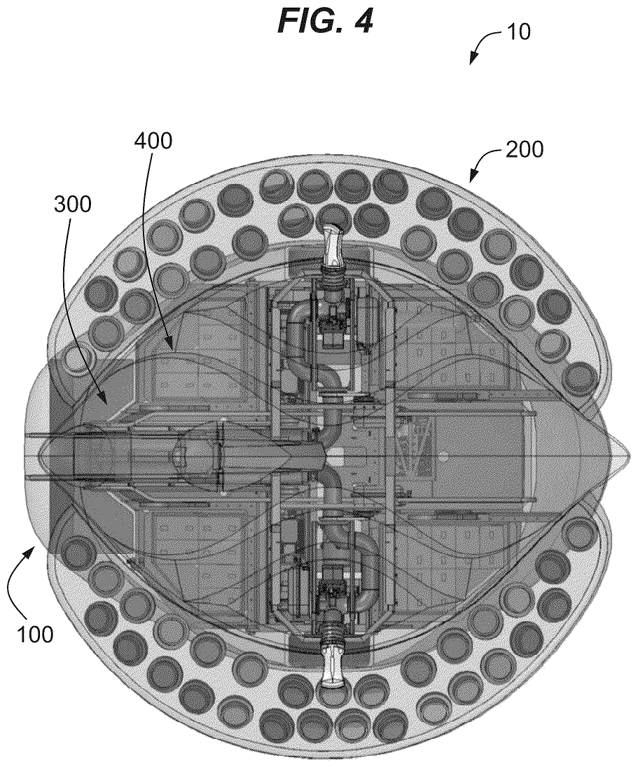

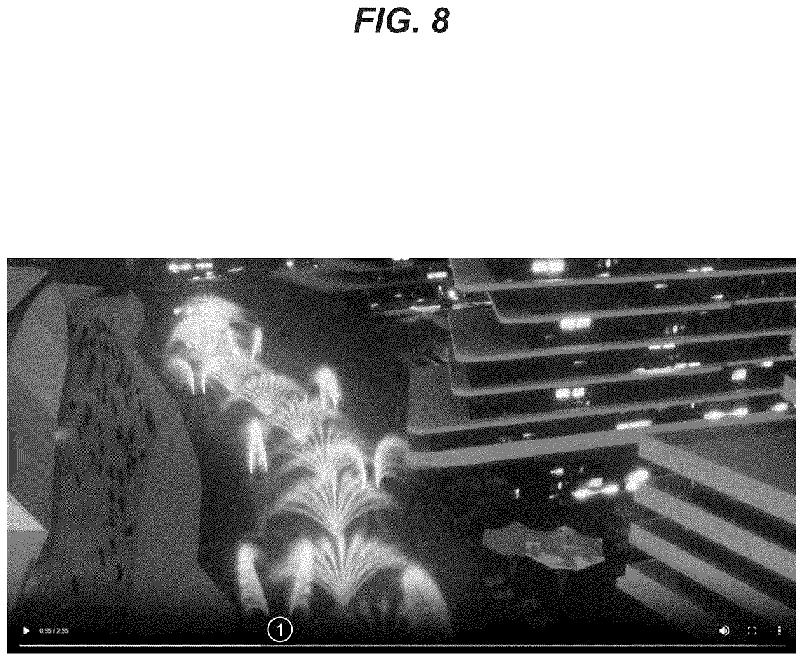

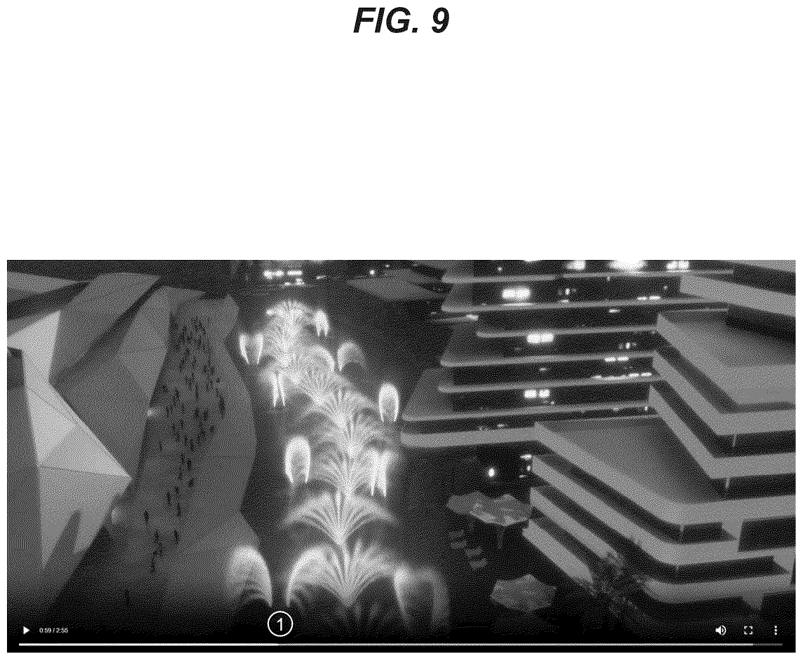

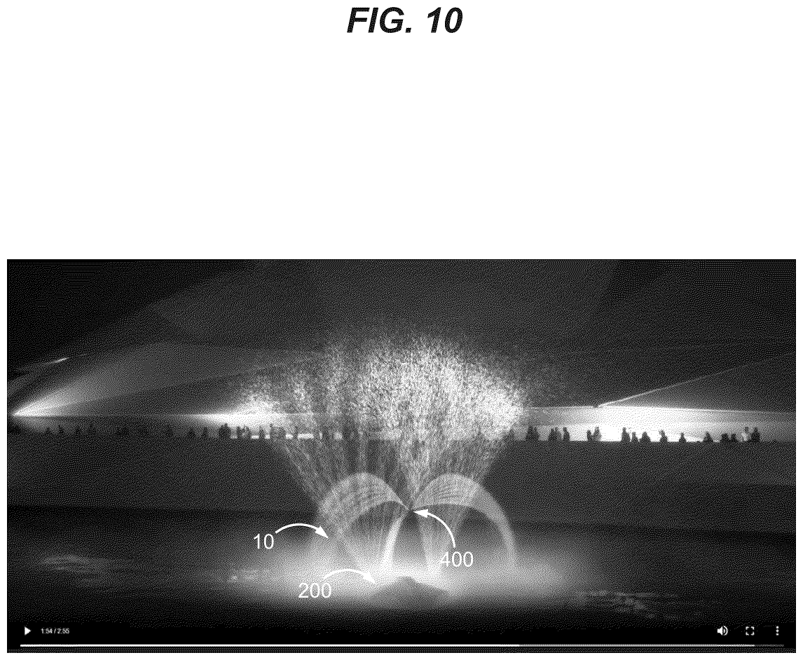

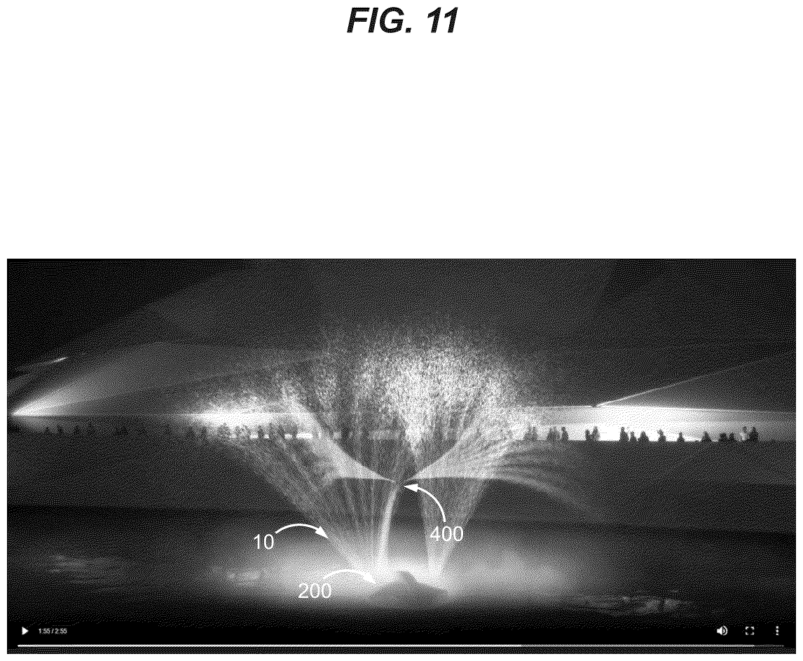

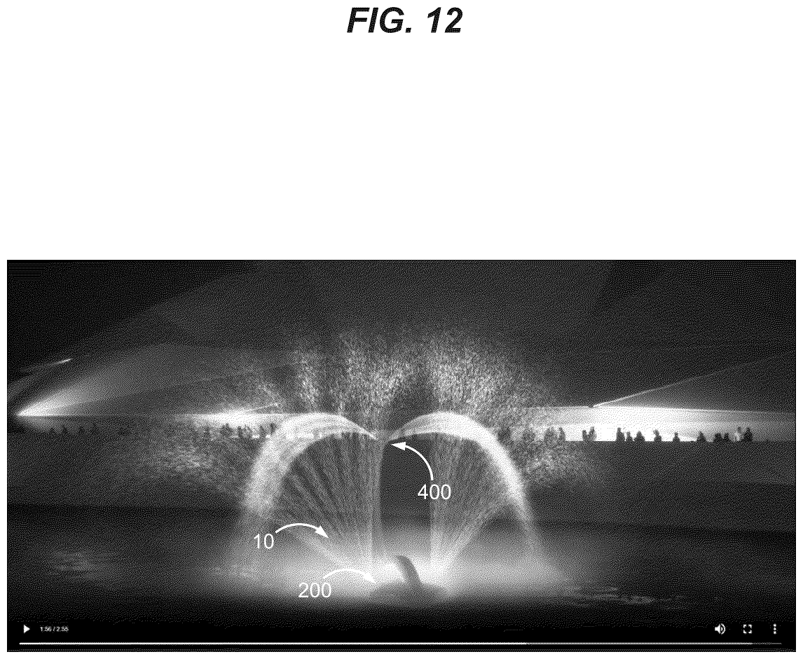

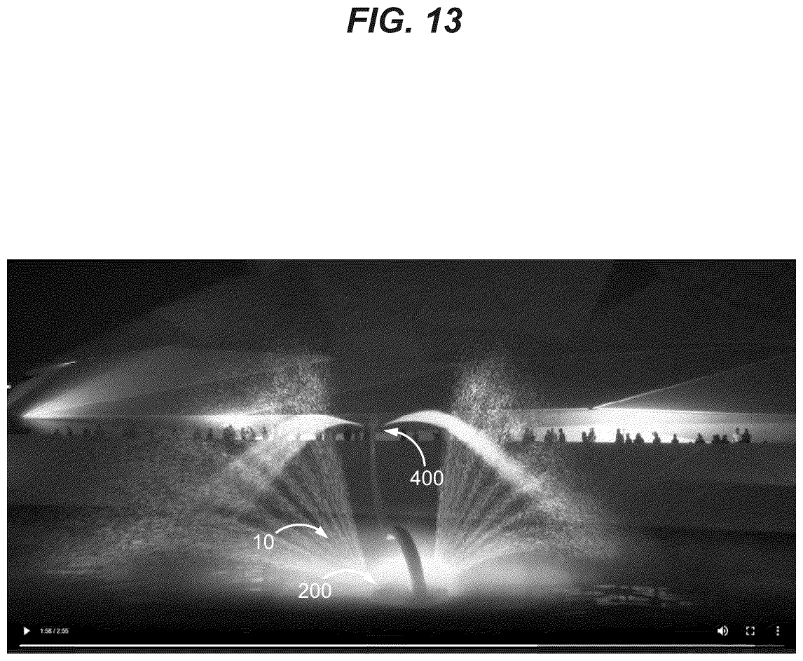

FIG. 1 is a perspective view of a mobile aquatic expressive platform or performance system 10 (also referred to herein as a movable water delivery device, or as simply, the system 10), and FIGS. 2, 3, and 4 show a side view, a front view, and a top view of the same, respectively. During a performance by display 1, one or more of the systems 10 may move about the reservoir 11, as shown in FIGS. 1A and 5-15.

For example, a number of systems 10 may be positioned within a themed water display 1 and may be controlled to perform choreographed multi-media water performances. Consistent with the desired theme, the display 1 may complement a building, landmark, or other location. For example, as shown in FIG. 1A, the display 1 may surround or be located in proximity to a museum 2. As described later, the water streams emitted from systems 10 may be choreographed with respect to each other, as well as with other visual and/or audio effects, e.g., lighting and music.

The choreographed movements of systems 10 may contribute to the overall theme provided by display 1. For example, systems 10 may emit water streams that simulate falcons taking flight which may reflect the culture of a country where falconry is symbolic of national pride, and which may be addressed in the museum 2.

In some embodiments, the system 10 may include an amphibious underwater mobile vehicle base, or movement system 100, a performance platform 200 which may include a sculptural shell, with lights and water fan expressions, a lifting system 300, and an articulated performance arm system 400.

In general, the movement system 100 may include an underwater robotic vehicle that acts as a base for the system's various payloads (e.g., 200, 300, and 400), as well as whatever nozzles or other water delivery devices may be mounted thereon. The movement systems 100 may include wheels so that it may travel on the reservoir floor according to control signals that reflect a desired choreography and performance. As such, movement system 100 may provide a movement, drive or propulsion function as well as a navigational function for the system 10. System 10 may autonomously drive around reservoir 11 while completely submerged, and then, while still moving, surface and perform complex choreography in coordination with other systems 10.

The performance platform 200 may be configured, positioned, or mounted generally on top of the movement system 100 and may include various performance elements such as water expression components or water delivery devices (e.g., nozzles, water sprayers, SHOOTER® devices, modified OARSMAN® devices and other types of water delivery devices). Performance platform 200 may also include lighting components, fog components, and/or sculptural components that may be employed during a performance by display 1.

The movement systems 100 may be controlled to move about the reservoir floor, e.g., in a choreographed pattern, while the performance platform 200 may be controlled to implement its choreographed performance elements. For example, while movement systems 100 travel in desired directions or patterns, the lights of performance platform 200 may be turned on or off, and its water delivery devices may be controlled to emit water streams at desired heights and/or in desired directions.

The lifting system 300 may be configured, positioned or mounted generally between the movement system 100 and the performance platform 200. The lifting system 300 may be movably coupled to the movement system and is designed to lift and lower the platform 200 relative to the movement system 100 during a performance by display 1. For example, the lifting system 300 may be in a non-deployed position or configuration such that the platform 200 is underwater or substantially underwater, and/or platform 200 is resting on base 100. The lifting system 300 may also deploy or extend, thereby lifting platform 200 above base 100 at various desired heights. For example, the lifting system 300 system may raise platform 200 so that it is slightly above the water surface, substantially above the water surface or at another desired height above the water surface.

As described in more detail later, the ability of system 10 to submerge or raise platform 200 may contribute to the visual effects provided by display 1. For example, the platform 200 may be raised while at one or more location(s) and emit water streams. Platform 200 may then submerge and be out of view or substantially out of view from observers while traveling to another location in reservoir 11. Platform 200 may then be raised and emit water streams from another location, thus giving the appearance that the source of the water stream moved by some distance between emissions.

The articulated performance arm system 400 may be configured or movably coupled or attached to the lifting system 300. As shown in FIG. 1C, arm system 400 may be positioned in a lowered, nested or non-deployed position where arm 400 is generally retracted and preferably hidden or located in a slot of platform 200, so that it is positioned within the profile of platform 200. When system 10 is submerged and moving about reservoir 11, the configuration where arm 400 is within the profile of platform 200 reduces hydrodynamic drag and assists system 10 to travel in reservoir 11. This configuration also contributes to system 10 having a sleek appearance, which provides contrast to when arm 400 is deployed as described below.

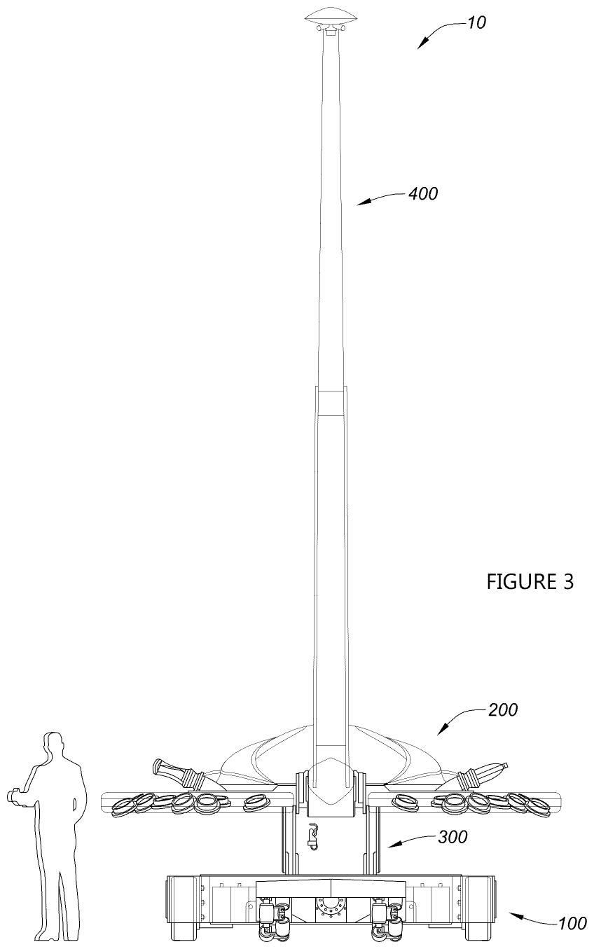

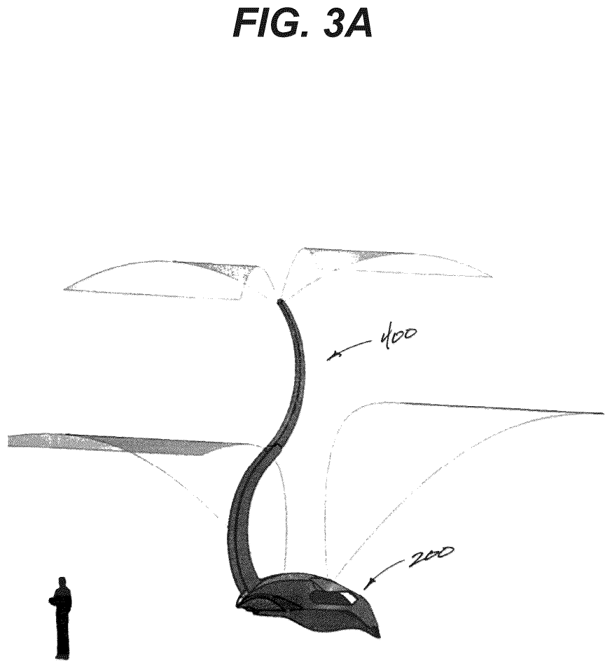

The articulating arm system 400 may be raised to an extended position (as shown in FIGS. 1-3) such that the distal end of arm 400 is raised above platform 200. A water expression mechanism, such as a Dual-Micro Oarsman™ water delivery device may be positioned at the apex of arm 400 to emit water streams. For example, as shown in FIG. 3A, dual fan expressions of water may be emitted from the apex or raised distal end of arm 400.

Additional performance payloads may be positioned along the length of arm 400, or at or near the upper end of the arm 400, e.g., additional water delivery systems, lighting, fog effects, etc. As discussed later, the water streams emitted from arm 400 may also be illuminated from lighting instruments positioned in performance platform 200. As also shown in FIG. 3A, fans of water may also be emitted from performance platform 200. These water fan expressions may be provided by modified OARSMAN® water delivery devices.

FIGS. 1-3 show the performance platform 200, as well as the articulated arm system 400 raised up to a deployed position. Lifting system 300 may serve to deploy both performance platform 200 and arm system 400.

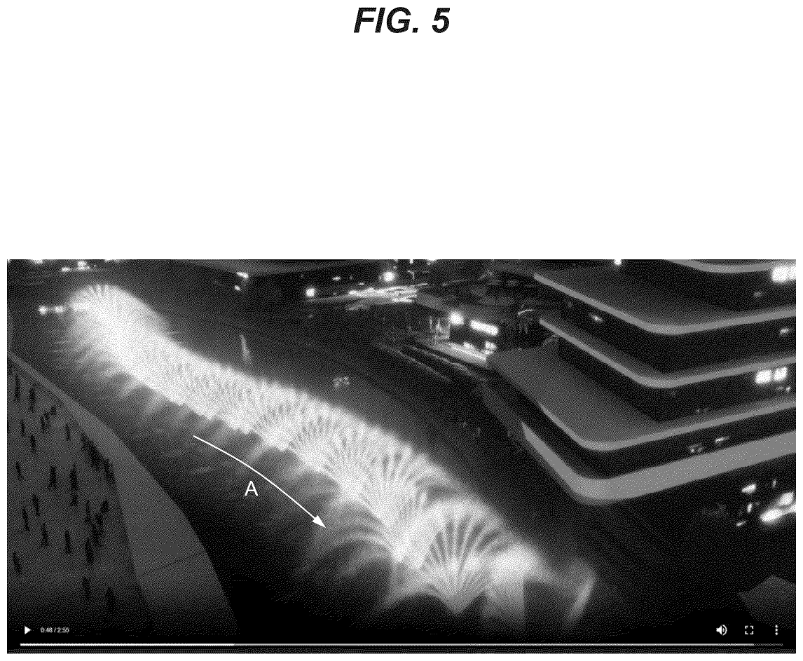

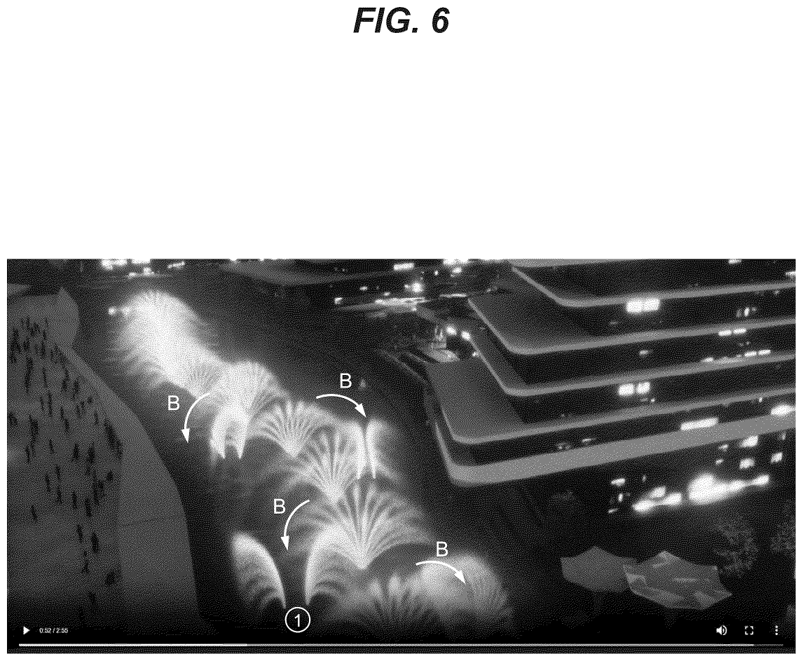

The manner in which system(s) 10 may move about reservoir 11 as part of a performance by display 1 is now described with reference to FIGS. 5-6. As shown, multiple mobile aquatic performance systems 10 (e.g., ten, twenty, or more) move about reservoir 11. Preferably, systems 10 are controlled to perform synchronized, choreographed performances.

For example, as shown in FIG. 5, a performance by display 1 may involve approximately twenty performance systems 10 traveling forward together in a generally single file arrangement (represented by the arrow A) with each system 10 emitting one or more streams of water, e.g., water fan expressions. As described in more detail later, the water fan expressions shown in FIG. 5 may comprise multiple streams of water emitted by individual water delivery devices. Alternatively, the water fan expressions may be formed by a variable width fan nozzle, or other similar types of devices, such as described in U.S. Pat. No. 10,376,902, the contents of which are expressly incorporated by reference as though fully set forth herein.

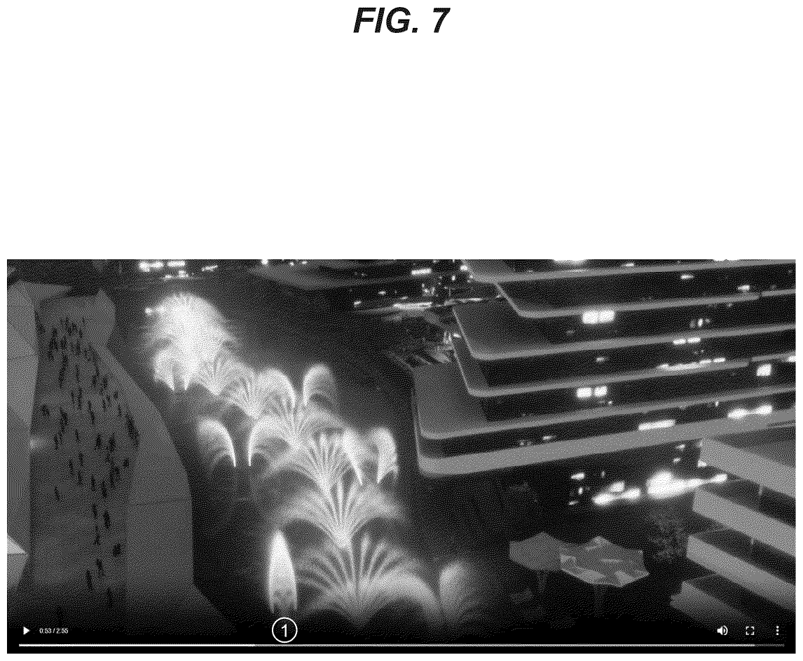

Then, as shown in FIG. 6, various systems 10 may divert (e.g., peel off) from the line up and begin performing additional synchronized movements (represented by the arrows B). The synchronized movements of systems 10 may be controlled according to a programmed choreography of a performance by display 1. To this end, the synchronized movements may include the direction in which systems 10 move, as well as the types of water streams they emit. As discussed herein, a controller may transmit appropriate control signals to cause these movements and visual effects. The controller may be programmed with appropriate software and may communicate with systems 10 by radio frequency or other suitable transmissions. FIGS. 7-10 show the choreographed movements of systems 10 and the water streams they emit.

In some embodiments, a performance system 10 may be controlled to emit left and right water fans that emulate the flapping of a bird's wings (e.g., a falcon). Just as a bird flaps its wings to gain flight, the water fans emitted by systems 10 may systematically flex upward and then downward in a continuous and gracefully flowing pattern, as the arm system deploys to a raised position. This aspect of the performance provided by display 1 is shown in FIGS. 10-14.

More specifically, the articulated performance arm 400 may begin to extend upward with its own left and right water sprayers located at its upper end performing a similar wing flapping pattern as described above. In this way, the top of the arm system 400 may provide the appearance of a bird taking off for flight. As shown in the figures, the top of arm 400 may increase its height above the reservoir 11, thus simulating a bird taking off. Then once at its maximum height, the performance arm system 400 may continue performing the water wing patterns as it appears to fly forward.

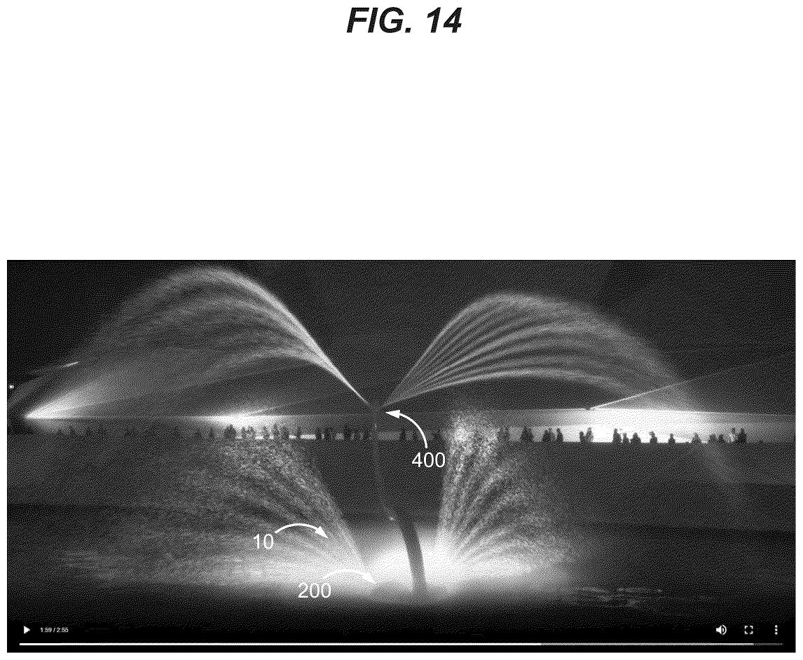

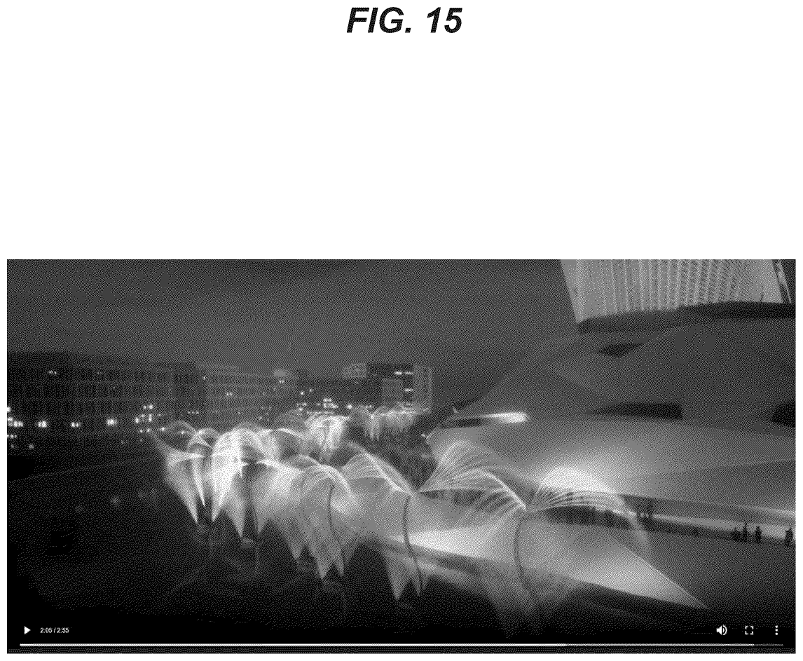

When the arms 400 of multiple systems 10 are fully deployed, this emulated wing flapping may continue as in FIG. 15, thereby simulating a flock of birds moving about reservoir 11. As shown in FIG. 15, multiple systems 10 may similarly employ their respective performance arm systems 400 thereby providing an appearance of a flock of birds flying together in a choreographed pattern. The raising of arm 400 to simulate a bird taking off, and the associated flapping of the birds' wings, as provided by the articulating water streams, may be controlled to provide an overall choreography for a performance by display 1. As discussed herein, a controller may transmit appropriate control signals to effect these movements. The controller may be programmed with appropriate software.

As shown in FIGS. 5-15, the various systems 10 also may implement lighting effects, fog effects, and other effects, e.g., music or other audio effects, that may be synchronized with the water effects described above. The foregoing may be controlled by a controller programmed to provide an overall choreography involving these effects to provide a performance by display 1.

In some embodiments, system 10 may be relatively large, and a sense of scale is provided by FIGS. 1-3 which shows a system 10 next to a person, and in FIG. 1A which shows systems 10 in reservoir 11 next to a large building. The relatively large size of systems 10 may complement the overall size of the displays in which they operate. Indeed, reservoir 11 may cover a number of acres and observers may be some distance from the visual effects provided by systems 10. As such, the size of systems 10 preferably allows observers to view and appreciate the performance by display 1 from a distance.

In any event, it should be noted that the current invention is not limited to the relatively large systems 10 of FIGS. 1-3. Indeed, systems 10 may be much smaller and may be used in other types of setting. For example, a smaller version of systems 10 may move about the pool at a private residence and provide visual effects when the residents are not swimming in the pool.

As described below, each system 10 experiences different forces during a performance. Referring again to FIGS. 1-3, the relatively large size of systems 10 means that it will gain significant momentum when it travels. Indeed, the forces exerted on system 10 by the deployment of arm 400, and the emission of water streams, may render system 10 unstable or difficult to control, let alone control in a synchronized fashion with a number of other systems 10. However, as described below, the stability provided by the base or movement system 100, the manner in which platform 200 and arm 400 are raised and lowered, and other aspects of the current invention provides stability.

An advance of the system 10 is that it may submerge and travel around reservoir 11, while protecting its interior components against leaks and other issues that may arise in a water environment. Another advance of systems 10 is how it addresses hydrodynamic forces it encounters as it moves through and interacts with the water of reservoir 11. These hydrodynamic forces also pose stability problems. This is especially so where system 10 is relatively large and may gain significant momentum as it moves.

However, as described below, the current invention has addressed these issues with an innovative, sculptured profile and surface, and a number of unique and innovative sub-systems and modules that provide for smooth and controlled movements by each system 10, as well as synchronized movements with respect to the other systems 10 moving about reservoir 11. As such, the current invention provides for an enhanced overall performance by display 11, where the movements of systems 10, their emission of water streams and their providing other visual effects are choreographed.

While the foregoing discussion referenced how the current invention overcame stability and control issues associated with large systems 10, the current invention encompasses performance systems 10 of varying sizes. To this end, a display 1 may not be so large as to surround a museum 2, and a much smaller performance system 10 would be required. Such performance systems 10 are within the scope of the current invention.

The movement system 100, performance platform 200, lifting system 300, and the articulated performance arm system 400 are now further described with reference to the figures.

### Movement System 100

As shown in FIGS. 1-4, the movement system 100 generally comprises a robotic wheeled vehicle designed to operate within a reservoir of water 11 (e.g., within a display 1) while carrying one or more payloads, e.g., the payloads 200, 300, 400 of the system 10. The movement system 100 may be low-profile (e.g., ˜16″ tall) and may be equipped to provide power, cooling, air, leak protection and/or control systems to the payloads that it may carry. The system 100 may be amphibious and may travel above and/or below the surface of the water. While driving on the bottom surface of a reservoir 11, the movement system 100 may travel at speeds up to and exceeding 5 mph while carrying payloads weighing up to and exceeding 6000 pounds. The movement system 100 may remain underwater indefinitely while being powered by on-board batteries that may be charged from the surface and/or while the system 100 is submerged. System 10 may have other dimensions and characteristics beyond those identified above. Furthermore, system 100 preferably provides the foregoing amphibious and underwater functions while providing a water resistant or watertight seal to protect control systems and other components that may be adversely affected by the water of reservoir 11.

The shape and style of movement system 100, along with performance platform 200, is preferably distinctive and sculptural in form. As such, system 10 is preferably both stylish as well as hydrodynamically sleek for purposes of moving smoothly through the water thereby providing stability to system 10. For example, the shape, contour of system 10, as defined by the shape and profile of movement system 100 and performance platform 200, preferably avoids excessive drag while moving through the water, and also avoids any effects that would cause the system 10 to surf or rise up and lose contact with the reservoir floor. As such, the system 10 may remain submerged until for certain periods of the performance.

To optimize the overall hydrodynamic characteristics of system 10, the current invention has involved hydrodynamic analysis of the general shape and contours of movement system 100, along with performance platform 200 (when platform 200 is in a lowered position directly on top of movement system 100). For example, lift-to-drag ratios and other calculations were performed for system 10 in a submerged state, and for system 10 in a partially submerged state, i.e., when a portion of performance platform 200 raises above the water's surface.

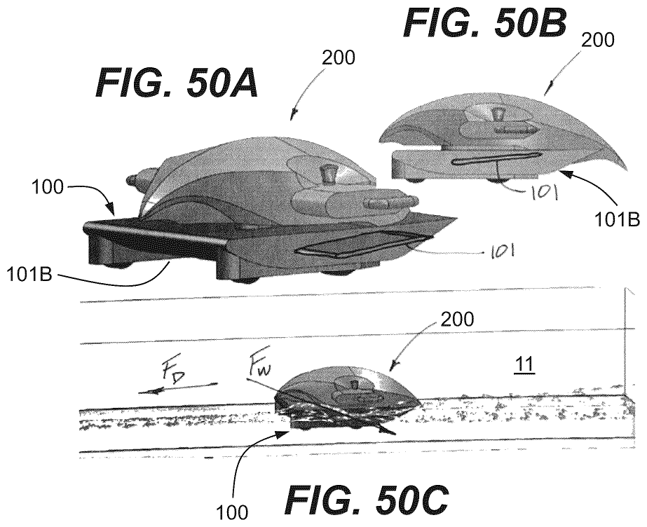

As shown in FIGS. 50A and 50B, movement system 100 may include a sloped rear surface 101A to help avoid turbulence at the back end of system 10. Movement system 100 may also include a channeled bottom 101B to facilitate smooth travel and stability through the water.

In some embodiments, as shown in FIGS. 50A-50C, the movement system 100 may include one or more downward angled winglets 101, e.g., on the left and right sides of the system 100. In some embodiments, the winglets 101 may include an angle of inclination of about 6° to provide an adequate downward force FW to the system 100 (e.g., via the Bernoulli effect) and without causing an excessive amount of drag and/or turbulence as the system 100 travels in the forward direction FD (as shown in FIG. 50C).

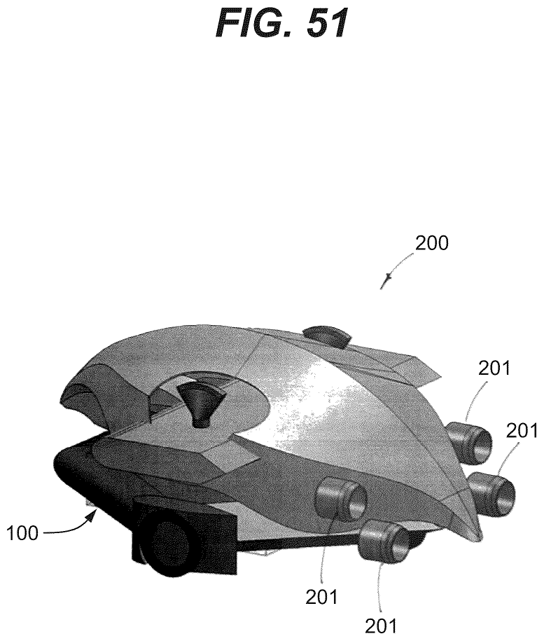

Additionally, as shown in FIG. 51, the performance platform 200 may include one or more thrusters 201 arranged and angled appropriately (e.g., located at or towards the rear end of performance platform 200) to emit pressurized water to provide additional downward forces to the system 10 as it moves forward through the water.

The use of appropriate ballast weight located in movement system 100 also contributes to the stability and hydrodynamic characteristics of system 10.

The movement system 100 also allows the lifting system 300 and the performance platform 200 to be mounted on and configured with movement system 100, so that these systems 200, 300 also avoid hydrodynamic issues such as drag and surfing. As such, the movement system 100 allows the overall system 10 to be hydrodynamically stable.

As described herein, the movement system 100, and system 10 overall, address engineering issues, including providing power to overcome water drag, hydrodynamic lift reduction, traction with the reservoir floor, buoyancy reduction, water intrusion, heat dissipation and communication. Various modules, subsystems or components of movement system or vehicle 100 are now further described.

### Chassis 102 (Also Referred to as Module M14)

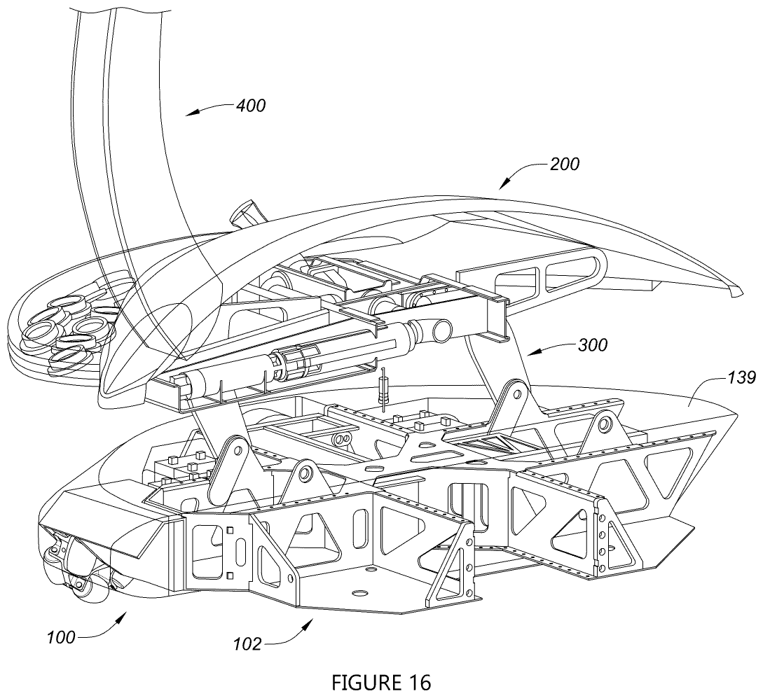

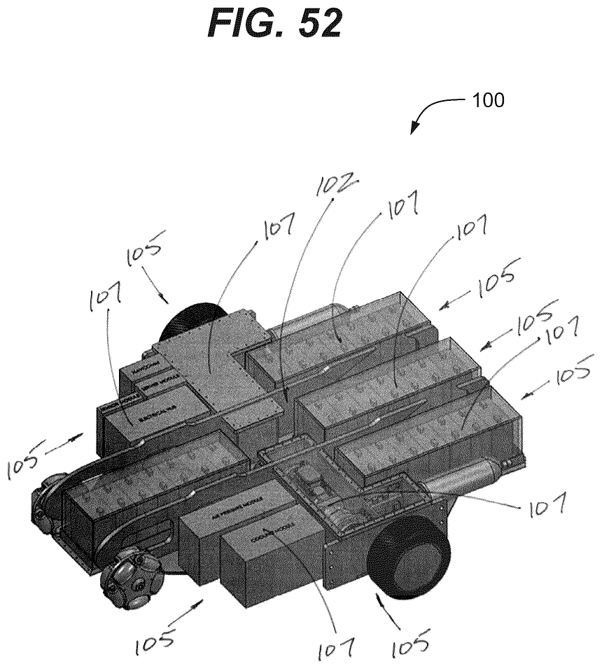

In some embodiments, as shown in FIGS. 16-17, the movement system 100 may include a chassis 102 designed to contain and support various functional modules of the movement system 100 and of the overall system 10 in general. The movement system 100 also may provide support to the system payloads 200, 300, 400, and provide movement and navigation functions of the overall system 10. The chassis 102 may include one or more predefined compartments (e.g., fuselages) and/or attachment structures, each designed to house and attach a particular module while preferably optimizing space. For example, as shown in FIG. 52, the chassis 102 may include a plurality of fuselages 105, each designed to receive and contain a particular functional module 107. For example, fuselages 105 may accommodate functional modules 107 such as drivetrain, cooling, air compression, Nav/Comms, server, sensors, batteries, omni wheels and/or other types of modules 107. Specific fuselages 105 and corresponding modules 107 will be described in other sections. Each functional module 107 is preferably independent, replaceable, and water-resistant or waterproof. Gaskets may also be used between the modules to further enhance protection against water leaks. In this way, failed modules may be easily removed and replaced, and any water leaks that may occur may be isolated to limit widespread water damage to other modules.

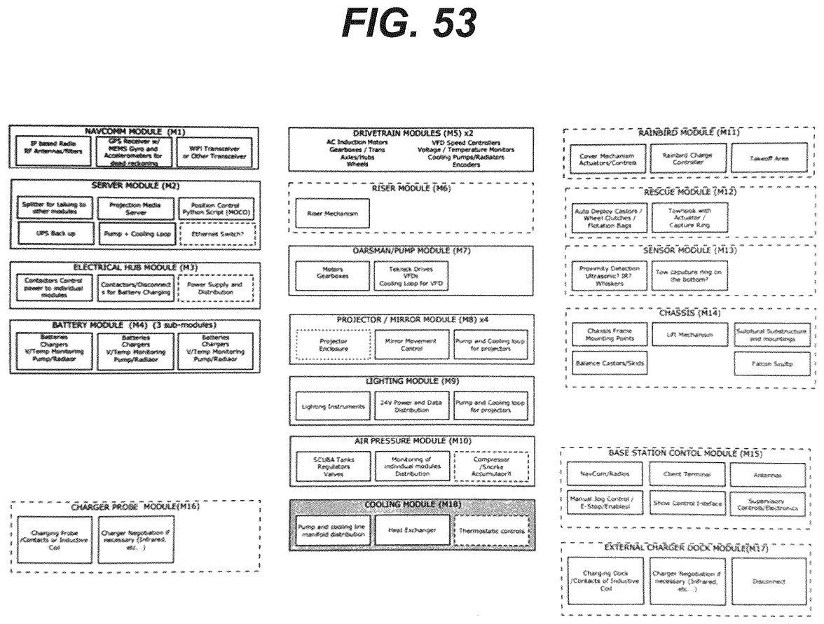

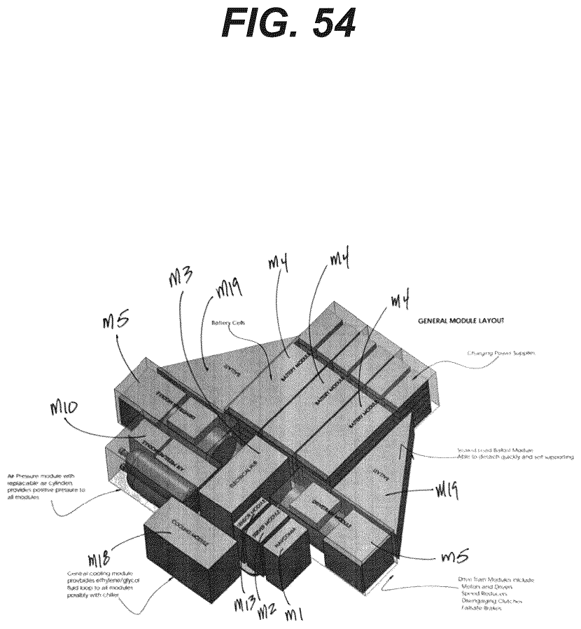

FIG. 53 shows a block diagram of various functional modules that the system 10 may include, and FIG. 54 shows an exemplary arrangement of the modules within dedicated fuselages 105 of the chassis 102. For example, in some embodiments, the system 10 may include the following modules 107 (without limitation):

NavComm module M1, server module M2, electrical hub module M3, battery module M4, drivetrain module M5, riser (lifting) module M6, Oarsman/pump module M7, projector/mirror module M8, lighting module M9, air pressure module M10, rainbird (arm) module M11, rescue module M12, sensor module M13, chassis M14, base station control module M15, charger probe module M16, external charger dock module M17, cooling module M18, and/or other modules. The system 10 also may include one or more ballast modules M19 (e.g., on the left and right sides).

In addition, some modules 107 may include other modules. For example, the drivetrain module M5 may include left and right drive wheel modules, and a front axle and omni wheel system. These will be described in further detail in other sections.

In some embodiments, the various modules 107 may be connected to the chassis 102 using quick-connect harnesses, including e.g., a coolant loop harness, an air purge harness, a high-voltage electrical harness, a low-voltage electrical harness, and/or other harnesses and/or structural attachment mechanisms as required.

In any event, an advantage of the current invention is the manner in which all the functional modules 107 may be efficiently packaged within chassis 102 and movement system 100, and provide a wide array of functions for system 10. Indeed, as described herein, it is a significant advance that all of these functions, e.g., the movement of system 10 around reservoir 11, the lifting of platform 200 and of arm system 400 by lifting system 300, the emission of water expressions, the provision of visual effects such as lighting and fog, and the computer control of system 10 as part of an overall choreography provided during a performance by display 1, may be based on the modules packaged within movement system 100. This packaging aspect also contributes to the stability of system 10 by providing a lower center of gravity, and to the hydrodynamic characteristics of system 10. The modularity of this packaging aspect also helps protect the functional modules 107 from leaks and other issues that may arise in a submerged water environment, or when transitioning between submerged and surfaced environments, i.e., submerged or performance positions.

In some embodiments, as shown in FIG. 17, the chassis 102 may include a chassis longitudinal axis L_{C1} extending from its forward end to its rear end, a front floor pan 104 defining a forward portion of the chassis 102, and a rear floor pan 106 defining a rear portion. The chassis 102 also may include a forward spar 108 generally traversing the chassis 102 perpendicular to the longitudinal axis L_{C}, e.g., at the rear of the front floor pan 104, and a rear spar 110 generally traversing the chassis 102 perpendicular to the longitudinal axis L_{C1}, e.g., at the front of the rear floor pan 106. The forward and rear spars 108, 110 may extend upward from a corresponding floor pan 104, 106 and may provide rigidity and support to the floor pans 104, 106 and to the overall chassis 102. The chassis 102 also may include a left support spacer 107 extending between the front and rear floor pans 104, 106 on the left side and a right support spacer 109 extending between the front and rear floor pans 104, 106 on the right side.

In addition, the chassis 102 may include a forward left support truss 112, a forward right support truss 114, a rear left support truss 116, and a rear right support truss 118, each extending upward from a corresponding floor pan 104, 106 and generally parallel to the chassis longitudinal axis L_{C1}. The chassis 102 also may include a central tube 120 extending along the chassis longitudinal axis L_{C} between the forward and rear spars 108, 110. The central tube 120 will be described in detail in other sections.

A forward left fuselage 122 may be defined by the forward left support truss 112 and the forward spar 108, a forward right fuselage 124 may be defined by the forward right support truss 114 and the forward spar 108, a rear left fuselage 126 may be defined by the rear left support truss 116 and the rear spar 110, and a rear right fuselage 128 may be defined by the rear right support truss 118 and the rear spar 110. A forward middle fuselage 123 may be defined by the chassis' forward left support truss 112 and its forward right support truss 114, and may generally reside between the forward left and right fuselages 122, 124. A middle left fuselage 130 may be defined by the front and rear spars 108, 110 and the central tube 120, and a middle right fuselage 132 may be defined by the front and rear spars 108, 110 and the central tube 120. The fuselages 122, 124, 126, 128, 130, 132 may be designed to each hold a particular functional module of the movement system 100 as described in other sections.

In addition, in some embodiments, the chassis 102 may include a front axle mount 129 including left and right diagonal supports 131 and left and right lift plates 133. As will be described in other sections, the movement system 100 may include a front omni wheel system 140 that may be mounted to and/or supported by axle mounts 129, diagonal supports 131, lift plates 133 and/or other suitable components.

In some embodiments, as shown in FIGS. 17-18, the chassis 102 may include a top plate 134. FIG. 17 shows the top plate 134 attached to the chassis 102 and FIG. 18 shows the top plate 134 separate from the chassis 102. When attached, the top plate 134 may provide a top cap to the chassis 102, e.g., in the area of the central tube 120, and also provide rigidity to the overall chassis 102. In some embodiments, the top plate 134 may be shaped to generally correspond to the top surfaces of the front and rear support trusses 112, 114, 116, 118, the central tube 120, and corresponding portions of the front and rear spars 108, 110.

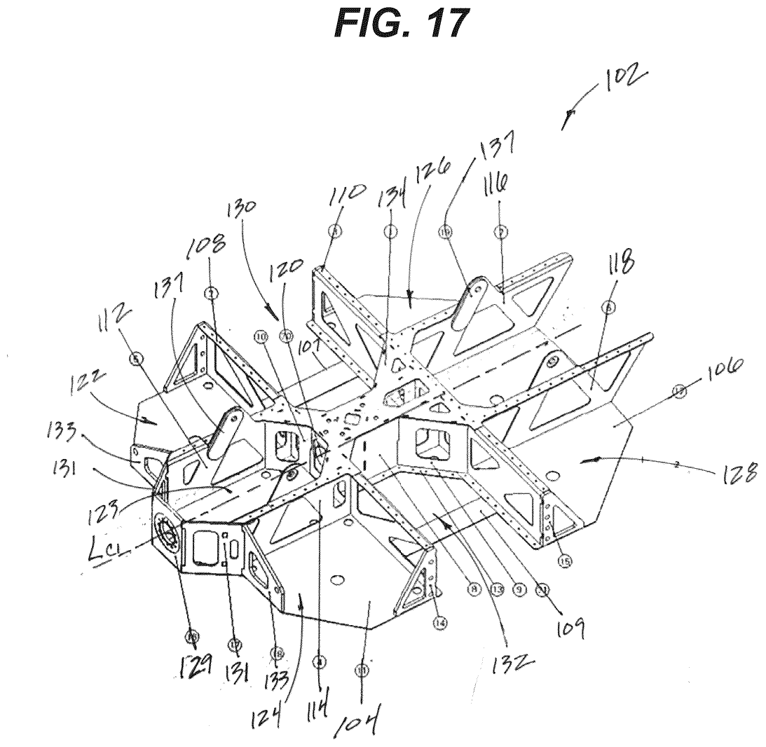

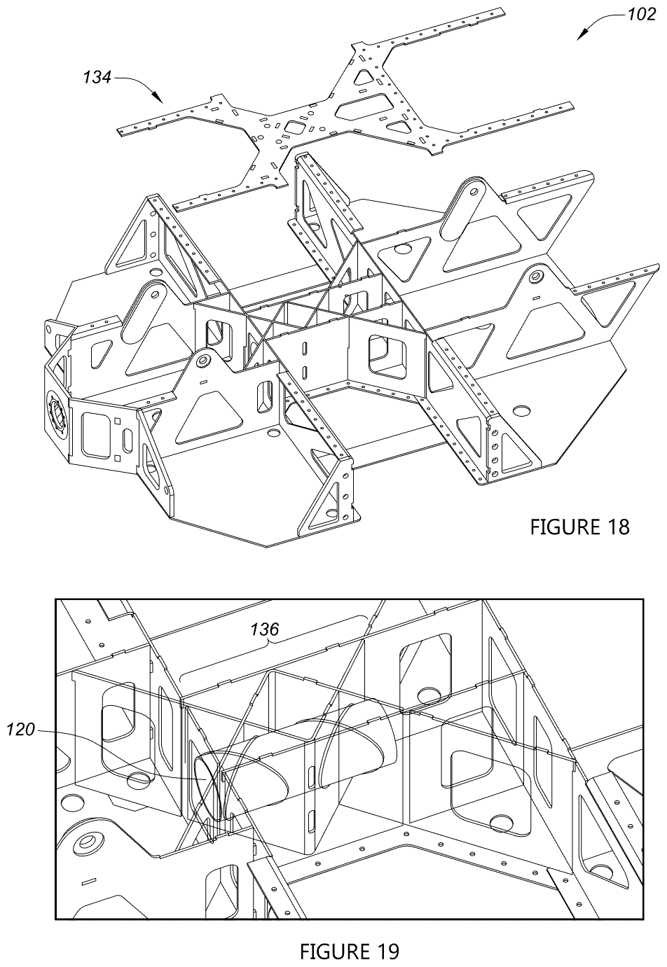

In some embodiments, as shown in FIG. 19, the chassis 102 may include one or more X-braces 136 in its center portion, e.g., along the central tube 120, that may provide torsional support to the chassis 102. The central tube 120 may pass through an opening in the X-braces 136 along the chassis longitudinal axis L_{C1} and may provide additional torsional support by acting as a torsion tube. As described in other sections, the central tube 120 also may act as a plenum for electrical, air, and cooling lines.

In some embodiments, the chassis 102 also may include one or more hard points 137, e.g., reinforcements, that may provide additional strength and rigidity at particular locations on the chassis 102. The hard points 137 may include an extra layer of material, e.g., a steel plate, added to the base material making up the chassis 102. For example, the chassis 102 may include one or more hard points 137 to strengthen the support trusses 112, 114, 116, 118 upon which the lifting system 300 and the performance platform 200 may be attached. Hard points 137 also may be placed where the drive modules 138 and the front omni wheel system 140 are attached to provide additional strength in these areas as well.

In some embodiments, the chassis 102 may be formed using stainless steel or other suitable materials. In some embodiments, the floor pans 104, 106 may comprise 3/16″ thick stainless-steel plates, and the spars 108, 110 and the support trusses 112, 114, 116, 118 may comprise ¼″ thick stainless-steel. The hard points 137 may comprise thicker ½″ and/or ¾″ steel plates. Slot and tab construction of the various elements of the chassis 102 may be preferable to facilitate precise fittings, easy fabrication, and part interchangeability, with minimal fixturing. In addition, the chassis 102 may be designed as an open platform to enable future expansions and interchangeability of the mounted equipment as needs may arise.

It is preferred that the foregoing components comprise a material that may withstand an underwater environment. It is also preferred that these components be attached by welds, fasteners or other suitable attachment means so that they are secured to each other so that chassis 102 has sufficient strength to support payloads above it.

The configuration of the foregoing components, i.e., their dimensions and the manner in which they are assembled, also helps contribute to the overall performance by display 1. That is, these components are dimensioned, assembled and packaged within movement system 100, such that the low-profile movement system 100 may remain underwater or substantially underwater, and out of the observers' view during the performance; while the performance platform 200 and arm 400 provide visual effects to the observers. This may enhance the performance as viewed by observers because the movement system 100 may not be intended to provide visual effects while the payloads it supports do. Instead, the movement system 100 may provide its support functions while remaining hidden, or largely hidden, from the view of the observers.

While contributing to the overall performance in this manner, the configuration of the foregoing components preferably still also (i) provides the strength to support its payloads, (ii) provides the ability to move the weight of its payloads about the reservoir 11 according to the desired choreography of the performance, (iii) provides stability and accommodates the forces, momentum and inertia variations that may occur when lifting system 300 elevates platform 200 and when arm system 400 deploys and (iv) provides stability and accommodates the forces, momentum and inertia variations that may occur when water delivery systems mounted on platform 200 and arm 400 emit streams of water. As such, the versatility of movement system 100 fulfills a number of functions and requirements so that display 1 may provide visually stimulating performances to the observers.

### Chassis Shell 139

In some embodiments, as shown in FIG. 16, the chassis 102 may be fitted with a shell 139 that may generally provide a cover or housing to the chassis 102 and to the various modules configured therein. The shell 139 may preferably be hydrodynamic to reduce both drag and lift that system 10 may encounter as it moves through the water of reservoir 11, e.g., when performance platform 200 and arm 400 are raised and deployed. As such, shell 139 may contribute to the overall stability of system 10.

In some embodiments, the shell 139 may include hard points for mounting, supporting, engaging and/or otherwise interfacing with the system payloads 200, 300, 400 and the functional modules. These may include appropriate brackets and other suitable components.

The shell 139 may provide water resistance or water proofing to the components and modules contained therein. However, in some embodiments, the shell 139 may be purposely designed to allow water from reservoir 11 to flow through the shell 139 and into specific locations of chassis 102, to provide cooling to the functional modules within. Other areas of the shell 139 may be sealed and watertight. In some embodiments, the shell 139 may comprise one or more panels that may be easily removed or hinged to the side to provide access to the various sub-systems and to maintenance points on the movement system 100.

### Drive Modules 138 (Also Referred to as Module M5)

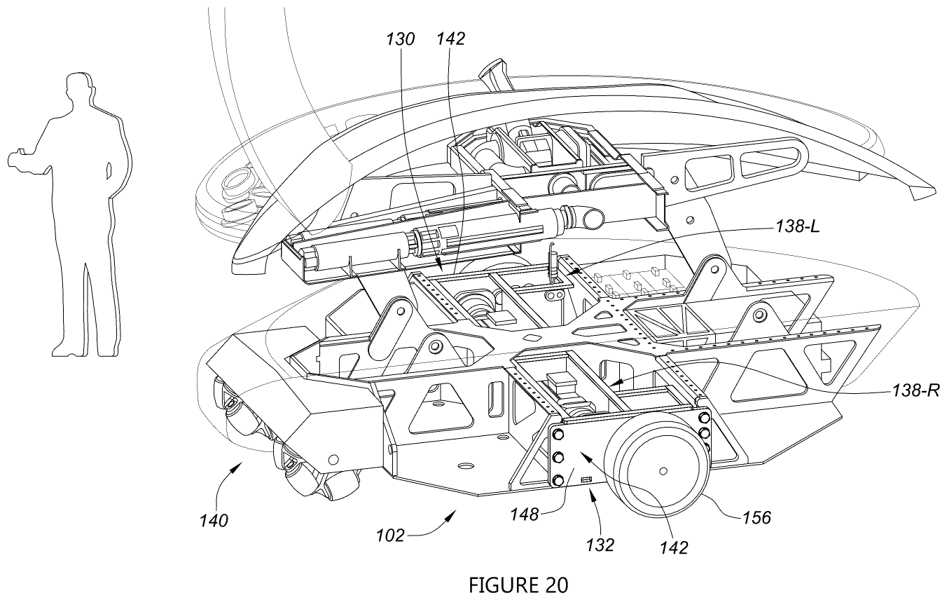

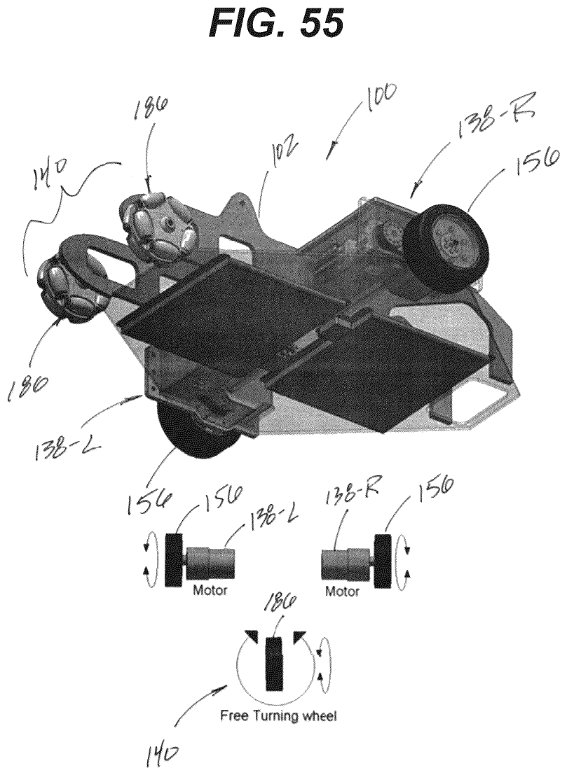

In some embodiments, as shown in FIG. 20, propulsion and steering of the movement assembly 100 is facilitated by left and right drive modules 138-L, 138-R, and a front omni wheel system 140. In some embodiments, as shown in FIG. 55, the arrangement of the left and right drive modules 138-L, 138-R (each including a drive wheel 156) and of the front omni wheel system 140 (including omni wheels 186) provides a semi-homonymous differential drive system, allowing the movement system 100 to perform zero-point spins on its central axis, tight turns, as well as straight travel. To show this general concept, FIG. 55 also shows conceptual representations (below the main diagram) of the drive modules 138-L, 138-R as left and right motor-driven wheels 156, and of the omni wheel system 140 as a free turning front wheel 186. This design may be mechanically and programmatically simple to implement, may eliminate the need for a steering mechanism, and may preferably place the system's center of gravity directly in front of the drive wheels 156 when the system 100 is at full speed. The design also may include a rear skid.

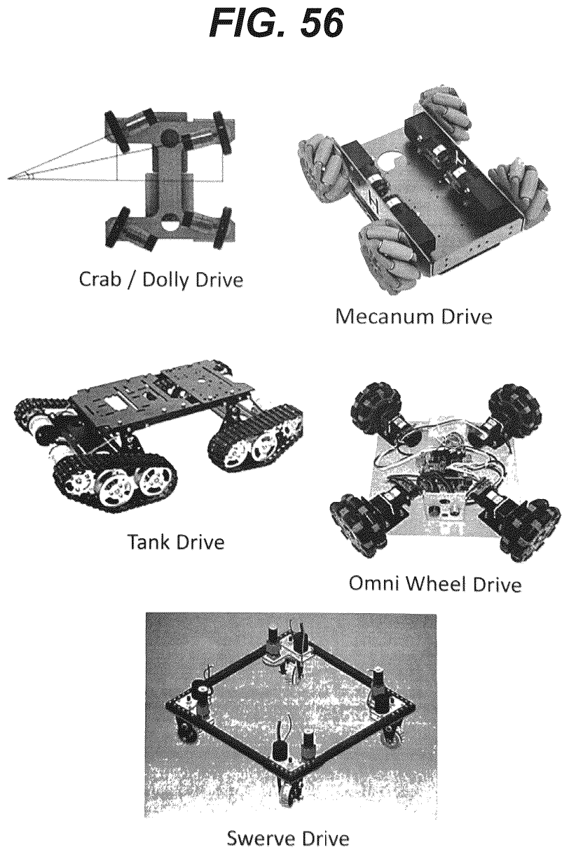

In other embodiments, as shown in FIG. 56, other types of drive mechanisms and architectures also may be used, e.g., a crab/dolly drive, a Mecanum drive, a tank drive, an omni wheel drive, a swerve drive, and/or other suitable types of drives.

Returning to FIG. 20, the left drive module 138-L may be housed within the middle left fuselage 130 and the right drive module 138-R may be housed in the middle right fuselage 132. In this way, the left and right drive modules 138-L, 138-R may be mirrored on the left and right sides of the movement system 100. As will be described in other sections, the front omni wheel system 140 may be positioned and/or attached to the front of the chassis 102.

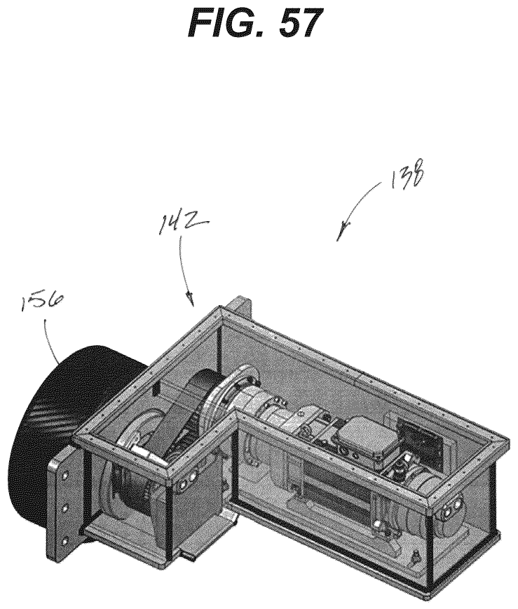

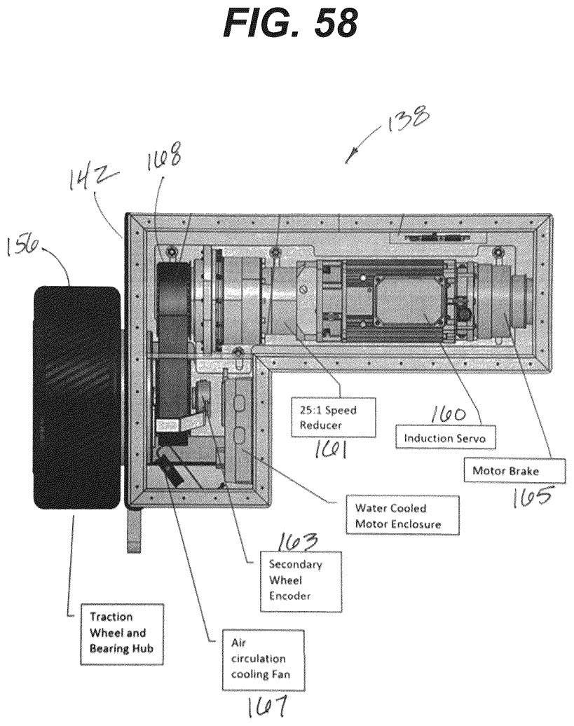

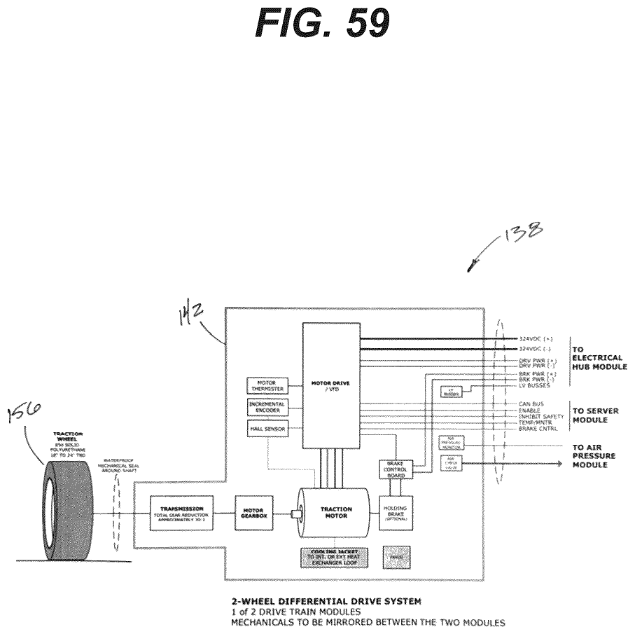

FIG. 57 shows a perspective view of a drive module 138 mechanical layout, FIG. 58 shows a top view thereof, and FIG. 59 shows a drive module block diagram. In some embodiments, each drive module 138 may include a motor box 142 inside which the various components of the drive module 138 are housed. Each motor box 142 is preferably waterproof and configured as a module that may be easily installed and/or removed from the chassis 102 as a single unit (e.g., during assembly of the system 10, for maintenance, etc.). The motor box 142 may be water cooled. In addition, it may be preferable that the removal of the drive module 138 from the chassis 102 not require the disassembly of any water seals. Alternatively, the drive modules 138 may be permanently integrated with the chassis 102.

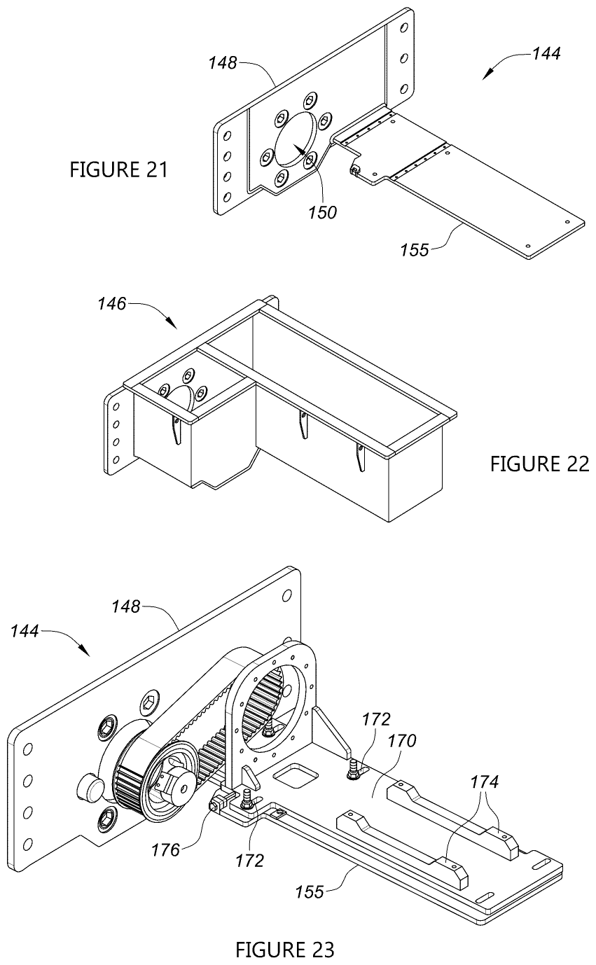

As shown in FIGS. 21 and 22, the motor box 142 may include a structural weldment 144 that acts as a base to provide structural support to the drive module's components, and a box weldment 146 that fits over the structural weldment 144 to provide a waterproof housing for the module 138.

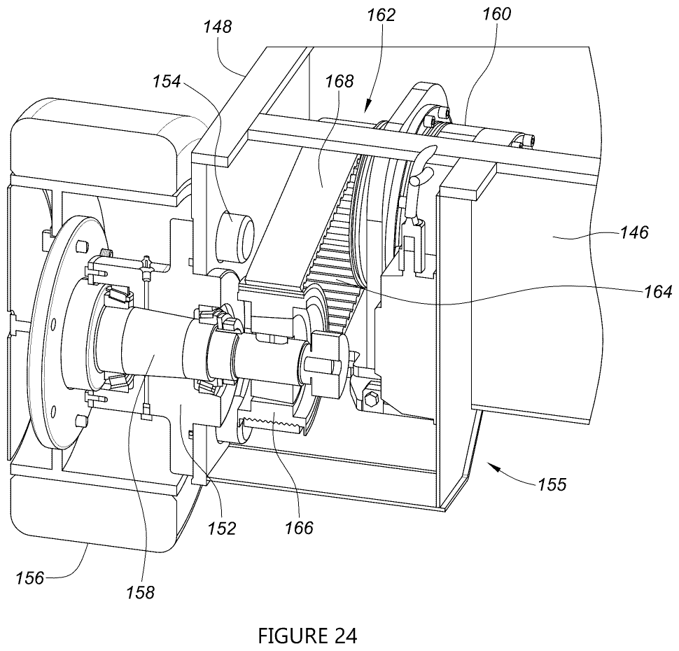

As shown in FIG. 21, the structural weldment 144 may include a front plate 148 that acts as an outer wall to the motor box 142 (see FIG. 57) with a through-port 150 to support the wheel hub 152 (also see FIG. 24). The wheel hub 152 may be configured within the through-port 150 and secured to the front plate 148 using water-sealing blind nuts 154. As such, bolts may be installed from the outside surface of the front plate 148 to engage the nuts 154 without the need for assembly tools to be inserted into the motor box 142. Each blind nut 154 may include an outward facing O-ring to provide a water-tight seal with the hub 152 and front plate 148. In addition, the drive module 138 may be positively pressurized to a desired level so as to expel water but not to extrude grease into the reservoir 11.

As shown in FIG. 24, each drive module 138 may include an external drive wheel 156 mounted to a drive axle 158 supported to rotate within the wheel hub 152. The drive wheel 156 in FIG. 24 is shown as a sectional view to show these inner components. The axle 158 may extend from the wheel 156 through the wheel hub 152 and into the motor box 142 where it may be configured with the drive assembly.

In some embodiments, as shown in FIG. 21, the structural weldment 144 also may include a base plate 155 extending generally perpendicular from a bottom side of the front plate 148. The base plate is preferably designed to support a drive motor 160, its drive assembly 162, and other functional components (see FIGS. 23, 24, 57, 58). The drive assembly 162 may include a first drive sprocket 164 configured with the motor's drive pin, a second drive sprocket 166 configured with the wheel's axle 158, and a drive belt 168 (or similar, e.g., a drive chain) that may engage the first and second sprockets 164, 166.

With this arrangement, the drive motor 160 may be controlled to rotate its drive pin which in turn may rotate the first drive sprocket 164 thereby causing the rotation of the second drive sprocket 166 via the drive belt 168. The rotation of the second sprocket 166 may cause the rotation of the wheel's axle 158 which in turn may cause the outer drive wheel 156 to rotate and propel the movement system 100. The drive motor 160 is preferably liquid cooled, e.g., by a dedicated cooling module. The way in which the motor 160 is controlled to move the movement system 100 in a choreographed pattern will be described in other sections.

In some embodiments, as shown in FIG. 58, the drive modules 138 also may include a speed reduction mechanism 161 (e.g., planetary gear reduction) and an electric motor controller. The motor 160 may be fully encoded with an additional external encoder 163 configured with the wheel's axle 158. The motor 160 also may include a motor brake 165 that may be engaged to prevent movement of the movement system 100 when in fail-safe conditions. A cooling fan 167 also may be implemented within the motor box 142 to provide additional cooling.

In some embodiments, as shown in FIG. 23, the base plate 155 may include a drive belt tensioning system comprising an adjustment plate 170 moveably attached to an upper surface of the base plate 155 via one or more slotted bolts 172. The adjustment plate 170 may include one or more motor mount rails 174 (preferably comprising brass or other suitable material(s)) upon which the drive motor 160 may be mounted and held in proper alignment. The tension of the drive belt 168 may be set by adjusting the position of the adjustment plate 170 relative the second sprocket 166 via an adjustment screw 176. Once set, the plate 170 may be locked by tightening the slotted bolts 172 thereby locking the belt tension setting.

In some embodiments, the drive wheel 156 features a stainless-steel hub and a polyurethane tire attached using standard lug nuts. The treads on the tires are designed to provide smooth rolling on the water basin floor with optimized underwater traction. For example, in some embodiments, the tires may be generally smooth and may not include treads, while in other embodiments, the tires may include crisscross tread patterns, parallel striped tread patterns, and/or other suitable tread patterns. In some embodiments, the tires may include 21″ SPS-85 durometer polyurethane tires mounted on 15″×8″ stainless steel hubs.

In some embodiments, the drive modules 138 also may include logic control boards, humidity sensors, air pressure sensors, purge valves, check valves and quick disconnects for power, control, air, and coolant lines. Drive modules 138 may also be used on other mobile platforms and products.

### Front Omni Wheel System 140

In some embodiments, as shown in FIG. 20, the movement system 100 may include a front omni wheel system 140 mounted to the chassis' front axle mount 129 (shown in FIG. 17). In this position, the wheel system 140 also may be supported by the left and right diagonal supports 131, and the left and right lift plates 133 (see FIG. 17) and may include sliding pads on these interfacing surfaces to provide lateral stability to the front wheel system 140.

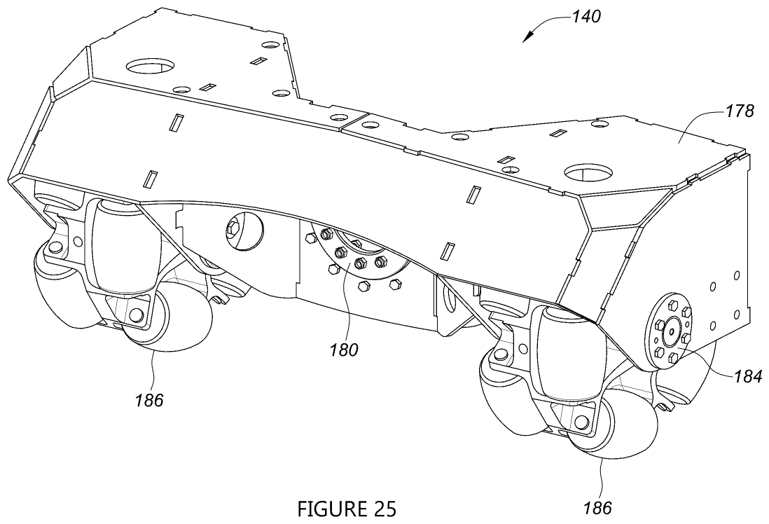

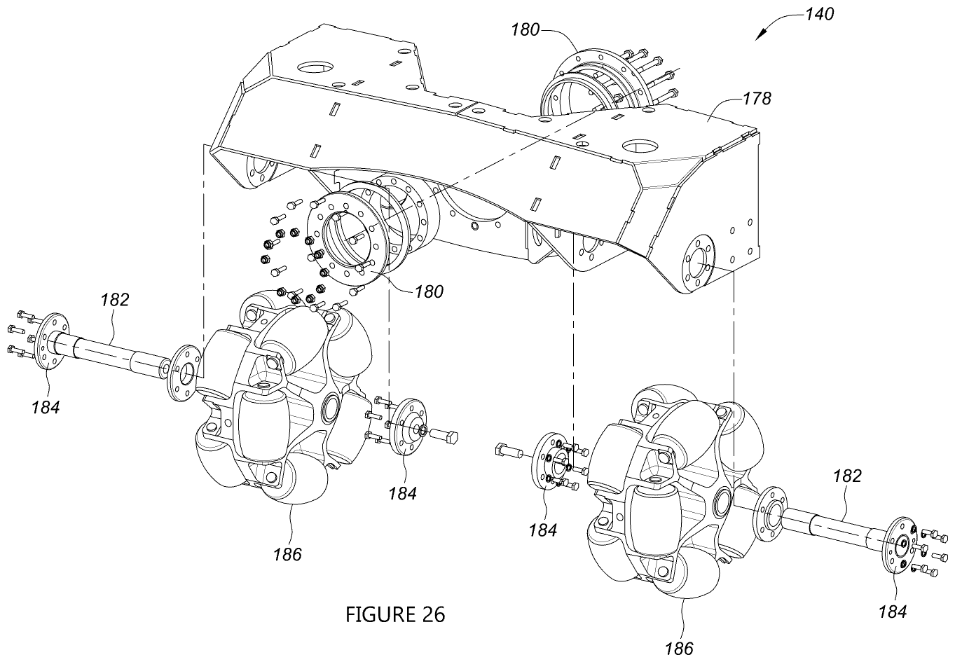

FIG. 25 shows the omni wheel system 140 assembled and FIG. 26 shows an exploded view of the same. In some embodiments, the omni wheel system 140 may include an external axle frame 178, two omni wheels 186 (e.g., left and right), independent quick-change wheel axles 182 for each left and right omni wheel 186, axle stabilizers 184 for each axle 182, and a central axis rotator bearing 180. The foregoing generally facilitates the smooth movement of system 10, which in turn enhances the performance by display 1.

In some embodiments, as shown in FIG. 26, each omni wheel 186 may be supported by an independent quick-change wheel axle 182 that provides precise and robust wheel mounting while enabling wheel replacement with minimal disassembly. The omni wheels 186 may be constructed from a large stainless-steel machined billet with stainless-steel roller pins and roller formed from MC nylon or other suitable materials. The omni wheels may include a stainless-steel support wheel of about 16″ to about 20″ in diameter with stainless-steel roller shafts. Each omni wheel may preferably include a load rating of 14000N or greater. The ease with which the wheels 186 may be mounted and replaced, if necessary, helps reduce or minimize any absence of system 10 from a performance by display 1.

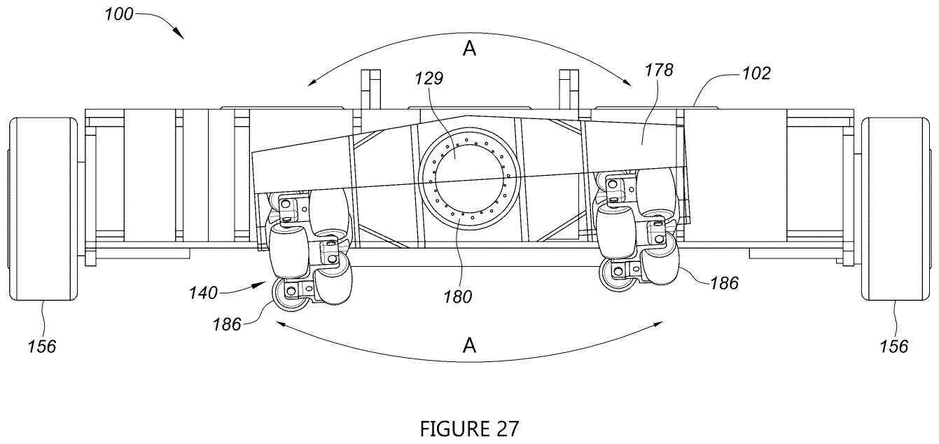

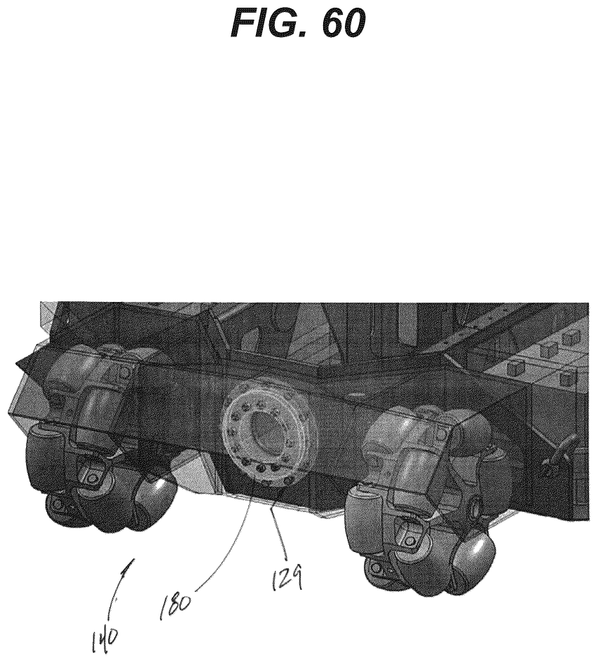

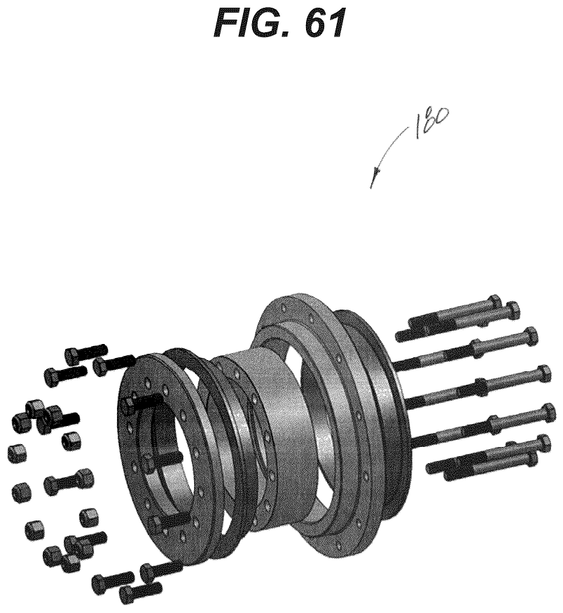

FIG. 60 shows a front perspective view (semi-transparent) of the movement system 100 with the front wheel system's central axis rotator bearing 180 coupled with the front axle mount 129 of the chassis 102. In this arrangement, the omni wheel system 140 may pivot about the chassis longitudinal axis L_{C1} (see FIG. 17) as depicted by the arrows A in FIG. 27.

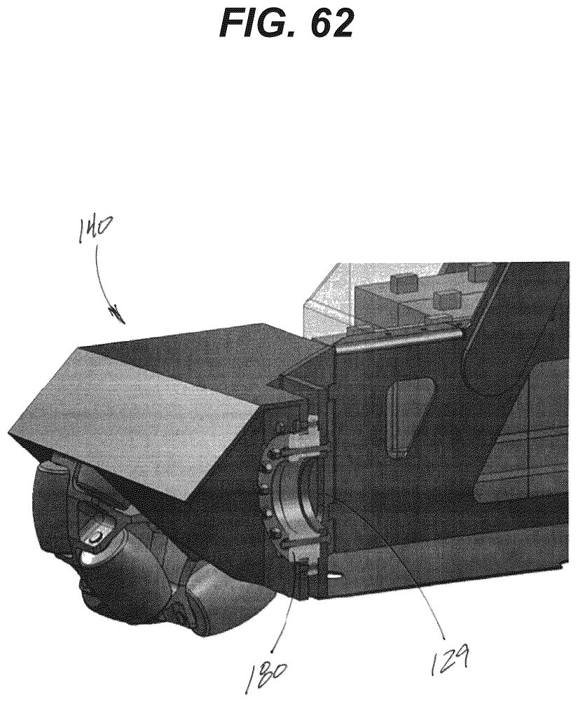

FIG. 61 shows an exploded view of the rotator bearing 180 including stainless-steel machined rings, plastic bearings (UC300), and threaded hardware. FIG. 62 shows a cut-away view of the rotator bearing 180 coupled with the chassis' front axle mount 129. As shown, in some embodiments, the front bulkhead of the axle mount 129 may be machined to act as the rear journal for the rotator bearing 180, thereby reducing space and part count.

As the movement system 100 travels over uneven surfaces (e.g., when entering and/or exiting a water basin via a ramp), the front wheel system 140 may pivot to accommodate the surface. This may ensure that all four wheels of the movement system 100 (e.g., the wheels 156 of the left and right drive modules 138, and the left and right omni wheels 186) remain on the basin floor at all times. This also may ensure that the load of the movement system 100 is distributed over all four wheels and that any torsional stresses that may be exerted on the chassis 102 due to any uneven surfaces may be reduced or minimized. As such, support for the chassis 102 is triangulated between the left and right drive module wheels 156 and the pivot point of the central axis rotator bearing 180 at the chassis' front axle mount 129. The foregoing also generally facilitates the smooth movement of system 10, which in turn enhances the performance by display 1.

The central bearing 180 may include a central through hole that corresponds to a central through hole on the chassis' front axle mount 129 thereby providing a port for control lines and other mechanisms to pass from the chassis 102 to the front wheel system 140. In some embodiments, the central bearing 180 may comprise plastic or other suitable materials. FIG. 27 shows an example of the front omni wheel system 140 deflected (pivoted) at about 3.54° which may correspond to the movement system's right side omni wheel 186 passing over a grade of roughly 10% while the rest of the system 10 (e.g., including the right drive module's right wheel 156, the left omni wheel 186, and the left drive module's left wheel 156) remains on a generally flat surface. In this example, the pivoting of the omni wheel system 140 enables both omni wheels 186 and both drive wheels 156 to remain in contact with the floor as the system 10 passes over the grade.

The reservoir 11 may include an entrance/exit ramp to allow systems 10 to enter the reservoir 11 and access the reservoir floor. This ramp or another ramp may provide access between the reservoir 11 and a dry dock servicing station as discussed later. It is preferred that the front omni wheel system 140 allows system 10 to travel up and down any ramp leading to or from reservoir 11.

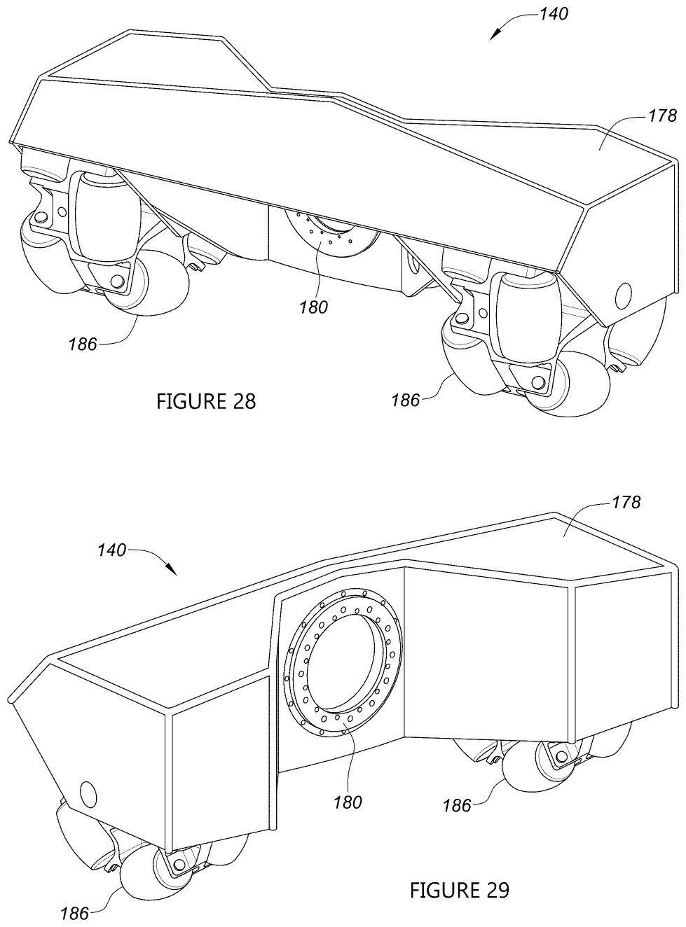

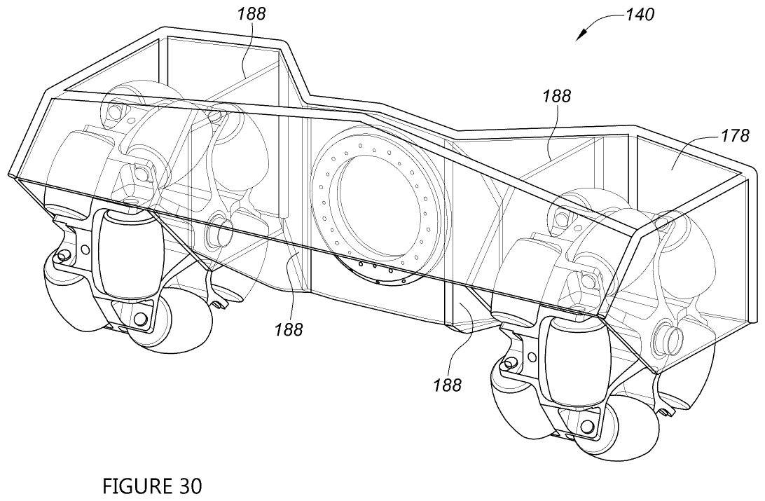

FIG. 28 shows a front perspective view of the front omni wheel system 140 including the external axle frame 178, FIG. 29 shows a rear perspective view of the system 140, and FIG. 30 shows a semi-transparent view of the same. In some embodiments, as shown in FIGS. 28-30, the external axle frame 178 provides rigidity to the wheel system 140 along the X-axis, Y-axis, and Z-axis to minimize wheel camber flexure. In addition, the frame 178 may be designed to minimize wheel axle deflection when the omni wheel(s) 186 may transfer the load of the system 10 between an inner roller and an outer roller. This may minimize any rocking or bumping that may be associated with the performance of the omni wheels 186 (especially if the omni wheels 186 may be loosely mounted). The foregoing helps system 10 move about reservoir 11 in a smooth fashion which enhances the choreography of the performance by display 1.

In some embodiments, the external axle frame 178 may include a weldment or other suitable structure including a box-like architecture with vertical and horizontal external walls coupled to one another perpendicularly at edges and corners for strength. In some embodiments, as shown in FIG. 30, the external axle frame 178 also may include one or more internal gussets 188 between the external walls to provide additional rigidity. Stress simulations of the external axle frame 178 (including finite element analyses and Von Mises stress analyses) were performed to determine an optimal frame material thickness (e.g., ½″, ⅜″, ¼″ steel plates) and optimal locations and architectures of the internal gussets.

### Air Pressure and Purge System 190 (Also Referred to as Module M10)

In some embodiments, the movement system 100 may include a modular air pressure and purge system 190 which may provide a constant and steady source of air pressure to the various portions of the system 10 as required. This air pressure may help minimize water ingress or otherwise leaking into the various modules carried by the movement system 100. This positive air pressure may also help displace any water that may have leaked into movement system 100. In addition, the system 190 may periodically purge moisture from the modules by replenishing the system 100 with clean dry air. The foregoing allows the movement system 100 to remain submerged underwater for protracted periods of time, e.g., during and between performances, because the air pressure and purge system 190 preferably avoids any contamination or damage to the systems carried by movement system 100 that might occur if water from the reservoir 11 leaked therein.

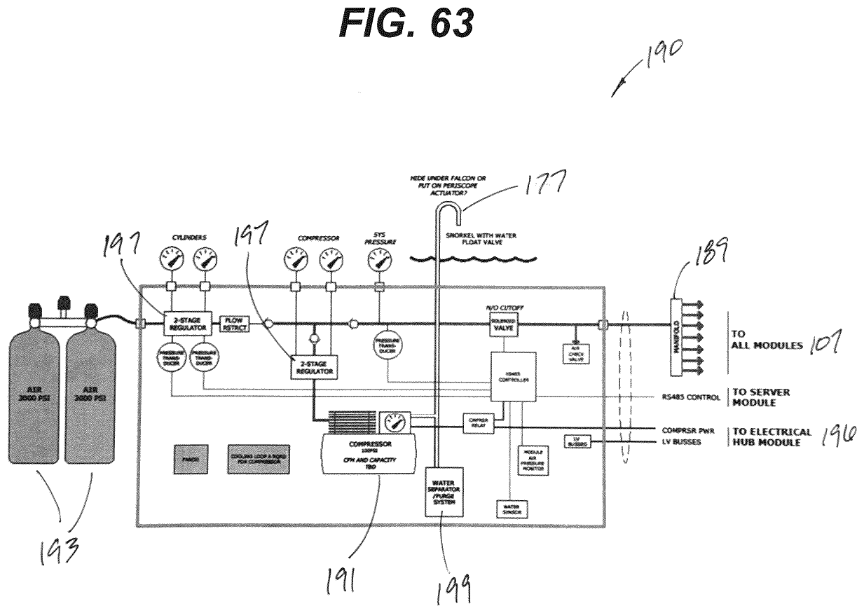

In some embodiments, as shown in FIG. 63, the air pressure and purge system 190 may include an on-board compressor 191, an accumulator tank, and/or one or more replaceable scuba tanks 193 (e.g., for use during extended periods of submersion). The onboard compressor 191 may be attached to a submersible snorkel system 177 with a water-trap and dryer prior to entering the compressor. Other types of air pressure and purge systems may be used in order to keep the electronics and other systems contained in the movement system 100 dry.

In some embodiments, the air pressure and purge system 190 also may include air regulators 197, valves, water separators, air dryers, and/or control circuitry. Three-way valves may be included to control the output to each module of the system 10 to provide a first pressure to maintain positive pressure in the modules, and/or a second pressure (e.g., a higher pressure than the first pressure) to actively purge moist air and/or ingressed water during a replenishing cycle. Valves in the air pressure and purge system 190 may be implemented in tandem with valves in the individual modules for this cycling. Airflow may be controlled independently at each valve and may be ported from each valve to a corresponding module as required. Air lines may extend from the system 190 to each functional module 107 via a manifold 189, control lines (e.g., RS485 lines) may extend to the server module, and power and bus lines may extend to the electrical hub module 196.

In addition, pick-up tubes may be included in each module to purge any standing water in the bottom of a module, and check valves may be used to ensure water doesn't enter the modules in case of a hose break. Pressure relief valves also may be used to ensure that the modules are not over-pressurized, and sensors may be implemented in the modules to monitor air pressure and humidity such that the system 190 may control the valving of each module accordingly.

### Rechargeable Power System 192 (Also Referred to as Module M4)

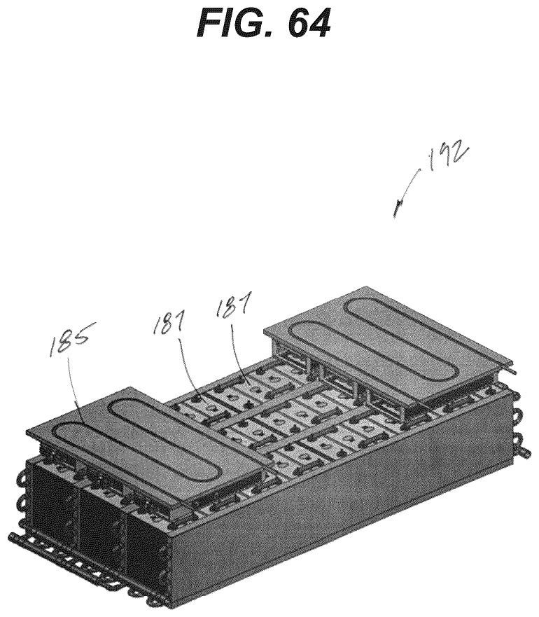

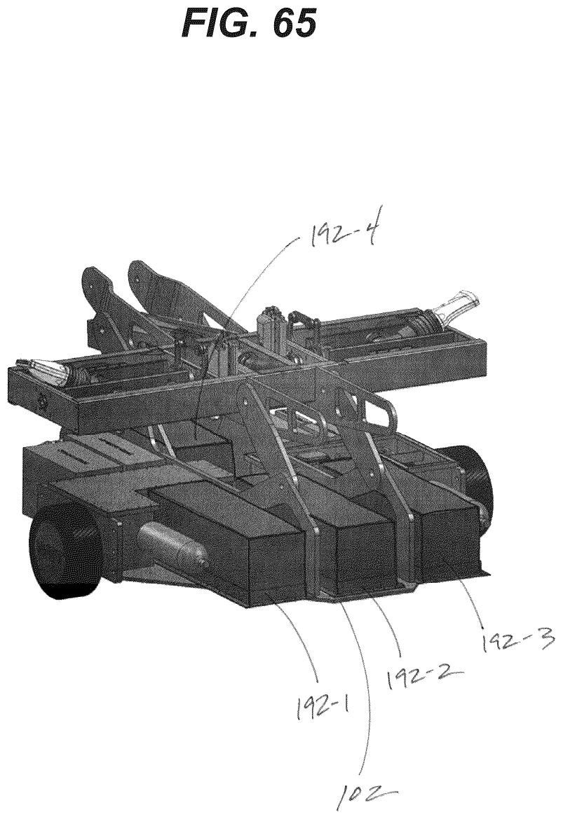

In some embodiments, as shown in FIG. 64, the movement system 100 may include a rechargeable power system 192 that may include one or more rechargeable battery packs 187. In one example, as shown in FIG. 65, the power system 192 may include a battery pack divided into four sub-packs 192-1, 192-2, 192-3, 192-4, with each sub-pack comprising an individual module. In this example, the four sub-packs 192-1, 192-2, 192-3, 192-4 may be mounted to the chassis 102 in quadrants to distribute the aggregate mass of the sub-packs evenly about the chassis' desired center of gravity. Also, by dividing the power system 192 into two or more sub-packs, water contamination into one pack may not affect the others such that power may still be available to the system 10. As such, power source redundancy may be provided.

In some embodiments, the battery sub-packs may include lithium titanate oxide (LTO), LiFePO4 or other suitable types of batteries that may be connected in series at the electrical hub module 196 to produce approximately 320 Vdc total voltage and/or about 2000 Ah. Other types of batteries also may be used to provide other voltages. Because batteries 192 may be enclosed within their respective modules 196, and where reservoir 11 water temperature is warm, it is preferred that the battery chemistry used generates less heat and provides increased reliability and longevity.

In some embodiments, each battery module may be attached (e.g., strapped) to a cold plate and/or include integrated liquid cooling 185 (e.g., an ethylene glycol cooling loop) that may keep the packs cool during high-speed charging and/or discharging while being enclosed and/or sealed in its module.

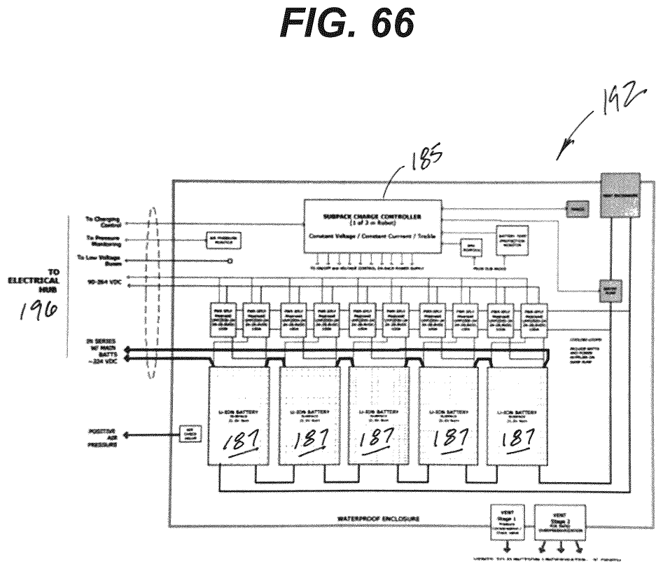

FIG. 66 shows a block diagram of an exemplary rechargeable power system module 192. As shown, a plurality of battery sub-packs 187 may be configured with a power system charge controller 185 with power lines, control lines, bus lines, pressure monitoring lines, and other lines extending from the module 192 to the electrical hub 196. The battery sub-packs also may include logic boards, BMS charge circuitry, high voltage disconnecting contactors, power interconnect system(s), coolant interconnects, and/or air pressure module components.

### Cooling System 194 (Also Referred to as Module M18)

In some embodiments, the movement system 100 may include a cooling system 194 to deliver cooling fluid (e.g., ethylene/glycol coolant, water, and/or other cooling fluid(s)) to one or more modules of the system 10, e.g., to the power system 192, to the left and right drive module's drive motors 160 and controllers, to various performance element motors that may require cooling (described in other sections), and to other elements of the system 10 as needed.

In some embodiments, the cooling system 194 may include one or more internal cooling loops, with each loop dedicated to a particular element of the system 10. For example, the cooling system 194 may provide a first cooling loop to the power system 192, a second cooling loop to the drive modules 138, a third cooling loop to peripheral systems, etc. Each cooling loop may include a dedicated pump. In some embodiments, the cooling system 194 may include a manifold with flow balancing valves and meters to sense and optimize the flow of the coolant within each cooling loop. This flow may be monitored and controlled by the onboard server to ensure proper operation and cooling of the system 10.

In some embodiments, the cooling system 194 may include a heat exchanger that uses water from outside the system 10 (e.g., water from the water basin) to cool one or more of the cooling loops. A submersible pump may be used to force the basin water through the heat exchanger while the system 10 is submerged. The cooling system 194 also may be fitted with an external water hose hookup for use when the system 10 is not submerged within the basin.

In some embodiments, the cooling loops may comprise coolant lines equipped with self-sealing quick-releasing connectors to connect the lines to the respective system modules to be cooled. In this way, when maintenance may be required, the coolant lines may be quickly disconnected from the modules thereby minimizing loss of coolant fluid from the cooling system 194 and preventing air from being introduced into the lines. This also may eliminate the need to evacuate the entire cooling system 194 when the modules are disconnected.

### Electrical Hub 196 (Also Referred to as Module M3)

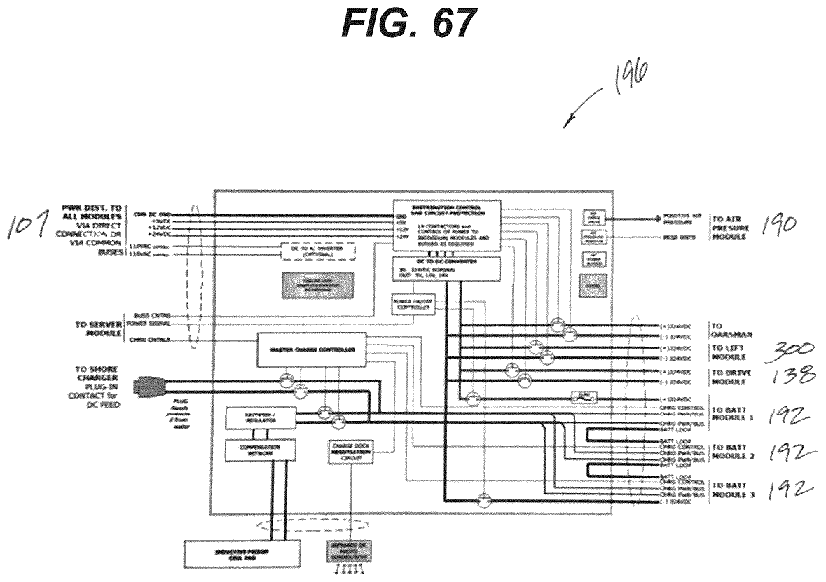

In some embodiments, as shown in FIG. 67, the movement system 100 includes an electrical hub/server 196 that may reside in a separate waterproof module, and that may be configured to accommodate high-voltage lines within the system 10, a motion-control computer, a backup logic battery, data control lines to other modules, and other components. In some embodiments, the electrical hub/server 196 also may include high-voltage contactors for managing high voltage loads within the system 10, for battery interconnects and power management, charging circuitry, etc.

In some embodiments, waterproof high-voltage bulkhead connectors may be used to electrically connect the hub/server module 196 to the modules 107 for power distribution thereto. For example, the hub/server module 196 may electrically connect to the drive modules 138, air pressure module 190, battery modules 192, etc., to systems such as the movement system 100, the performance platform 200, the lifting system 300, and the articulated arm system 400, and to other elements such as remote control panels, charge connectors, etc. In addition, the hub/server module 196 may include ports for positive air pressure, valving for air purging, humidity sensors, check valves, and other necessary components.

### Server 197 (Also Referred to as Module M2)

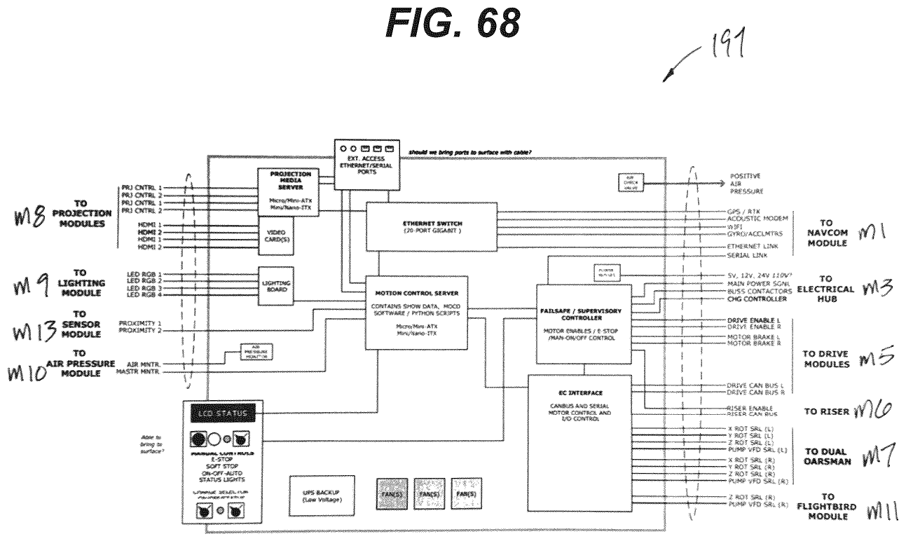

In some embodiments, as shown in FIGS. 54 and 68, the movement system 100 may include a server module 197. The server module 197 may preferably be self-contained and may include on-board computer and supervisory circuits. In general, the server module 197 may provide the main control and decision-making functionalities of the system 10, and may function as the brain of system 10. As shown, the server module 197 may be integrated to generally control the NavComm module M1, electrical hub module M3, drivetrain module M5, riser (lifting) module M6, Oarsman/pump module M7, projector/mirror module M8, lighting module M9, air pressure module M10, rainbird (arm) module M11, sensor module M13, and/or other modules. While not explicitly shown, the server 197 also may interface with and/or control the battery module M4, rescue module M12, base station control module M15, charger probe module M16, external charger dock module M17, cooling module M18, and/or other modules.

The server module 197 also may include a local interface for basic operation and/or emergency operations (e.g., to stop one or more functionalities of the system 10 when necessary).

### Charging System 198 (Also Referred to as Modules M16 and M17)

In some embodiments, the system 10 may include a charging system 198 configured with, or generally connected to its rechargeable power system 192. It is preferred that charging occur between performances by display 1. However, charging may also occur during a performance in a manner that does not disrupt the performance's choreography. For example, a particular system 10 may be charged at a time when it is stationary per the performance's choreography.

In one embodiment, the charging system 198 may include an electrical cable that extends from system 10 and that may be plugged into an external charging receptacle to receive a charge. The cable may be plugged into the charging receptacle while the system 10 is submerged within a reservoir 11, with the cable coming up out of the water, or while the system 10 is on dry land, e.g., in a servicing station as described later. The electrical cable is preferably located and extends from at or near the top of system 10 or other easily accessible location to facilitate connecting the cable to the external charging station. The cable may be capped with a waterproof cover and/or purged storage receptacle. Alternatively, system 10 may include a charging receptacle that may receive a charging cable from the external charging system. In this case, the receptacle on system 10 may be capped and/or purged as mentioned above.

In another embodiment, charging may occur automatically underwater using a mechanical system, whereby a charging mechanism is installed in the water below grade, e.g., in the floor of reservoir 11. In this embodiment, the system 10 may position itself on or adjacent the underwater charging station, and pneumatically actuated electrodes may automatically extend from the reservoir floor into system 10. More specifically, the electrodes may extend into receiver tubes configured in the bottom of movement system 100.

Before the electrodes extend upward, the recharging system may ensure that system 10 is properly positioned. To that end, control signals may be transmitted to movement system 100 so that the omni wheels 186 and the drive wheels 156 are instructed to position system 10 to a location suitable for charging. Once property positioning of system 10 is confirmed, the electrodes may extend up into the receiving tubes. To the extent that any of the systems 10 must be recharged during a performance, the charging stations may be underwater and not visible to the observers. This may enhance the performance of display 1.

The onboard charging system 198 may include one or more receiver tubes each configured to receive a corresponding charging electrode from the charging station (e.g., one receiver tube for each leg of the high-voltage circuit of the system 10). Each receiver tube may include upper ends plated with one or more charge-receiving electrodes. The receiver tubes may preferably be air purged and equipped with air purge sensors. When the sensors indicate a positive purge and when proper electrical continuity between the charging electrodes (of the charging station) and the charge-receiving electrodes (of the onboard charging system 198) is established (sensed), one or more contacts of the charging station may provide a charging cycle. In addition, in some embodiments, the charging station and/or the system 10 may include one or more automatic lateral adjustment mechanism(s) to ensure the proper orientation of the receiver tubes with the charging electrodes, and of the overall system 10 and charging station.

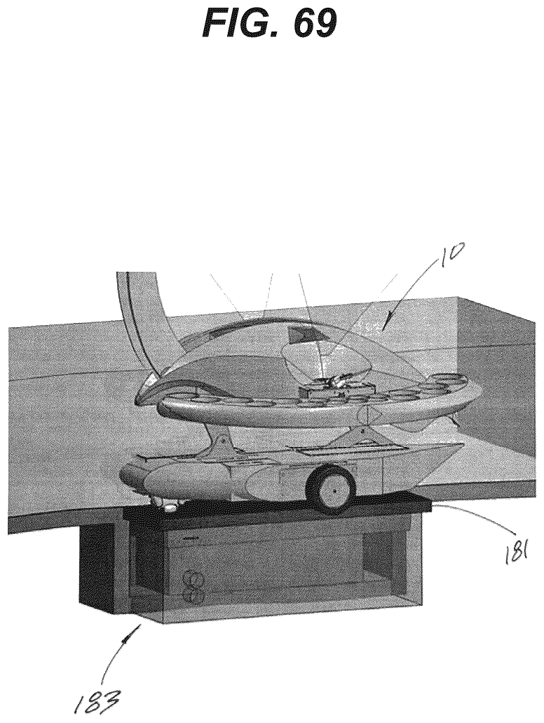

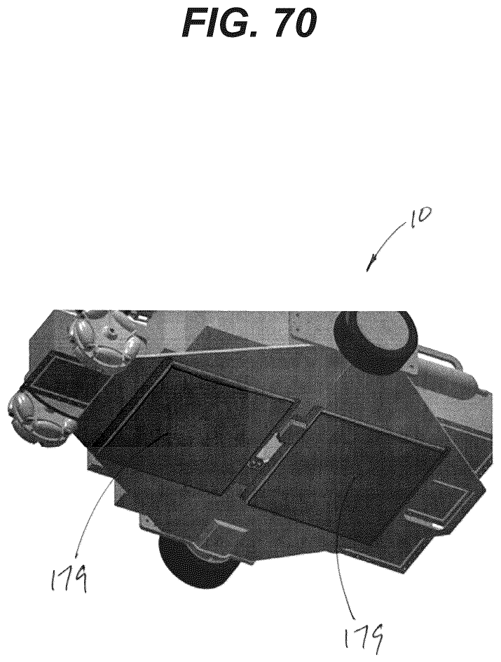

Another charging system embodiment involves induction charging as shown in FIGS. 69-70. In this embodiment, an underwater charging station 183 may be configured in the floor of reservoir 11, and may include one or more induction charging pads 181 housed in waterproof enclosures as shown in FIG. 69. And as shown in FIG. 70, the onboard charging system 198 of system 10 may include one or more corresponding induction pickup pads 179 positioned at a lower or bottom surface of the chassis 102 of system 10. In this way, the system 10 may park itself so that its induction pickup pads 179 are aligned with the corresponding induction charging pads 181 (e.g., the system 10 may simply park on top of the charging station), and charging may automatically commence.

The performance choreography may include predetermined navigation signals that command a particular system 10 to park over the induction charging station 183. Alternatively, if system 10 signals to the display 1 that its batteries are running low, a controller of display 1 may then command that the system move to a induction charging station 183 and park thereover.

In some embodiments, the induction charging may provide up to and exceeding 100 KW of power at a voltage of 400 v-600 v.

With this embodiment, system 10 may still perform while receiving a charge parked over charging induction pads 181. For example, if the choreography of the performance by display 1 calls for a particular system 10 to remain stationary while it is parked above induction pads 181, that system 10 may still raise its performance platform 200 and its articulated arm system 400 to emit water streams and provide lighting, fog or other visual effects. As such, this system 10 may receive a charge without disrupting the performance. Furthermore, because the charging occurs underwater, observers of the performance are unaware that a charging function is occurring while this system 10 is performing.

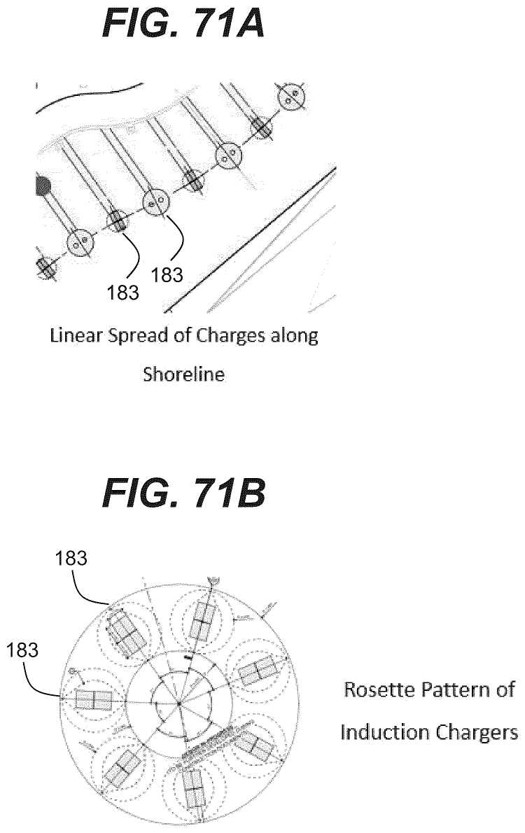

The locations of underwater induction charging systems 183 may be arranged in different layouts. For example, as shown in FIG. 71A, induction charging systems 183 may be arranged in a linear fashion that may extend along the periphery of reservoir 11 near its outer walls. As shown in FIG. 71B, a plurality of underwater charging stations 183 may be arranged in one or more circular Rosette patterns within the reservoir 11.

### Rescue System 197 (Also Referred to as Module M12)

In some embodiments, the movement system 100 may be equipped with a rescue system 197 that may include a mechanical towing apparatus configured with and/or extending from the system 100, e.g., at the front or rear of the system chassis 102, so that performance system 10 may be retrieved if it becomes inoperable. The towing apparatus may include a spring-loaded or actuated towing engagement mechanism that may controllably engage with a mechanical towing apparatus of a different and separate system 10. In this way, when one system 10 may become inoperable, another system 10 may lock onto to it and tow it to safety.

The two systems' towing apparatuses may be engaged by being physically pressed together, either by manually navigating the rescue system 10 to engage the inoperable system 10, or by computer-controlled navigation of the rescue system 10. In some embodiments, the towing apparatus may be permanently attached to each system 10, and/or may be modular for quick attachment and/or detachment when required.

Given the above, it may be preferable that each system's movement system 100 have adequate power to tow an inoperable system 10 as needed.

In some embodiments, the rescue system 197 may implement a low-voltage electrical connection between the two system's towing apparatus such that the rescuing vehicle 10 may provide power to the inoperable system 10, e.g., to release the inoperable system's motor-brakes to allow it to be towed.

In some embodiments, the rescue system 197 may include a rescue caster apparatus that may be configured with the system's chassis 102 to lift its wheels (e.g., to lift the drive wheels 156 and/or the omni wheels 186) off the basin floor surface thereby enabling the system 10 to roll. The rescue caster apparatus may be installed manually when the system 10 becomes inoperable and/or may be pre-installed with the system 10 to be employed as needed. In some circumstances, the caster apparatus may be configured to lift only the front omni wheel system 140 (e.g., if it becomes damaged) such that the damaged system 10 may utilize its own drive modules 138 for propulsion

In other embodiments, an underwater vehicle dedicated to towing may be used to annually or automatically retrieve an inoperable system 10. For example, a non-performance version of system 10 may be used for this purpose. As such, an inoperative system 10 may be retrieved by a vehicle out of view of the observers of display 1.

### NavCom System 195 (Also Referred to as Module M1)

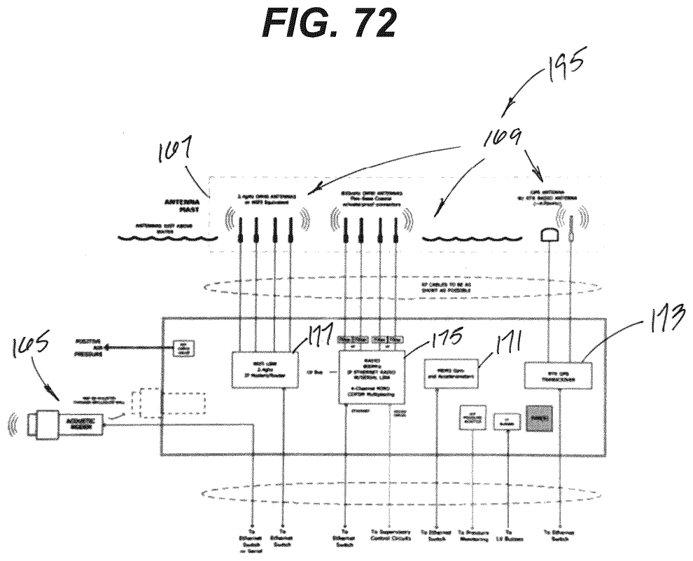

In some embodiments, the movement system 100 includes a NavCom system 195 configured to establish and manage communications between the system 10 and a base station or controller. In some embodiments, as shown in FIG. 72, the NavCom system 195 may include one or more radio communication peripherals and corresponding antenna systems 169. In some embodiments, the NavCom system 195 provides two redundant ethernet communication radios, e.g., a longer-wave IP-over-ethernet radio 175 and a shorter-wave Wi-Fi radio 177, with the longer-wave radio able to embed serial communication links into an RF connection for system supervisory and emergency control functions. The NavCom system 195 also may include a Global Positioning System (GPS) receiver 173 and inertial accelerometers and/or gyroscopes 171 (e.g., MEMS).

In some embodiments, the NavCom system's antennas 169 may comprise waterproof antenna array(s) corresponding to each of the system's communication radios. The antenna arrays may be held by associated antenna masts 167, either above the water surface or below. The masts 167 may be controllably articulated such that the antenna arrays 169 may be raised and/or lowered by the masts 167 as desired. In some embodiments, the system 195 may include a failsafe condition that automatically raises the antenna arrays 169 to above the water surface under predetermined circumstances.

In some embodiments, the NavCom system 195 may include one or more low baud-rate communication systems 165 that may communicate with the base station while its corresponding antenna array is fully submerged (e.g., using an acoustic transducer or RF wave penetration through the water). This may allow a fully submerged system 10 (e.g., a system 10 that is relatively dormant in a sleep state) to be awakened and controlled by a low-level system supervisory control signal.

The NavCom system 195 may be connected to the system's electrical hub/server 196, e.g., via flexible umbilical cabling, so that the system 195 (as a module) may be mounted at an upper location on the system 10, e.g., closer to the water surface, thereby reducing RF cable lengths and increasing the RF signal strength. In addition, the NavCom system 195 may comprise a waterproof module equipped with ports for air pressure, purge valves, and humidity and pressure sensors, and may be plumbed to include an active cooling loop from the cooling system 194.

### System Sensors (Also Referred to as Module M13)

In some embodiments, the movement system 100 includes a variety of system sensors to aid in its navigation and safety. These sensors may include underwater infrared (IR) cameras mounted about the perimeter of the chassis 102 for viewing the reservoir environment surrounding the system 10. Positioning cameras may also be configured to track the movement and orientation of the system 10 relative to the basin floor. Other types of sensors include shock sensors to sense shock and vibrations, proximity detection sensors, and/or other types of sensors. The sensors may preferably be housed in waterproof enclosures and electrically connected to the electronics hub/server 196.

In addition, some, or all of the modules within the system 10 may preferably contain a variety of internal and/or system sensors including, e.g., temperature monitoring, air pressure monitoring, humidity monitoring, water ingress detection, coolant flow sensing, fluid level sensing, electrical sensors (voltage, amperage), position encoders, and/or other sensors. The sensors may provide data to an onboard server to be used in automated navigation and control algorithms, to modulate the automated running of various onboard systems, and for other uses. In some embodiments, when sensor data shows an out-of-tolerance condition, the system 10 may be triggered to send an alert (including the sensor data) to the base station through radio telemetry.

### Motion Control System Architecture

The Motion Control System or Navigation System Architecture may comprise a sensor fusion algorithm running on a multi-core ARM processor, and four types of sensors. An RTK GPS may provide measurements of position and velocity, but may be unavailable when the GPS antenna is submerged. An IMU including a three-axis gyroscope and/or three-axis accelerometer may measure motion, even when system 10 is submerged. Correction from other sensors may reduce or avoid drift of measured position and/or heading over time. Wheel encoders may measure distance traveled by the wheels, providing constraints on the IMU's position and heading drift. A magnetometer may measure the local magnetic field, and may be used to estimate the system's 10 heading, as another constraint on the IMU's heading drift.

### Control and Telemetry Architecture

System 10 may also include Control and Telemetry Architecture to facilitate navigation and motion of system 10.

### E-Stop Architecture

System 10 may include various safety systems including E-Stops. The E-Stops may include buttons or sensors that, when activated, preferably avoid collusions. E-Stops may also be located in a control room, service bay or observer positions.

### Underwater Path Following Technology

The current invention also includes a tool for analyzing, comparing and improving algorithms for path following, to determine a preferred technique to use for choreographed movement of systems 10 and arm systems 400. This tool helps optimize motion algorithms.

### Coordinated Movement Technology

The performances provided by display 1 may be designed by choreographing the movements of systems 10, as well as their water, lighting and other effects, through the use of software design tools.

### Performance Platform 200

In general, as shown in FIGS. 1-3, the performance platform 200 may be configured generally on top of the movement system 100 via the lifting system 300. The performance platform 200 may comprise a platform or base designed to hold, support, and implement one or more performance elements of the system 10 during a water display performance. The performance elements may include water expression components such as nozzles to emit streams of water, lighting components, fog components, sculptural components, and/or other performance elements such as fire, gas, air, live performance elements, etc. The performance platform 200 may also house speakers to provide music or other audio elements to the performance of display 1.

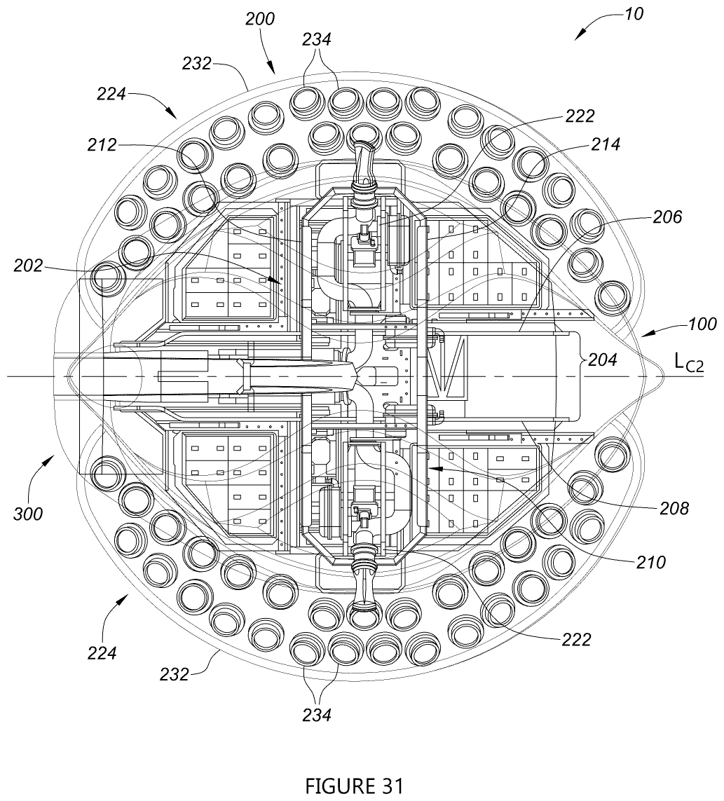

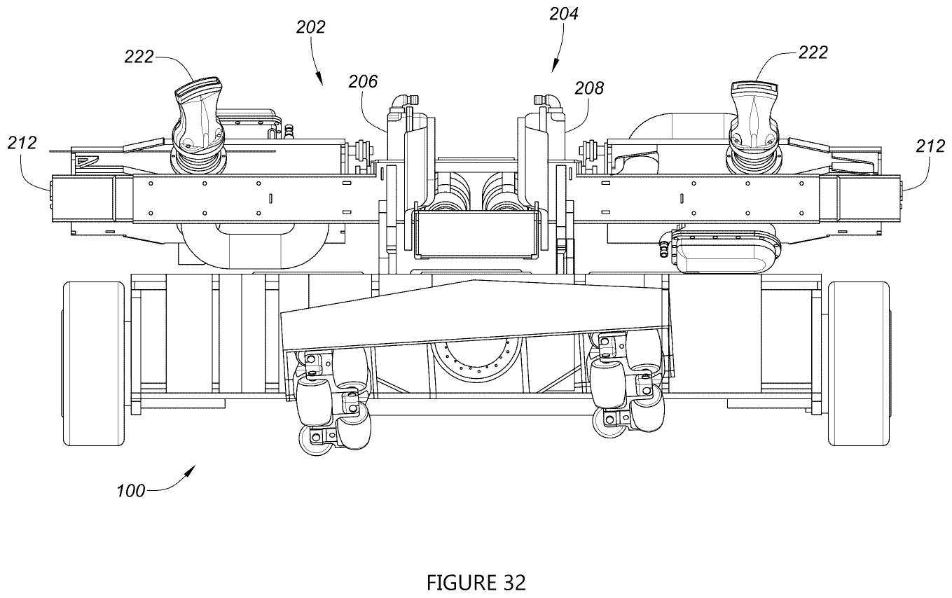

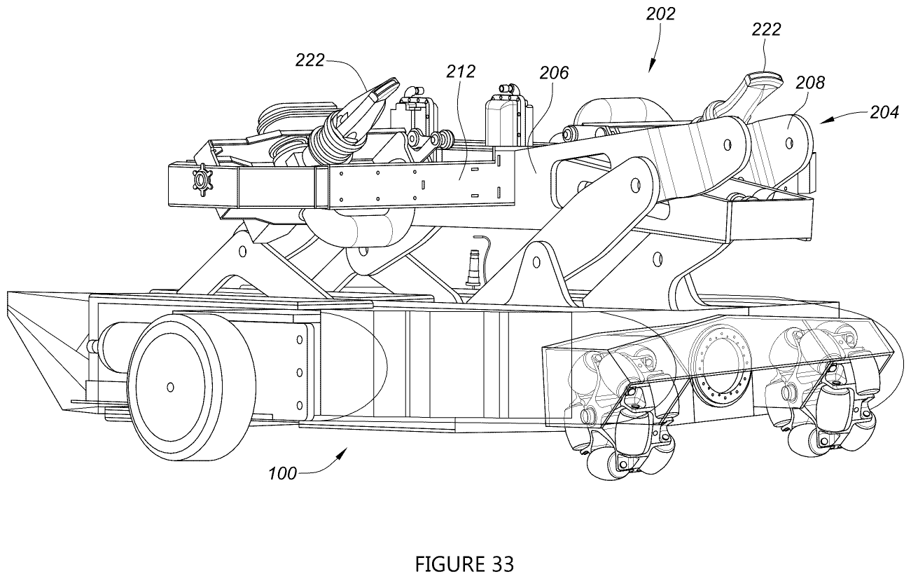

FIG. 31 shows a top view of the performance platform 200, FIG. 32 shows a front view of the platform 200, and FIG. 33 shows a side perspective view of the same.

In some embodiments, each performance element may preferably comprise a functional module that is independent, replaceable, and waterproof. As shown in FIGS. 31-33, the performance platform 200 may include a performance platform chassis 202 to receive and support the various functional modules. The chassis 202 may provide power, air pressure, control signals, hydraulic power (e.g., via an umbilical), and other functionalities to the modules.

The performance platform chassis 202 may include a central support structure 204 generally defining a performance platform longitudinal axis L_{C2} (see FIG. 31) and comprising a left central beam 206 and a right central beam 208. The left and right central beams 206, 208 may preferably be parallel with one another and separated by a gap thereby forming a slot along the longitudinal axis L_{C2}. As described in more detail later, when arm system 400 is in a retracted or nested position, it preferably resides within this slot so that the top surface of platform 200 and the top surface of arm system 400 appear contiguous. This may enhance the performance of display 1 because, for example, observers may believe the platform 200 and nested arm 400 are a single component, and would thus be surprised to see the arm 400 rising out of and above the platform 200.

When the performance platform 200 is configured with the movement system 100 via the lifting system 300, the performance platform's longitudinal axis L_{C2} is preferably parallel with and generally located directly above the movement system's longitudinal axis L_{C1}. In this way, the systems 100, 200, 300 all may be aligned in a generally stacked arrangement front to back.

The performance platform chassis 202 also may include a central spar 210 comprising a forward spar support 212 and a rear spar support 214 separated by a gap. The central spar 210 may generally bisect the central support structure 204 perpendicular to the longitudinal axis L_{C2} and may extend outward equal distances from the central spar 210 on the left and right sides.

In some embodiments, the performance platform 200 may include one or more of the following performance elements: one or more nozzles or other water delivery devices 222, a lighting grid 224, a fog system 226, one or more rotating mirror effects 228, a sculptural shell assembly 230, and other elements. The performance platform 200 also may provide a base and associated structural support elements for the articulated performance arm system 400. The performance platform 200 also may integrate components of one or more sub-systems of the movement system 200, e.g., antennas for the NavCom system 195.

### Water Delivery Devices 222 (Also Referred to as Module M7)

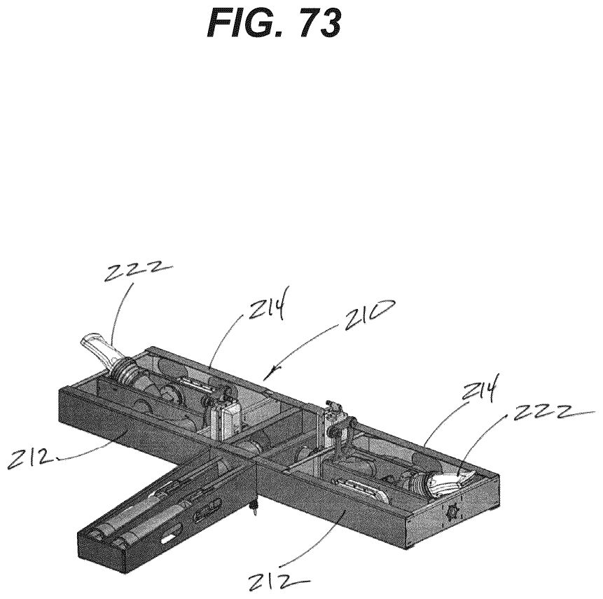

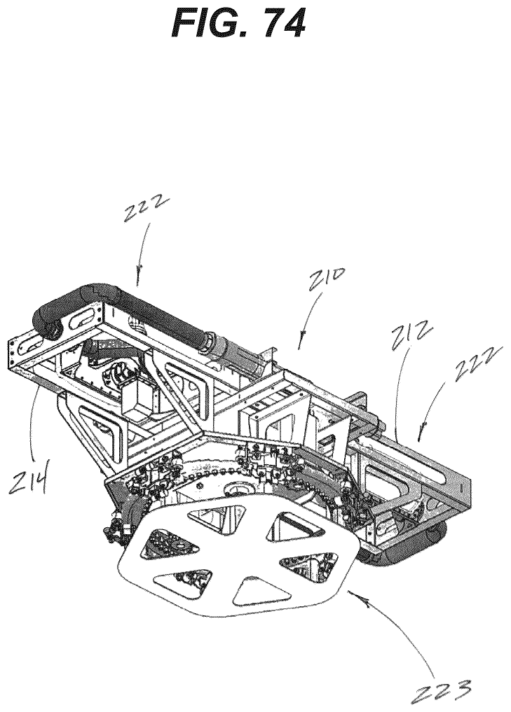

In some embodiments, the performance platform 200 includes one or more water delivery devices 222. For example, as shown in FIGS. 31-33, the platform 200 may include a left water delivery device 222 configured on a left side of the platform's chassis 202, e.g., with the forward and rear spar supports 212, 214 on the left side, and a right water delivery device 222 configured on a right side of the chassis 202, e.g., with the forward and rear spar supports 212, 214 on the right side. An isolated view of the left and right water delivery devices 222 within the left and right portions of the forward and rear spar supports 212, 214 is shown in FIG. 73. The left and right water delivery devices 222 may each be capable of emitting a wide variety of different types of water streams, fans, sprays, and effects.

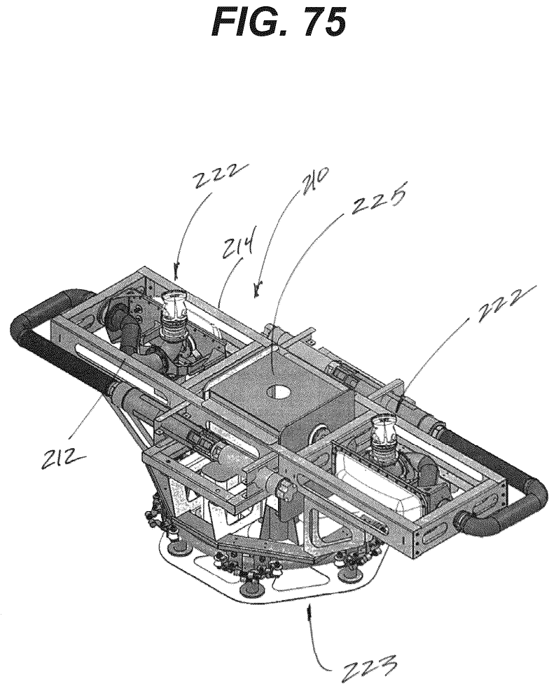

In some embodiments, each water delivery device 222 may include a 4-axis assembly, providing independent X-and Y-axis motion, independent nozzle spin, and dedicated pumps for each device 222. As shown in FIG. 74, a spinner base 223 may be implemented with the forward and rear spar supports 212, 214 to provide rotational movement about the vertical. In addition, as shown in FIG. 75, the devices 222 may share a common X-axis enclosure 225 for housing electronics for the device 222 motion and spinner base control. The devices 222 also may each include a controllable motorized mount capable of positioning the devices 222 in three-dimensions. In this way, the devices 222 may be controlled to emit the wing flapping pattern of water streams and fans as described in other sections, in addition to other types and forms of water effects.

### Lighting Grid 224 (Also Referred to as Module M9)

In some embodiments, as shown in FIG. 31, the lighting grid 224 includes a left wing module 232 generally defining the left side of the platform 200, and the right lighting grid 224 includes a right wing module 232 generally defining the right side of the platform 200. The left and right wing modules 232 may each house a plurality of illumination elements 234 and may each be generally semi-circular thereby providing the performance platform 200 with a generally circular or oval shape when viewed from above. In this way, illumination elements 234 within the left and right lighting grids 224 may generally surround and illuminate other performance elements provided by the platform 200. For example, the left and right lighting grids 224 may illuminate water streams and/or large water fan expressions provided by the water delivery devices 222. Other shaped wing modules 232 also are within the scope of the current invention. The illumination elements 234 may include light emitting diodes and/or other types of light sources of any color.

The left and right wing modules 232 may each be mounted to corresponding sections of the performance platform chassis 202. For example, the left wing module 232 may be mounted to the left central beam 206 and/or to the forward and rear spar supports 212, 214 on the left side, and the right wing module 232 may be mounted to the right central beam 208 and/or to the forward and rear spar supports 212, 214 on the right side.

The left and right wing modules 232 may each comprise modular stainless-steel support frames comprising waterproof enclosures that hold the various illumination elements 234. The illumination elements 234 may include fixed mounts and/or may include mounts that are adjustable in the X and Y tilt. The modules 232 also may house an underwater electrical harness system that may provide the associated electrical wiring, power supplies, and control to the various illumination elements 234. Integral waterproof junction boxes may be used to provide interconnection points for the individual illumination elements 234 as well as external cable harnessing from other modules on the platform 200. The wing modules 232 also may be plumbed to accept positive air pressure.

In some embodiments, the wing modules 232 may include one or more sub-sections that may be coupled to one another (e.g., bolted together) to form each overall module 232. In this way, the wing modules 232 may be easily disassembled, removed, and replaced (e.g., for maintenance and/or to interchange one wing module 232 with another that may include different types of performance elements).

As shown in FIG. 31, each wing module 232 may include two rows of 14-15 illumination elements 234 facing generally upward and distributed across the length of the modules 232. Other numbers and rows of illumination elements 234 at different orientations also are contemplated.

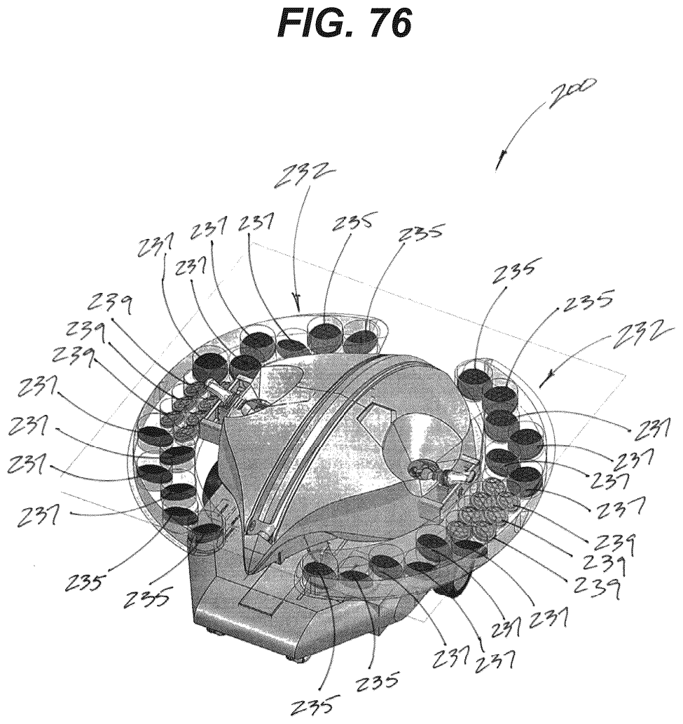

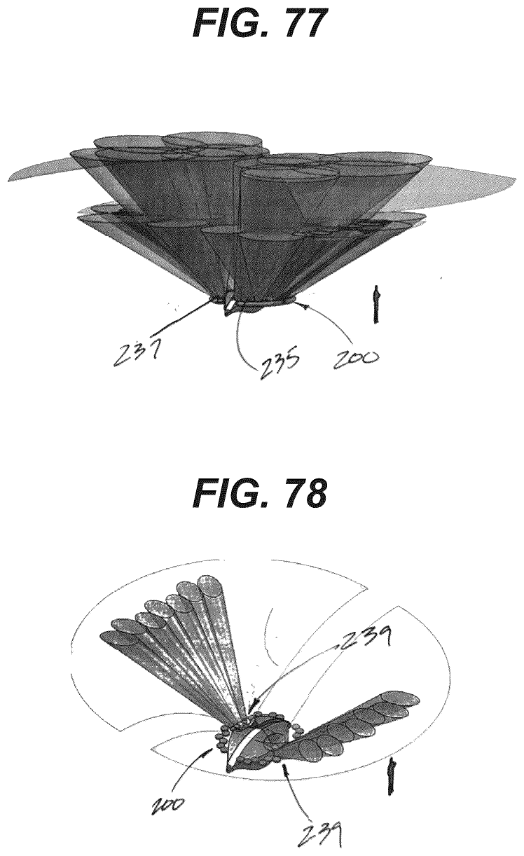

In some embodiments, as shown in FIG. 76, the illumination elements 234 may include one or more upper expression lights 235, one or more lower expression lights 237, and one or more articulated lower expression lights 239. In one example as shown, the left and right wing modules 232 may each include two forward and two rear upper expression lights 235, four forward and four rear lower expression lights 237, and seven middle articulated lower expression lights 239. As shown in FIG. 77, the upper and lower expression lights 235, 237 may emit cones of light to cover the full range of movement for both the upper and lower water expressions of the performance platform 200 (with the cones of light from the upper expression lights 235 extending farther upward than the cones of light from the lower expression lights 237), and as shown in FIG. 78, the articulated lights 239 may provide controllable narrow cones (e.g., “stripes”) of light to any of the system's water expressions as desired.

### Fog System 226

In some embodiments, the fog system 226 may include a waterproof enclosure containing a high-pressure water pump and valving, a container of clean water, a high-pressure distribution manifold, and a multitude of fog nozzles (e.g., up to and exceeding several hundred nozzles). The container of water may include a quick-fill hose ported to the maintenance area(s) of the movement system 100, and the distribution manifold may port high-pressure water to various locations on the system 10 for conversion to fog (e.g., using a water atomizer). In other embodiments, the fog system 226 may filter or otherwise treat water from the reservoir 11 for use in creating the fog. The enclosure also may include a control board, plumbing for positive air pressure, air check valving, and humidity and water sensors. The water pump may be cooled using an ethylene-glycol cooling plate fed from an external cooling loop.

Each fog nozzle may be attached to a respective tube circuit and may be embedded at various locations on the performance platform 200 to emit atomized water clouds (fog). For example, the fog nozzles may be embedded within and/or on a surface of the movement system's shell 139 and/or along the length of the articulated performance arm system 400 such that fog released by the fog system 226 may trail behind the system 10 and/or the arm 400 as it moves through the water.

### Rotating Mirror Effects 228

In some embodiments, the rotating mirror effects 228 may include an array of lights (preferably high intensity) focused onto one or more motorized rotating reflective elements. The speed, direction, and tilt of the reflective elements may be controlled, and the lights may be modulated. In this way, the effects 228 may provide sweeping kinetic light patterns onto water expressions (e.g., onto water streams emitted by the water delivery devices 222 and/or fog from the fog system 226) and/or onto physical surfaces (e.g., onto nearby buildings, etc.).

In some embodiments, a pair of rotating mirror effects 228 may be positioned on both the left and right sides of the performance platform 200. The effects 228 may be mounted on or within the platform's shell assembly 230 (see below). If mounted within the shell 230, the shell 230 may preferably include corresponding sculptural openings through which the kinetic patterns of light may pass. Other numbers and positions of rotating mirror effects 228 also are contemplated. Each effect 228 may include plumbing for positive air pressure, power and control inputs, purge air, and check valving.

### Platform Shell Assembly 230

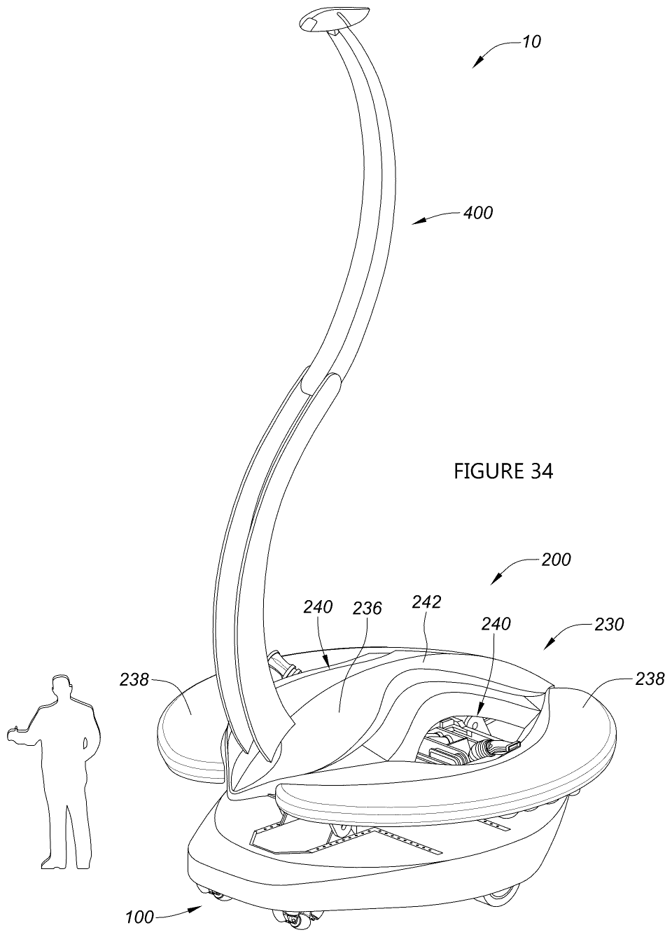

In some embodiments, as shown in FIG. 34, the performance platform 200 may include a shell assembly 230 that may generally cover the platform 200 while providing a hydrodynamic function, as well as an aesthetically pleasing sculptural element to the system 10. The appearance of the shell assembly 230 may be designed to correspond to a particular water fountain theme, e.g., to resemble a falcon or other type of animal.

The shell assembly 230 may include a central shell 236 that may generally cover the middle of the platform 200 along its longitudinal axis L_{C2}, and left and right wing shells 238 that may cover the left and right wing modules 232, respectively, of the lighting grid 224.

In some embodiments, the shell assembly 230 may be designed to be easily removable for access to elements of the platform 200 beneath. The shell assembly 230 also may comprise one or more panel sections that also may be easily removed. Each shell 236, 238 may include openings, windows, or allowances to enable performance elements beneath, such as water and/or lighting effects, to pass through the shells 236, 238 as necessary. In addition, the shell assembly 230 may include a gap 240 between the central shell 236 and the left and right wing shells 238 on either side to provide a window for the left and right water delivery devices 222 to extend through and/or emit water effects.

In some embodiments, the central shell 236 also may provide an upper nesting surface 242 that may receive the articulated performance arm system 400 when the arm is in its retracted position. Accordingly, it may be preferable that the upper nesting surface 242 include contours that generally match or correspond to the contours of the retracted arm system 400.

In some embodiments, the shells 236, 238 may comprise composite fiberglass materials with colorful gelcoat finishes and/or other types of protective coatings. Other types of fiber-reinforced composites and/or suitable materials such as metal also are contemplated. In other embodiments, the shells 236, 238 may be omitted

### Lifting System 300 (Also Referred to as Module M6)

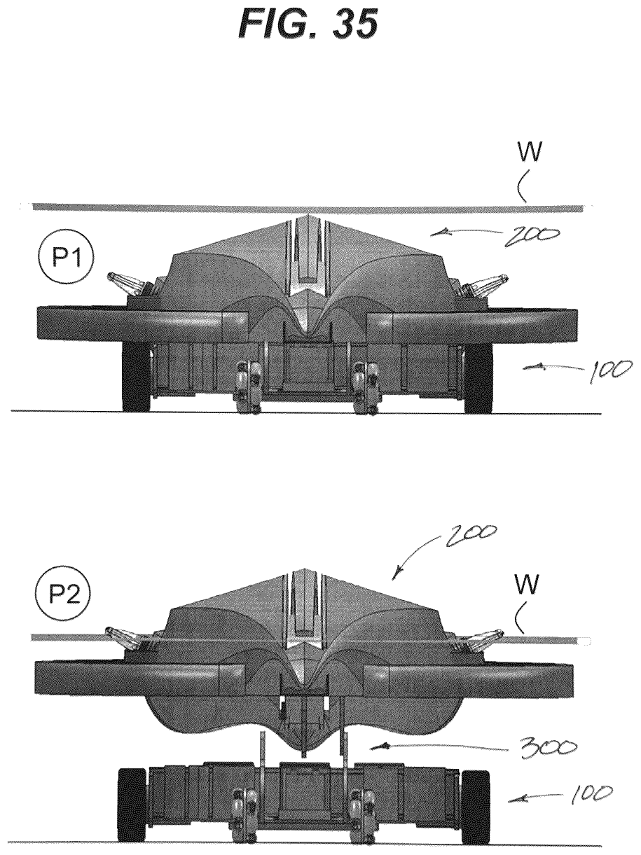

As shown in FIG. 35, the lifting system 300 may be controlled to lift the performance platform 200 (and the articulated arm system 400 attached thereto) from a generally submerged position P1 with respect to the movement system chassis 102 and/or the reservoir water level W (e.g., about 6″ below W) to a generally surfaced or above-water position P2, e.g., about 22″ above W. The lifting system 300 also may be controlled to lower the performance platform 200 from position P2 to position P1 as desired, and/or to place the performance platform 200 at any intermediate position between the first and second positions P1, P2. In some embodiments, the lifting system 10 may be capable of lifting and/or lowering a payload of 5000 pounds or greater.

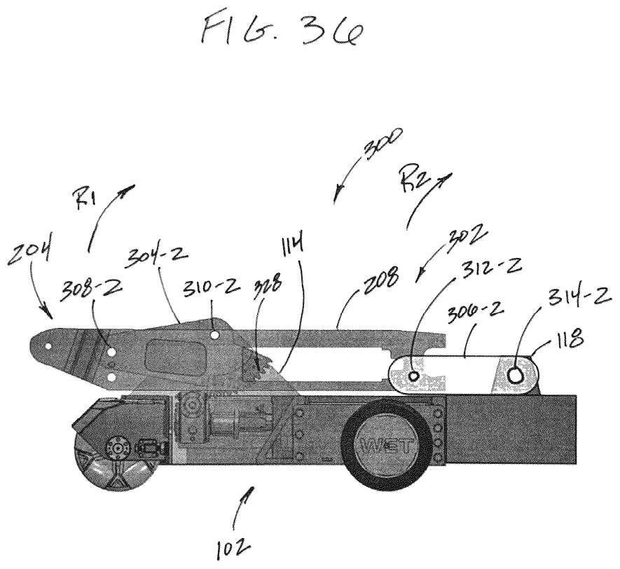

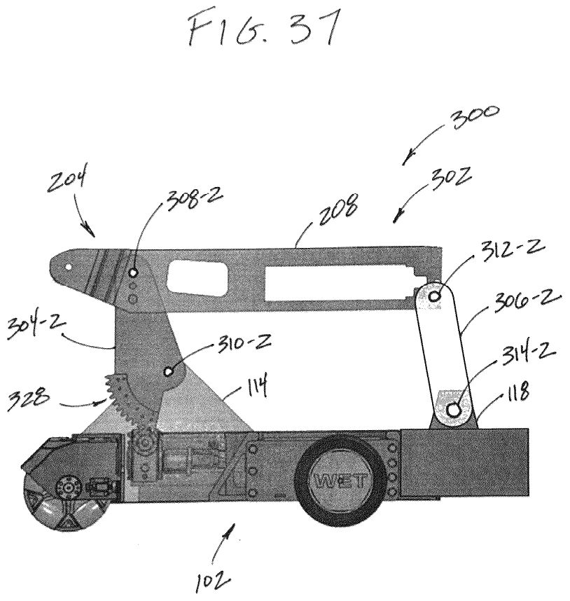

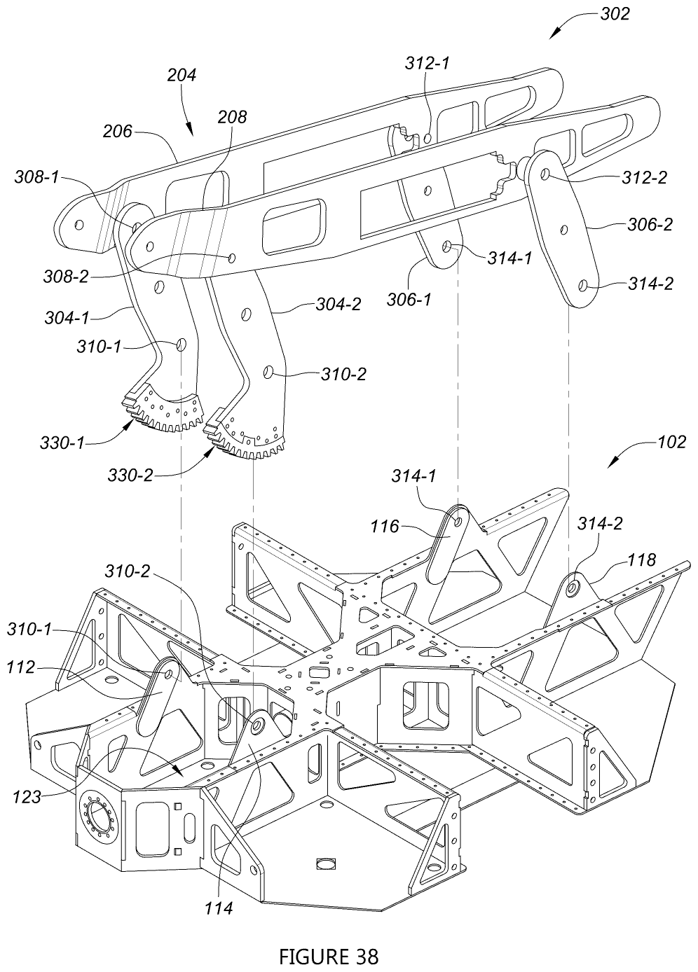

FIGS. 36-37 show side views of the lifting system 300 configured or movably attached to the chassis 102 of movement system 100, where FIG. 36 shows the system 300 in a retracted position and FIG. 37 shows the system 300 in a raised, deployed or extended position. FIG. 38 shows an exploded view of the system 300 in the extended position in relation to chassis 102 of movement system 100.

In some embodiments, the lifting system 300 may be configured as a parallelogram or “scissor” lift assembly. The system 300 may include a lifting system chassis 302 including one or more front lifting arms 304 and one or more rear lifting arms 306. The chassis 302 also may incorporate the central support structure 204 of the performance platform chassis 202 (see FIGS. 31-33), including the left central beam 206 and the right central beam 208, as its upper front-to-back central beam. In this way, the central support structure 204 may be common to both the lifting system chassis 302 and the performance chassis 202. The lifting system's front lifting arms 304 may be configured with the front of the central support structure 204 and the rear lifting arms 306 may be configured with the rear of the structure 204. The front lifting arms 304 also may each include gear portions 328 to facilitate the movement of the arms 304 as described in other sections.

In some embodiments, a first end of a first front lifting arm 304-1 may be rotatably configured with the front end of the left central beam 206 at a forward upper pivot point 308-1 (e.g., using a linkage pin or similar), and a second end of the first front lifting arm 304-1 may be rotatably configured with the forward left support truss 112 of chassis 102 of movement system 100, at a forward lower pivot point 310-1. Similarly, a first end of a second front lifting arm 304-2 may be rotatably configured with the front end of the right central beam 208 at a forward upper pivot point 308-2, and a second end of the second front lifting arm 304-2 may be rotatably configured at a forward lower pivot point 310-2 with the right support truss 114 of the chassis 102 of movement system 100. The support trusses 112, 114 may each include a hard point 137 for extra strength and rigidity (see FIG. 17). This arrangement may generally form the front portion of the parallelogram lift.

To form the rear portion of the parallelogram, a first end of a first rear lifting arm 306-1 may be rotatably configured with the rear end of the left central beam 206 at a rear upper pivot point 312-1 (e.g., using a linkage pin or similar), and a second end of the first rear lifting arm 306-1 may be rotatably configured with the rear left support truss 116 of chassis 102 of movement system 100, at a rear lower pivot point 314-1. Similarly, a first end of a second rear lifting arm 306-2 may be rotatably configured with the rear end of the right central beam 208 at a rear upper pivot point 312-2, and a second end of the second rear lifting arm 306-2 may be rotatably configured at a rear lower pivot point 314-2 with the rear right support truss 118 of chassis 102 of movement system 100.

In some embodiments, as shown in FIGS. 36 and 37, the lifting system 300 may transition from a retracted position (FIG. 36) to an extended position (FIG. 37) by rotating the front lifting arms 304-1, 304-2 about their respective forward lower pivot points 310-1, 310-2 in the direction of arrow R1, and/or by rotating the rear lifting arms 306-1, 306-2 about their respective rear lower pivot points 314-1, 314-2 in the direction of arrow R2. This may result in the central support structure 204 translating from a generally lower and retracted position to a generally extended position. To transition from the extended position to the retracted position, the forward arms 304-1, 304-2 and/or the rear arms 306-1, 306-2 may be rotated in directions generally opposite the directions of R1 and R2, respectively.

In some embodiments, it may be preferable that the length of the front lifting arms 304-1, 304-2, as measured between the pivot points 308-1, 310-1 on the first forward arm 304-1 and between the pivot points 308-2, 310-2 on the second forward arm 304-2, match one another. It also may be preferable that the length of the rear lifting arms 306-1, 306-2, as measured between the pivot points 312-1 and 314-1 on the first rear arm 306-1 and between the pivot points 312-2, 314-2 on the second rear arm 304-2, also match one another.

Additionally, it may be preferable that the length of the front lifting arms 304-1, 304-2 and the length of the rear lifting arms 306-1, 306-2 as measured as described above also match one another. In this way, the longitudinal axis L_{C2} of the central support structure 204 (see FIG. 31) may remain generally horizontal when the lifting system 300 is in its retracted position, in its extended position, and at each intermediate position therebetween. As such, the performance platform 200 configured with the lifting system 300 also may be held generally horizontal at each position.

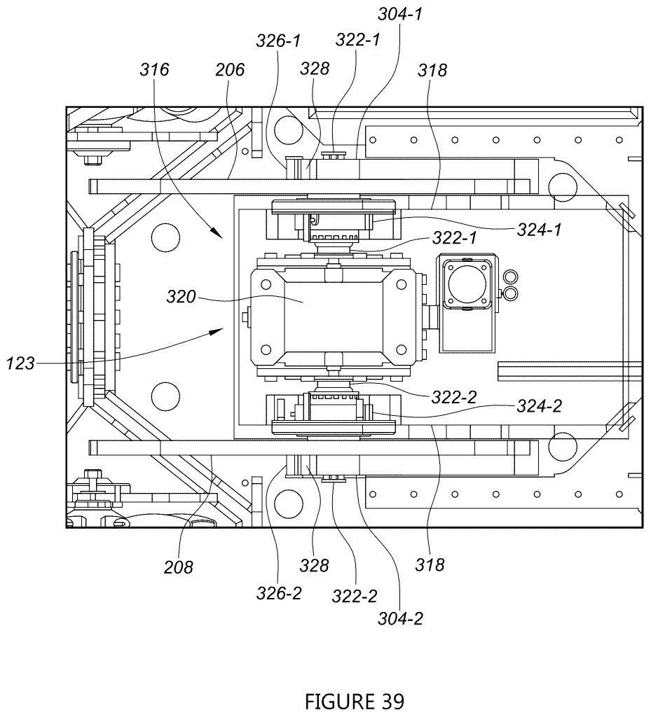

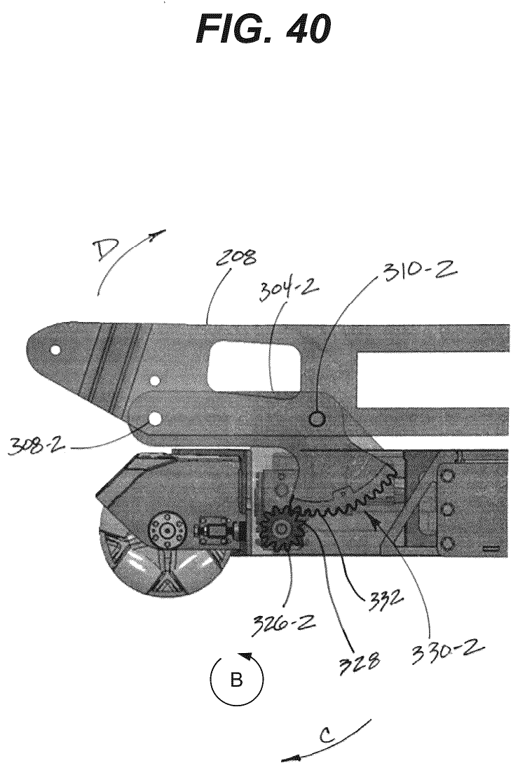

In some embodiments, the lifting system 300 may include a drive assembly 316 configured to cause the translation of the system 300 from a retracted position to an extended position and back. The drive assembly 316 may be modular and may be contained within a waterproof box weldment 318. FIG. 39 shows a close-up top view of the drive assembly 316 configured within the forward middle fuselage 123 of the movement system's chassis 102 defined by the chassis' forward left support truss 112 and its forward right support truss 114 (also see FIG. 38). FIG. 40 shows a close-up side view of the drive assembly 316 engaged with lifting system chassis 302 in the retracted position, and FIG. 41 shows the drive assembly 316 engaged with the chassis 302 in the extended position.

In general, the drive assembly 316 may include an electric drive motor 320 (see FIG. 39) that is configured to drive the rotation of the front and/or rear lift arms 302, 304 to extend and/or retract the lifting system chassis 302 as described in other sections.

In some embodiments, as shown in FIG. 39, the drive motor 320 may be configured to rotate a first drive spindle 322-1 (e.g., a left drive spindle) and/or a second drive spindle 322-2 (e.g., a right drive spindle). Each drive spindle 322-1, 322-2 may pass through and be supported by a respective waterproof drive hub 324-1, 324-2. Each drive hub 324-1, 324-2 may be piloted through, sealed, and bolted to respective sidewalls on opposite sides of the drive assembly's box weldment 318 (e.g., on the left and right sides). The distal ends of each drive spindle 322-1, 322-2 extending through the box weldment 318 may be coupled to respective drive sprockets 326-1, 326-2 (e.g., pinions) configured to drive the front lift arms 302-1, 302-2, respectively. Each drive sprocket 326-1, 326-2 may include radially outwardly extending gear teeth 328.

In some embodiments, as shown in FIGS. 40-41, the second front lifting arm 304-2 may include a gear portion 330-2 including gear teeth 332 that extend radially outward with respect to the arm's corresponding forward lower pivot point 310-2. The teeth 332 of the gear portion 330-2 may engage with the teeth 328 of its corresponding drive sprocket 326-2. Rotational movement of the drive sprocket 326-2, e.g., in the counterclockwise direction of the arrow B of FIG. 40, may cause a rotational movement of the lifting arm's gear portion 330-2 about the lower pivot point 310-2 in the direction of the arrow C, and a corresponding upward rotation of the second front lifting arm 304-2 in the direction of the arrow D. As the drive sprocket 326-2 continues to rotate, the lifting arm 304-2 may continue to rotate upward until it reaches its fully extended position as shown in FIG. 41. It is appreciated that the first front lifting arm 304-1, being on the opposite side of the lifting system 300 and therefore out of view, may include a corresponding gear portion 330-1 with gear teeth 332 that may engage with gear teeth 328 of the corresponding drive sprocket 330-1 to be driven upward in a similar fashion.

With each front lifting arm 304-1, 304-2 rotated to its fully extended position, the lifting system 300 may be placed in its extended position. The lifting system 300 may be lowered and returned to its retracted position by controlling the drive motor 320 to rotate the drive sprockets 326-1, 326-2 in a direction generally opposite the arrow B, thereby causing the lifting arms' gear portions 330-1, 330-2 to each rotate about their respective lower pivot points 310-1, 310-2 in a direction generally opposite the arrow C, and the front lifting arms 304-1, 304-2 to each rotate downward in a direction generally opposite the arrow D.

In some embodiments, the drive assembly 316 also may include additional components such as one or more gearboxes (e.g., a 70:1 primary gear box, a secondary 3:1 gear box, etc.), associated coupling flanges, torque arms, pull rods, rotating pins, and other components as necessary. The drive assembly 316 also may include a manual drive mechanism (e.g., a manual operation port, manual crank shaft, etc.) that may be used to raise and/or lower the lifting system 300 in a situation of system failure, loss of power, or similar. In addition, the drive assembly 316 may include a safety lockout that prevents movement of the lifting system 300 when required, e.g., during maintenance of the system 300.

In some embodiments, the lifting system 300 may include feedback devices and/or servo controls which may report and control the position of the lift 300. This axis of motion may be controlled by an on-board motion control system which may be located in the electrical hub.

In some embodiments, the drive assembly 316 may include ports for air positive pressure, air purge valving, pressure sensors, water, and humidity sensors. In addition, active liquid cooling plates may be fed to the assembly 316 by external cooling loops to cool the electric motor 320, the motor driver, gearing, and other elements of the assembly 316.

In alternative embodiments, the left and right forward arms 304-1, 304-2 may each include their own dedicated gearbox and motor, enabling independent motion of the arms 304-1, 304-2.

### Articulated Performance Arm System 400 (Also Referred to as Module M11)

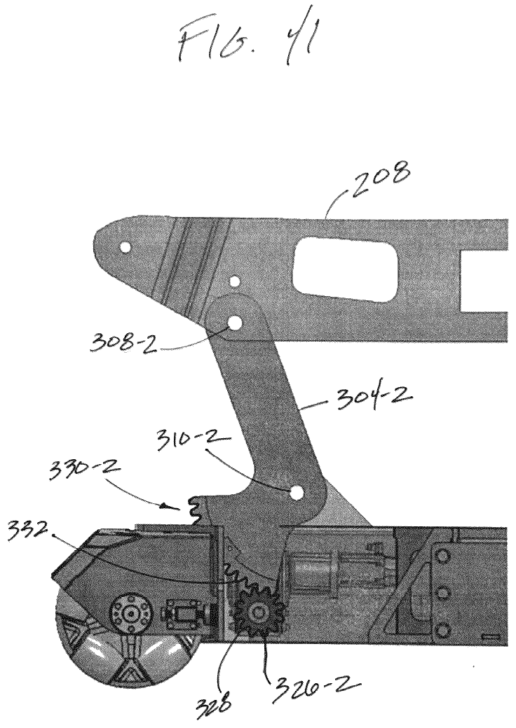

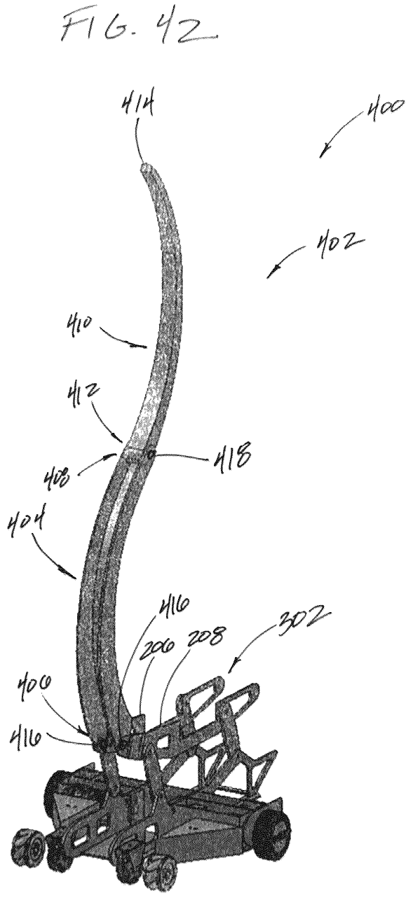

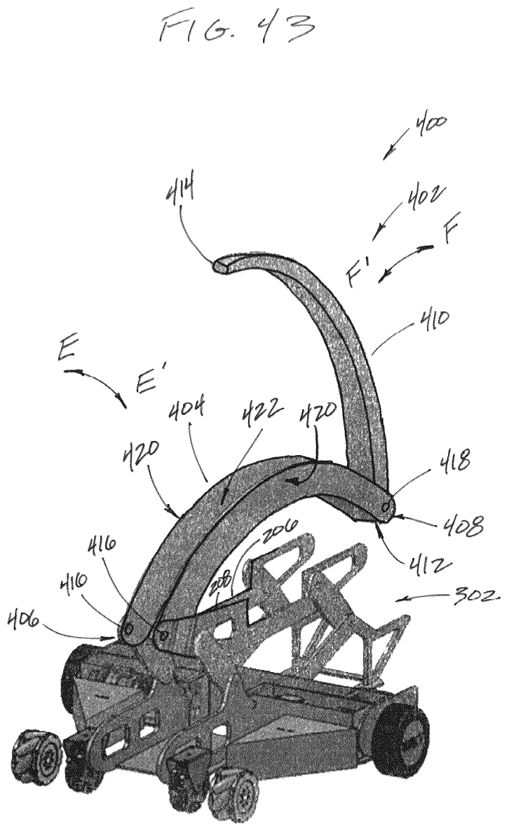

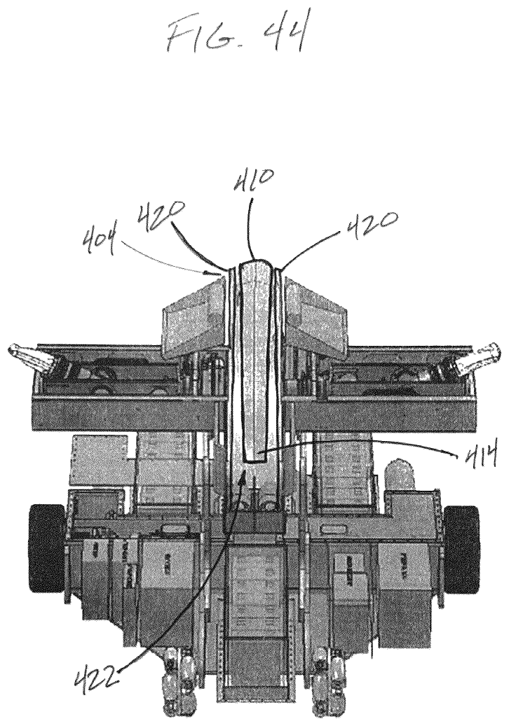

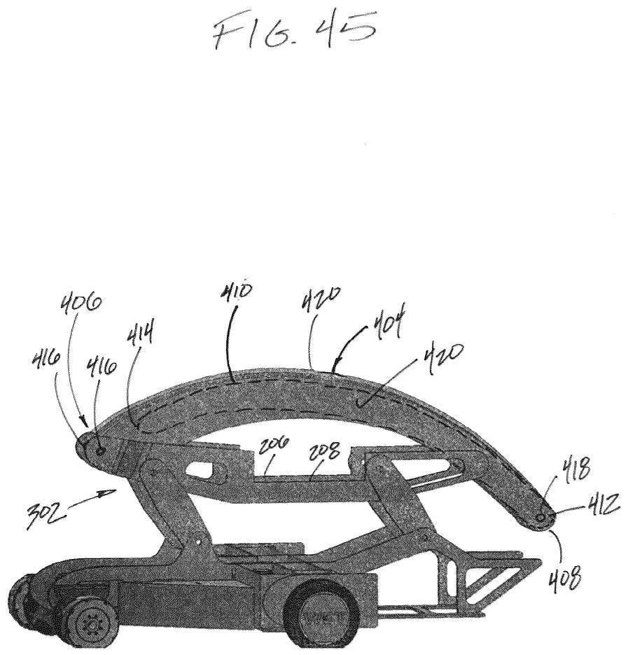

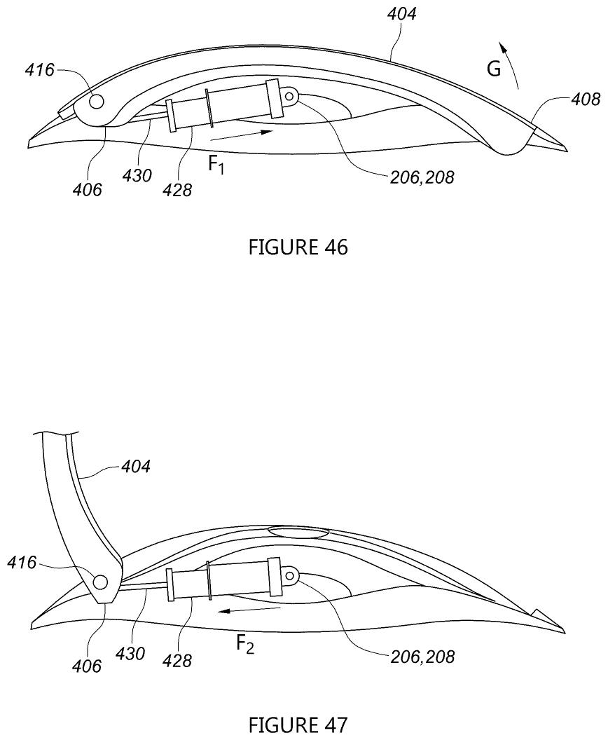

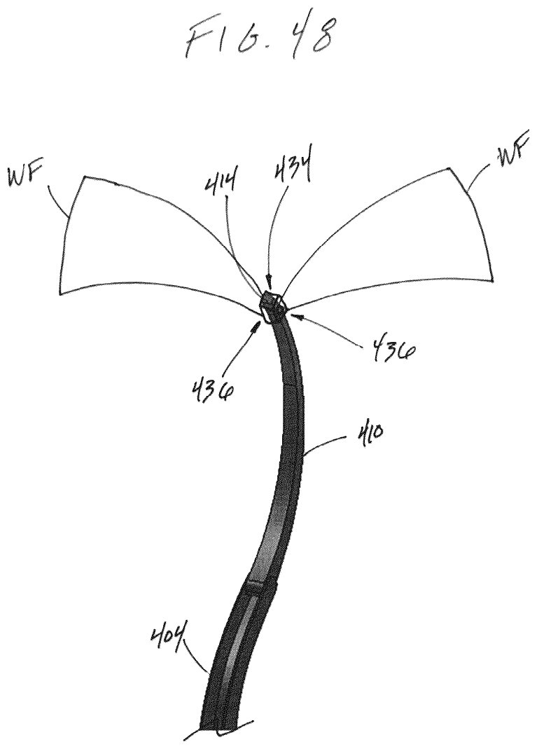

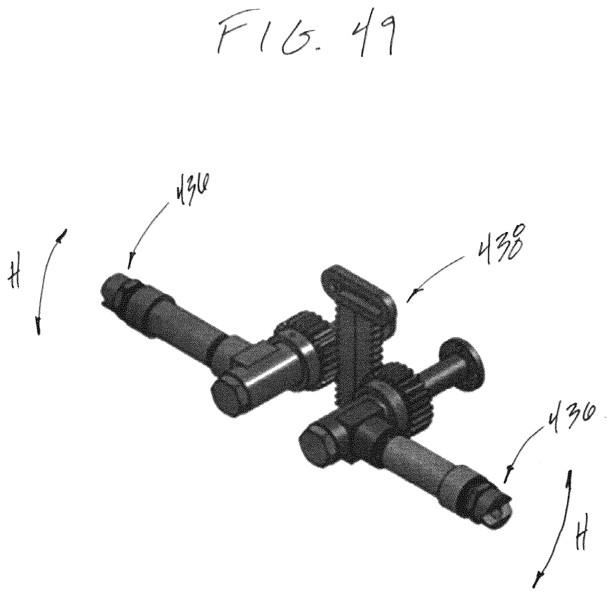

FIGS. 42-45 show the articulated performance arm system 400 configured with the system 10, and in particular, with the lifting system chassis 302. FIG. 42 shows a perspective view of the arm system 400 in a fully extended, raised or deployed position, FIG. 43 shows the arm system 400 semi-extended, partially raised or partially deployed position and FIGS. 44 and 45 show front and side views, respectively, of the arm system 400 in a fully retracted position.

In some embodiments, as shown FIGS. 42-43, the articulated arm system 400 may include an articulating arm 402 comprising one or more arm sections, e.g., a first arm section 404, with a first end 406 and a second end 408, and a second arm section 410, with a first end 412 and a second end 414. Additional arm sections also may be included depending on the desired height of the arm 402 when fully extended or depending on other desired visual effects for a performance by display 1.

In some embodiments, the first end 406 of the first arm section 404 may be rotatably coupled to the lifting system chassis 302 at forward pivot points 416 on the front end of the left and right central beams 206, 208 of the central support structure 204 of the performance platform chassis 202. (As noted previously, central support structure 204 may be common to both the performance platform chassis 202 and the lifting system chassis 302.) The first arm section's second end 408 may be rotatably coupled to the second arm section's first end 412 at elbow pivot points 418. The second arm section's second end 414 may generally extend freely and may be equipped with additional performance elements (e.g., water elements, lights, etc.) as described in other sections.

As shown in FIG. 43, an upward rotational movement of the first arm section 404 about the forward pivot points 416 in the direction of the arrow E combined with an upward rotation of the second arm section 410 about the elbow pivot points 418 in the direction of the arrow F may generally cause the articulated arm 402 to extend upward (resulting in the configuration of FIG. 42 when fully extended, raised or deployed). Conversely, a downward rotational movement of the first arm section 404 about the forward pivot points 416 in the direction of the arrow E′ combined with a downward rotation of the second arm section 410 about the elbow pivot points 418 in the direction of the arrow F′ may generally cause the articulated arm 402 to retract downward (resulting in the configuration of FIG. 45 when fully retracted, lowered or non-deployed).

In some embodiments, as shown in FIGS. 43 and 44, the first arm section 404 may comprise left and right sidewalls 420 extending from its first end 406 to its second end 408 (or at least a portion thereof) defining an open inner channel 422 within the length of the first arm section 404 that may receive the second arm section 410 when the arm 402 is in its retracted position (see FIG. 45).

In some embodiments, as shown in FIGS. 42 and 43, the first arm section 404 may include one or more first arm curvatures. For example, the first arm section 404 may include an upper side curvature that is generally convex from its first end 406 to its second end 408, and a lower side curvature that is generally concave from its first end 406 to its second end 408. Similarly, the second arm section 410 may include one or more second arm curvatures from its first end 412 to its second end 414, e.g., a convex upper side curvature and a concave lower side curvature.

As shown in FIG. 45, it may be preferable that the second arm curvatures generally match the first arm curvatures such that when the second arm section 410 is received into the first section's channel 422, the first and second arm sections 404, 410 may generally overlay or coincide with one another with the second arm section 410 nested or positioned generally within the first arm section 404. In this manner, arm sections 404, 410 may both be positioned within the gap or nesting surface 236 of performance platform sculptural shell assembly 236. This contributes to the sleek profile of performance platform 200 and aids with addressing hydrodynamic forces as system 10 moves through the water of reservoir 11.

In some embodiments, the articulated arm system 400 may include one or more movement mechanisms to cause the upward extension and/or the downward retraction of the articulated arm 402. In some embodiments, the system 400 may include a first movement mechanism 424 to cause the upward/downward movement of the first arm section 404, and a second movement mechanism 426 to cause the upward/downward movement of the second arm section 410. In this way, the first and second arm sections 404, 410 may be controlled to move independently.

The first movement mechanism 424 may be implemented at the first end 406 of the first arm section 404, and the second movement mechanism 426 may be implemented at the junction between the second end 408 of the first arm section and the first end 412 of the second arm section 410 (at the “elbow” of the arm 402). Each movement mechanism 424, 426 may be enclosed in a waterproof housing that prevents moister from entering (to protect the mechanisms 424, 426 from corrosion), and hydraulic fluid from escaping into the water reservoir. Each housing preferably includes positive air pressurization, check valving, and hydraulic fluid drain lines.

In some embodiments, as shown in FIGS. 46 and 47, the first movement mechanism 424 may include a hydraulic cylinder 428 and a pull rod 430, where movement is effected by extending or retracting the pull rod 430 out of or into the hydraulic cylinder 428. The hydraulic cylinder 428 may be power by a hydraulic power unit.

The rear end of the hydraulic cylinder 428 (opposite the pull rod 430) may be movably coupled to a fixed support point, e.g., to the left and/or right central beams 206, 208 of the central support structure 204 (where structure 204 is common to both the performance platform chassis 202 and the with lift system chassis 302). The distal end of the pull rod 430 may be movably coupled to the first end 406 of the first arm section 404, at a connection point below the forward pivot points 416.

In one embodiment, the connection point between the distal end of pull rod 430 and the first end 406 of the first arm section 404, may be about 6.5″ from the pivot points 416. However, other distances between these two points may be used.

As shown in FIG. 46, the pull rod 430 may preferably be fully extended when the actuated arm 202 is in its retracted position. In one embodiment, when the pull rod is fully extended, its connection point with the first end 406 of the first arm section 404 may be about 15 degrees from vertical extending downward from the pivot points 416. However, other angular relationships between these two points may be used.

The first movement mechanism 424 may include a single hydraulic cylinder 428/pull rod 430 system. In this embodiment, the hydraulic cylinder 428 is movably coupled to one or both of the left and right central beams 206, 208 of the central support structure 204, and the pull rod 430 is movably coupled to the pivot points 416 of one or both sidewalls 420. Alternatively, first movement mechanism 424 may include two hydraulic cylinder 428/pull rod 420 systems. In this embodiment, a first hydraulic cylinder 428 may be movably coupled to left central beam 206, and a second hydraulic cylinder 428 may be movably coupled to right central beam 208. Also, a first pull rod 430 may be movably coupled to the pivot point of one sidewall 420, and a second pull rod 430 may be movably coupled to the pivot point of the other sidewall 420. Because maintaining an overall sleek appearance of system 10 is preferred, space considerations.

In operation, as the pull rod 430 is pulled into the hydraulic cylinder 428, the pull rod 430 may apply a rearward force F1 to the first arm section's first end 406, below the pivot points 416. This causes the first arm section's second end 408 to rotate upward about the forward pivot points 416 in the direction of the arrow G (resulting in the configuration of FIG. 47).

To lower the first arm section 404, the hydraulic cylinder 428 may push the pull rod 430 forward thereby applying a forward force F2 to the first arm section's first end 406 below pivot points 416. This causes the first arm section's second end 408 to rotate downward about the forward pivot points 416 (resulting in the configuration of FIG. 46). In some embodiments, it may be preferable that the first arm section 404 have a freedom of rotation of about 0° to about 90°.

In other embodiments, the first movement mechanism 424 may include a hydraulic rotary actuator, electric motor(s), cables, linkage mechanics, and/or other suitable type(s) of movement mechanisms.

In some embodiments, the second movement mechanism 426 may include a hydraulic rotary actuator 432 configured at the junction between the second end 408 of the first arm section and the first end 412 of the second arm section 410 (at the “elbow” of the arm 402).

In some embodiments, it may be preferable that the second arm section 410 have a freedom of rotation of about 0° to about 180°.

Each of the first and second movement mechanisms 424, 426 may be powered by an on-board hydraulic power unit enclosed in a waterproof module. The power unit may include one or more motors, oil reservoir(s), hydraulic valving, control circuitry, and other components. The power unit also may be ported for positive air pressure, with air purging, check valve(s), water and humidity sensors, and necessary electrical connections. In some embodiments, the hydraulic power unit may be configured within the lift system chassis 302, e.g., near the first movement mechanism 424, and may be connected to the first and/or second movement mechanisms 424, 426 via hydraulic fluid lines. In other embodiments, the power unit may include an electric motor with variable frequency drive (VFD) motor controllers.

Each movement mechanism 424, 426 also may be equipped with feedback devices to provide accurate positioning of the arm sections 404, 410.

In some embodiments, the arm 402 may include one or more clutches (e.g., mechanical and/or hydraulic bypass valves) to enable the arm sections 404, 410 to move with respect to one another if an unexpected outside force greater than a predetermined magnitude is applied to the sections 404, 410. In this way, the arm sections 404, 410 may simply move under the outside force rather than buckling and/or breaking. When fully extended, the articulated arm 402 may reach a height of 20′ or greater.

An aspect of the current invention regards calculations based on the weight of arm sections 404, 410 and their associated components, the radius of rotation, i.e., the distance between the arm center of gravity and the pertinent pivot points. Another relevant variable is the time taken to raise or lower arm sections 404, 410. Another variable regards whether both or only one of arm sections 404, 410 are/is being raised or lowered.

Based on the foregoing, the inertia associated with raising or lowering of arm system 400 may be determined. This may relate to the torque required of movement systems 424, 426. The inertia may also relate to the ability of system 10 to smoothly travel around reservoir 10 as arm system 400 is raised or lowered. That is, the inertia of arm system 400 is preferably not excessive so as to cause system 10 to tip or otherwise disturb the travel of system 10 as it moves in reservoir 11, or as system 10 stops or starts.

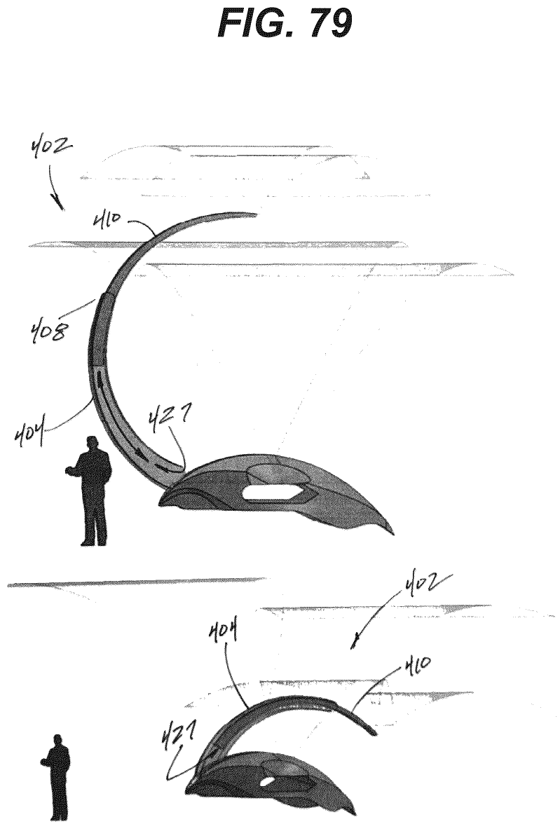

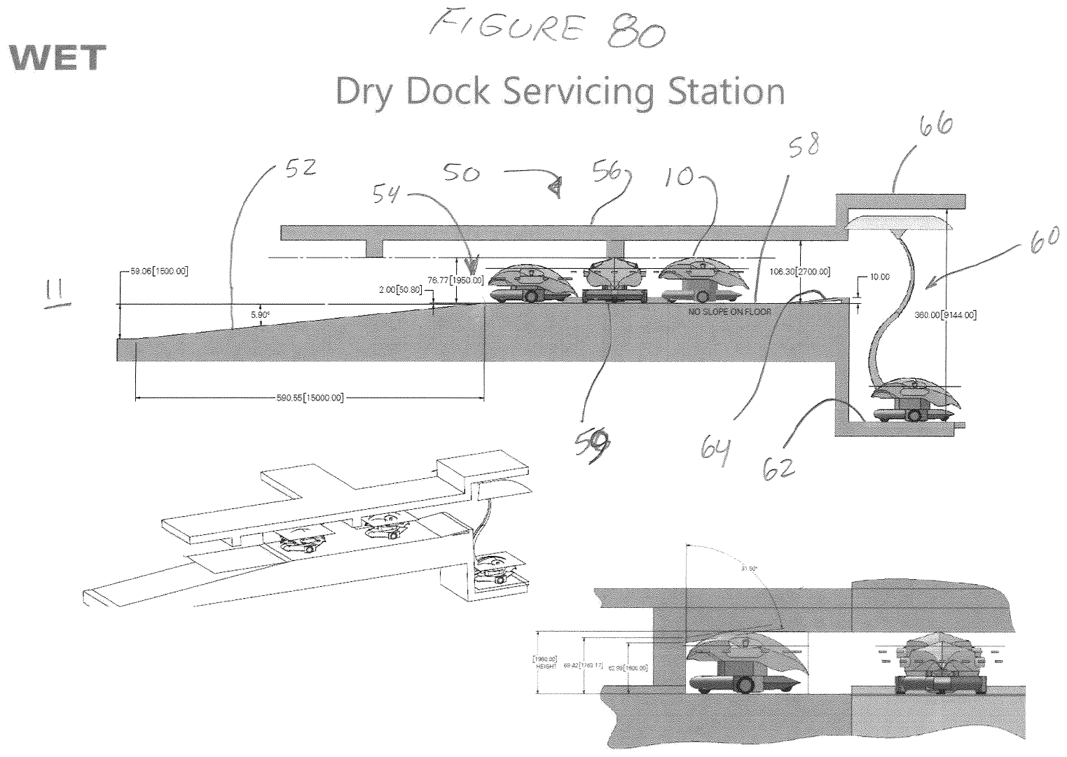

In an alternative embodiment, as shown in FIG. 79, the first and second arm sections 404, 410 may be telescoping. For example, the first arm section 404 may include an inner channel 427 within which the second arm section 410 may telescopically slide. As shown in the top view of FIG. 79, the second arm section 410 may be generally extended out the second end 408 of the first arm section 404, with a small portion of the second arm section 410 held concentrically within the upper end 408 of the first arm section 404 for support. As shown in the lower view of FIG. 79, a majority of the second arm section 410 may be received into the first arm section's inner channel 427 such that second arm section 410 is generally retracted.

In some embodiments, as shown in FIG. 48, the articulated arm 402 may include a top end performance payload 434 configured with its second end 414. The top end payload 434 may include performance expression mechanisms such as water elements, lights, fog emitters, etc. For example, in some embodiments, the payload 434 may include left and right water delivery devices 436 configured to emit left and right water fan expressions WF to provide the graceful water wing movements as described in other sections. In this embodiment, water lines may extend upward within arm system 400 to provide water to water delivery devices 436. In some embodiments, as shown in FIG. 49, the water delivery devices 436 may be implemented using a track and gear mechanism 438 that translates linear motion into a precision controlled up and down rotational movement of the water delivery devices 436 (depicted by the arrows H). Other types of linkage assemblies, such as rotary linkage systems, also may be used.

In a preferred embodiment, the top end payload may comprise a MICRO DUAL-OARSMAN™ water delivery device, which may control water sprays from either side of arm 400 by articulating axes of the nozzle through which water is emitted, and by modulating the amount of water pumped through it.

The MICRO DUAL-OARSMAN™ device is a three-axis water expression device that may include two nozzles pointing approximately opposite of each other to provide the water expression emulating a pair of wings. The nozzles may be relatively small and flat like wings, but other types of nozzles may be used. One axis of articulation may control the pitch or angle of attack of the pair of water jets associated with the nozzles, and another axis may control the vertical angle, which may be centered around a roughly horizontal direction of the nozzle, e.g., like flapping.

Gearing, such as shown in FIG. 49, preferably maintains the vertical attitude of the two nozzles at the same or substantially the same, e.g., as mirrored about a central plane. Waterproof rotary joints may allow articulation of the nozzle without the need for flexible components. The MICRO DUAL-OARSMAN™ device is preferably lightweight to accommodate the operation of arm system 400. Motorized axes may be enclosed in waterproof enclosures to enhance their durability, and may be controlled according to the overall choreography to be provided during the performance by display 1.

Water may be pumped up from the base of arm 400 through a series of hoses and manifolds, up to the top of arm 400 where it may be emitted by the MICRO DUAL-OARSMAN™ to provide a water expression in artistic fashion.

In some embodiments, the arm's first and/or section sections 404, 410 may be equipped with additional performance expressions along its length such as lights, fog emitters, water expressions, and other performance elements. It is preferred that pertinent utility lines, e.g., water lines, electrical lines and data lines may extend securely within arm 400 to reach its associated performance expression. To this end, it is preferred that the utility lines be sufficiently flexible and durable to withstand repeated bending as arm system 400 is deployed and retracted over time. It is also preferred that the utility lines are protected, e.g., by a protective coating or sheath, to withstand a water environment when system 10 is submerged.

### Display 1, Reservoir 11 and Service Station 50

Additional aspects of display 1, reservoir 11 and servicing station 30 are now further described. As noted earlier, display 1 may be situated so as to contribute to an artistic and aesthetically pleasing environment. For example, as shown in FIGS. 1A, 1B, reservoir 11 may be located adjacent to and extend around an architecturally significant building 2, thereby complimenting and contributing to an aesthetically pleasing environment that will attract visitors and foster human interaction.

Given the numerous systems and components of systems 10, and the water environment they preferably withstand, it is contemplated that systems 10 may require maintenance. As such, display 1 may include a dry dock servicing station 50 that is connected to reservoir 11 as shown in FIG. 80. (FIG. 1A also shows servicing station 50 extending into the foreground from reservoir 11.) In a preferred embodiment, servicing station 50 is located out of the observers' view so as to avoid disrupting performances provided by display 1 or otherwise distract observers from the water and visual effects provided during performances.

Besides providing an area in which to service systems 10, station 50 may also serve as a parking area for systems 10 while they are not taking part in a performance by display 1. While systems 10 may preferably withstand a water environment, it may be preferred that systems 10 be stored in a dry environment while not performing.

As shown in FIG. 80, the servicing station 50 may include a ramp 52, a dry dock service area 54, roof 56, floor 58, and one or more charging station(s) 59. Besides charging, servicing station 50 may provide other servicing functions to systems 10, e.g., sourcing air to fill scuba tanks or purge any unwanted water that may have collected in the modules of movement system 100.

As shown in FIG. 80, roof 56 may be supported by a number of overhead beams. The roof 56 of servicing station 50 may be relatively low so that station 50 remains inconspicuous to observers of display 1. However, roof 56 may be sufficiently high enough above floor 58 so that maintenance may be performed. For example, it is referred that roof 56 is high enough so that performance platform 200 of system 10 may be raised. Cranes may extend down from the ceiling of roof 56 to hoist parts of system 10. For example, if the lifting system 300 of a system 10 is inoperable, a crane may raise performance platform to provide access to lifting system 300 for repairs.

The dimensions of, and space provided by, station 50 may vary. However, in one embodiment, station 50 is preferably large enough so that a number of systems 10 may be parked there for storage. For example, station 50 may be large enough so that 20 or more systems may park and/or be stored there. Systems 10 may be parked in station 50 in various configurations. For example, systems 10 may be parked in a staggered configuration or in a configuration where they are lined up with the spaces created by the overhead beams.

The ramp 52 may comprise concrete that is formed in a desired configuration. After display is installed and water is added to reservoir 11, ramp 52 may be completely, largely or partially underwater, and the bottom end of ramp 52 may be contiguous with the floor of reservoir 11. Ramp 52 may slope upward to its top end that may be above the water level of reservoir 11, and that may coincide with floor 58. As such, a system 10 may travel along the floor of reservoir 11 and then up ramp 52 into station 50 and onto floor 58, where a dry environment exists for maintenance, parking, storage and/or other functions.

The ramp 52 may be wide enough for several systems 10 to travel up or down at once. For example, systems 10 may be programmed or controlled so that several systems 10 travel up ramp 52 at the same time after a performance. During the performance, systems 10 may receive control signals so that they perform in choreographed fashion. When the performance is over, systems 10 may then receive control signals directing them to travel from their locations in reservoir 11 to station 50, then to ascend ramp 52 and then to travel to an assigned parking spot in area 54.

A unique aspect of a performance by display 1 may also involve the introduction of systems 10 from station 10, down ramp 52 and into reservoir 11. This may occur in a formation such that it is aesthetically pleasing to observe a number of sleek systems 10 entering reservoir 11 in anticipation of a performance by display 1. This may be especially so where systems 10 are relatively large.

A performance by display 1 may involve several systems 10 traveling down ramp 52 and being submerged in reservoir 11. These systems may then surface and/or otherwise move according to a choreography for the performance.

The angle or slope of ramp 52 is preferably within the limits for which the drive modules 138 and front omni wheel system 140 may stably drive system 10 up and down the ramp 52. The manner in which the movement system 100 of system 10 may accommodate slopes has been described above. After system 10 has been serviced, or when a parked system 10 is to enter reservoir 11, it may then travel down ramp 52 into reservoir 11 and join or rejoin the display 1. Systems 10 may also access servicing station 50 from dry land via an entrance other than ramp 52. Systems 10 may then travel down ramp 52 into reservoir 11 to participate in a performance by display 1. Ramp 52 may include a curb on each of its sides to help avoid a system 10 inadvertently traveling and falling over a side of ramp 52.

Service area 54 may include one or more charging stations 59. In one embodiment, charging stations 59 may be similar to the induction charging station 183 shown in FIGS. 69-70. In this embodiment, floor 58 may include one or more charging stations, e.g., floor 58 may include induction pads 183 that may interact with the charging pads 179 on the bottom of systems 10 as described above. Alternatively, charging systems may be positioned on the ceiling or beams of roof 56. In this embodiment, a charging cable may extend downward to plug into system 10. In any event, it is preferred that systems 10 park in an arrangement so that they may each access a charging system.

Besides service area 54, servicing station 50 may also include another service or testing area 60, having a floor 62 and a roof 66. There may also be a ramp 64 leading from the dry dock service area 54 to the service or testing area 60. Ramp 64 may also serve as a restraint to avoid a system 10 inadvertently falling into area 60.

Floor 62 may act as an elevator by raising up to receive system 10 from ramp 64. Floor 62 may then lower to the position shown in FIG. 80 so that arm system 400 may be deployed. Alternatively, a crane and/or hoist system may be used to transport system 10 from service area 54 to testing area 60, and back up to service area 54 when maintenance and testing is complete.

The roof 66 of area 60 may be sufficiently high enough above floor 62 so that arm system 400 may be deployed for maintenance, testing or other purposes. For example, certain types of maintenance may require arm system 400 to be raised or deployed to provide access to components that would otherwise be inaccessible when the arm is in a retracted position.

Other types of restraints may be used to avoid a system 10 from inadvertently falling down into area 60. For example, removable bollards or wedge barriers may be placed at the location where ramp 64 is shown in FIG. 80. Alternatively, in a preferred embodiment, pockets may be formed into the concrete of ramp 64, or the concrete of floor 58, during slab construction. These pockets may be formed by inserting a can or other type of barrier or spacer that prevents the concrete from entering the pocket as the concrete solidifies. The can may be cylindrical or of some other shape, and is held firmly in place as the concrete of ramp 52 and/or floor 58 solidifies.

A mount may then be inserted into the pocket formed by the can, and is also attached to the can. So that the mount is securely positioned within the can, the outer profile of the mount preferably corresponds to the interior profile of the can. For example, where the can is cylindrical, the mount may also be cylindrical. The can may be sufficiently thick to receive bolts or other attachment means from the mount. Alternatively, the interior of the can may have a latch or other mechanism that engages a corresponding mechanism on the outer surface of the mount to hold the mount in place. Bars or other types of restraining devices may then be attached to the mount(s).

For example, in some embodiments, three cylindrical pockets may be formed in a line in floor 58 or ramp 64 by cylindrical cans. In an example, the cans comprise steel and may have a diameter of about 16″ and extend into floor 58 or ramp 64 by about 8″. However, the cans may have other dimensions and shapes. The cans may be positioned, and the pockets may be formed, in a line that is transverse to the direction sought to be restrained. In FIG. 80, the pockets would be arranged transverse to the direction that a system 10 would travel to go from area 54 to area 60, i.e., in a line going into the page.

Mounts may be installed into the two outer cans/pockets and held securely in place. Each mount may include a bracket having two sidewalls which extend upward from the surface of floor 58 or ramp 64. Each bracket may receive a proximal end of a bar between is sidewalls. The bar may be rotatably attached to the sidewalls, e.g., rods may extend from either side of the bar's proximal end, into holes in each sidewall. The bar of each mount may be configured in a lowered position whereby each rod rests on the floor 58 or ramp 64, with their distal ends touching each other or in proximity to each other. The distal ends of the bars may be received and/or locked in place by the third or center mount located between the two outer mounts.

In this lowered position, the bars are held in place by the center mount and thus form a barrier to prevent a system from traveling along floor 58 or ramp 64 in a direction perpendicular to the barrier. It is preferred that the height of the barrier formed by the bars is tall enough to restrain the omni wheels or drive wheels but is still short enough to avoid engaging the chassis 102 or lower part of movement system 100.

The center mount may extend upward from the surface of floor 58 or ramp 64, similar to the outer mounts. Alternatively, the center mount may be recessed into the floor 58 or ramp 64 so that it is flush with the floor 58 or ramp 64 surface. In this embodiment, the distal end of each bar may include a tab, pin, rod or other protuberance that extends downward into the center mount when the bars are in the lowered position.

The distal ends of the bars may be raised when it is desired that system 10 travel along. The bars may be raised and lowered manually. In another embodiment the rotatable connection between the proximal end of each bar and its respective outer mount may be motorized to raise and lower the bars.

It is preferred that this restraining system is designed to withstand a single pocket/can/mount enduring the entire load of a system 10 colliding with it. As such, it is preferred that the size and strength of the bars, the strength of the rotatable connection between the proximal end of each bar and its respective outer mount, the strength of the connection between the distal ends of the bars and the center mount and the manner in which the mounts are secured to the can and/or floor 58 or ramp 64, can withstand such a collision.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water display, comprising:
a reservoir that contains water;
a performance system that is movable in the reservoir, that is adapted to submerge below the water surface and to rise above the water surface, wherein the performance system includes:
a movement system that causes the performance system to move in the reservoir;
a lifting system that is moveably attached to the movement system;
a performance platform that is moveably attached to the lifting system and that is adapted to be raised and lowered by the lifting system;
an arm system that is moveably attached to the lifting system and/or the performance platform, that is moveably attached to a first movement mechanism and that is adapted to be raised and lowered by the first movement mechanism; and
a water delivery device that is attached to the performance platform and/or the arm system.

2. The water display of claim 1, wherein the performance system is controlled to move in the reservoir and to emit streams of water according to a performance choreography.

3. The water display of claim 1, further comprising a plurality of performance systems.

4. The water display of claim 3, wherein the performance systems are controlled to move in the reservoir and to emit streams of water according to a performance choreography.

5. The water display of claim 1, wherein the reservoir has a floor, and the movement system includes wheels that engage the floor of the reservoir thereby causing the performance system to move in the reservoir.

6. The water display of claim 5, further comprising a service station that is joined to the reservoir and that is accessible to the performance systems.

7. The water display of claim 1, wherein the arm system includes one or more water delivery devices at its distal end that emit streams of water as water fan expressions.

8. The water display of claim 7, wherein the one or more water delivery devices emit the water fan expressions as the arm system is raised.

9. The water display of claim 8, wherein the one or more water delivery devices direct the water fan expressions outward and in opposite directions from the arm system, and wherein the one or more water delivery devices direct the water fan expressions in an alternating up and down direction.

10. The water display of claim 9, wherein the water fan expressions emulate flapping of a bird's wings.

11. The water display of claim 1, further comprising a plurality of performance systems, wherein the arm system of each performance system includes one or more water delivery devices at its distal end that emit streams of water as water fan expressions, wherein the one or more water delivery devices direct the water fan expressions outward and in opposite directions from the arm system, and wherein the one or more water delivery devices direct the water fan expressions in an alternating up and down direction.

12. The water display of claim 11, wherein the water fan expressions emulate flapping of wings of a flock of birds.

13. The water display of claim 1, further comprising a charging station and wherein the performance system includes a battery that is adapted to be charged by the charging station.

14. A performance system, comprising:
a movement system that causes the performance system to move in a reservoir;
a lifting system that is moveably attached to the movement system;
a performance platform that is moveably attached to the lifting system and that is adapted to be raised and lowered by the lifting system;
an arm system that is moveably attached to the lifting system and/or the performance platform, that is moveably attached to one or more movement mechanisms and that is adapted to be raised and lowered by the one or more movement mechanisms; and
a water delivery device that is attached to the performance platform and/or the arm system.

15. The performance system of claim 14, wherein the movement system includes wheels that engage a floor of the reservoir and that facilitate propulsion and steering of the performance system, wherein the wheels include at least one drive wheel and at least one omni wheel.

16. The performance system of claim 14, wherein the performance platform includes a sculptural shell that includes a nesting area which receives the arm system when the arm system is in a lowered position.

17. The performance system of claim 14, wherein the arm system includes an articulating arm having a first arm section, a second arm section, a first movement mechanism and a second movement mechanism;
wherein, while the arm system is in a lowered position, the second arm section is nested with the first arm section, and the first and second arm sections are nested within a profile of the performance platform;
wherein the first arm section has a first proximal end and a first distal end;
wherein the second arm section has a second proximal end and a second distal end;
wherein the first arm section is rotatably coupled at its first proximal end to the lifting system and/or the performance platform;
wherein the first movement mechanism is rotatably coupled to the first arm section and the lifting system and/or the performance platform;
wherein the second arm section is rotatably coupled at its second proximal end to the first distal end of the first arm section;
wherein the second movement mechanism is rotatably coupled to the first arm section and the second arm section; and
wherein the arm system is raised by the first movement mechanism rotating the first arm section in so that the first distal end raises above the performance platform, and the second movement mechanism rotates the second arm section so that the second distal end raises above the first arm section.

18. The performance system of claim 14, wherein the movement system includes a plurality of modules, including a battery module to provide power to the performance system, a drivetrain module to provide propulsion and steering for the performance system, a control module to provide signals for controlling the water delivery devices and for controlling the raising and/or lowering of the performance platform and/or arm system, and a charging module.

19. The performance system of claim 18, wherein the plurality of modules are contained in separate compartments with a waterproof or water resistant shell, and wherein the movement system includes an air pressure module that may provide an air purging function to discharge any water that leaks into a module.

20. The performance system of claim 14, further comprising a navigation system that allows he performance system to move and provide water and lighting effects as part of a performance choreography.
